(19) United States
(12) Patent Application Publication
(10) Pub. No.: US 2026/0151901 A1
(43) Pub. Date: Jun. 4, 2026

(54) PICKING SYSTEM, CART ROBOT, METHOD, AND PROGRAM

(71) Applicant: SOFTBANK GROUP CORP., Tokyo (JP)

(72) Inventor: Masayoshi SON, Tokyo (JP)

(21) Appl. No.: 19/123,214

(22) PCT Filed: Oct. 27, 2023
(86) PCT No.: PCT/JP2023/038960

§ 371 Date: Apr. 22, 2025

(30) Foreign Application Priority Data
Oct. 27, 2022 (JP) 2022-172750
Oct. 31, 2022 (JP) 2022-174252
Nov. 2, 2022 (JP) 2022-175990
Nov. 8, 2022 (JP) 2022-178652
Nov. 11, 2022 (JP) 2022-181084
Nov. 25, 2022 (JP) 2022-188594
Nov. 28, 2022 (JP) 2022-188949
Nov. 28, 2022 (JP) 2022-189151
Nov. 29, 2022 (JP) 2022-189888
Nov. 29, 2022 (JP) 2022-190203
Dec. 1, 2022 (JP) 2022-192689
Dec. 16, 2022 (JP) 2022-201460
Dec. 19, 2022 (JP) 2022-202243
Dec. 19, 2022 (JP) 2022-202353

(51) Int. Cl. B25J 9/16; B25J 5/00; B25J 15/06

(52) U.S. Cl. CPC B25J 9/162; B25J 5/007; B25J 9/1661; B25J 9/1664; B25J 15/0616

(57) ABSTRACT

A method to be implemented by a computer, the method including: a moving step, being a step of moving a cart robot, being a robot configured to convey a package, to a battery replacement station when there is a decline in a remaining battery level of a driving battery mounted on the cart robot; and a replacement step, being a step of replacing the driving battery of the cart robot with a replacement battery by using a replacement robot present in the battery replacement station.

### FIELD

The disclosed embodiments relate to a picking system, a cart robot, a method, and a program.

### BACKGROUND

As a conventionally technique in a picking system, there is known a cart robot that autonomously travels based on a predetermined pickup plan of an article and fetches a package from a shelf by using an arm (refer to, for example, Patent Literature 1).

### CITATION LIST

### Patent Literature

Patent Literature 1: JP 2022-68557 A

### SUMMARY

### Technical Problem

However, the conventional technique has room for improvement in efficiently operating the picking system.

The present invention has been made in view of the above, and an object thereof is to provide a picking system, a cart robot, a method, and a program capable of efficiently operating a picking system.

### Solution to Problem

A method according to an embodiment to be implemented by a computer, the method comprising: a moving step, being a step of moving a cart robot, being a robot configured to convey a package, to a battery replacement station when there is a decline in a remaining battery level of a driving battery mounted on the cart robot; and a replacement step, being a step of replacing the driving battery of the cart robot with a replacement battery by using a replacement robot present in the battery replacement station.

A cart robot according to an embodiment comprising: a traveling vehicle body including a cart on which a package can be placed; and a fixing frame being provided on a frame of the cart and configured to fix an arm, being an arm that transfers the package, to an inside of the cart.

A picking system according to an embodiment comprising a plurality of cart robots, the cart robots configured to pick up and convey a package and place the package on a shelf from which the package is to be picked up by a cart robot.

A picking system according to an embodiment comprising: a first cart robot configured to move along a slow lane; and a second cart robot configured to move along a fast lane at a higher speed than the first cart robot, the picking system being configured to pick up a package using the first cart robot and pass the package to the second cart robot, the picking system further comprising: a detection unit configured to detect the package dropped from the first cart robot or the second cart robot; and a collection robot configured to collect the package detected by the detection unit.

A picking system according to an embodiment comprising: a cart robot configured to pick up and convey a package; and a placement robot configured to place the package on a shelf from which the package is to be picked up by the cart robot.

A method according to an embodiment to be implemented by a computer, the method comprising: a collection step, being a step of collecting information including a remaining battery level of each of a plurality of cart robots traveling along one of a plurality of lanes and configured to convey a package; and a determination step, being a step of determining a priority of charging for each of the plurality of cart robots, based on the information.

A picking system according to an embodiment comprising: a sensor capable of detecting information on a floor; a cart robot that includes a traveling vehicle body equipped with a cart capable of accommodating a package and that includes an arm attached to the traveling vehicle body and configured to convey the package; and a control apparatus configured to acquire a property of the package based on information detected by the sensor and configured to execute placement control of the package in the cart according to the acquired property of the package.

A cart robot according to an embodiment comprising: an arm configured to retrieve a package from a storage section; a traveling vehicle body to which the arm is attached and on which the package retrieved by the arm can be placed; and a control apparatus that controls the arm and the traveling vehicle body, wherein the control apparatus can execute two modes: a first retrieval mode, being a mode of retrieving the package from the storage section by the arm while keeping the traveling vehicle body traveling; and a second retrieval mode, being a mode of stopping the traveling vehicle body and retrieving the package from the storage section by the arm, and the control apparatus sets the retrieval mode to either the first retrieval mode or the second retrieval mode based on a size of the package, placement of the package, and a length of the arm.

A cart robot according to an embodiment comprising: an arm that transfers a package; a traveling vehicle body to which the arm is attached and on which the package can be placed; and a control apparatus that controls the traveling vehicle body and returns the cart robot (an own cart robot) to a base in a case of an own abnormality, being an abnormality in the own cart robot.

A cart robot according to an embodiment comprising: a plurality of arms that transfers a package; a traveling vehicle body to which the arms are attached and on which the package can be placed; and a control apparatus that determines quantity of arms to be used for the transfer, in accordance with the package.

A cart robot according to an embodiment comprising: an arm that transfers a package; and a control apparatus configured to determine an operation speed of the arm configured to transfer the package, in accordance with a type of the package.

A picking system according to an embodiment comprising: a first cart robot that includes a first vehicle body capable of accommodating a package and that moves along a first lane; and a second cart robot that includes a second vehicle body capable of accommodating the package and that moves along a second lane located outside the first lane to receive the package from the first cart robot traveling in parallel and accommodate the received package in the second vehicle body, wherein the first vehicle body has a first opening at a position facing the second vehicle body traveling in parallel, and has a first sidewall capable of opening and closing the first opening, the second vehicle body has a second opening at a position facing the first vehicle body traveling in parallel, and has a second sidewall capable of opening and closing the second opening, and the picking system opens the first sidewall and the second sidewall, and transfers the package from the first vehicle body to the second vehicle body through the first opening and the second opening.

A picking system according to an embodiment comprising: a first cart robot that includes a first vehicle body capable of accommodating a package and that moves along a first lane; and a second cart robot that includes a second vehicle body capable of accommodating the package and that receives the package from the first cart robot while moving along a second lane and accommodates the received package in the second vehicle body, wherein the second lane is a circulating path and has a curved portion that curves toward an outside of the circulating path, and the second vehicle body has an opening that opens toward an inside of the second lane.

According to one aspect of the embodiment, the picking system can be efficiently operated.

### BRIEF DESCRIPTION OF DRAWINGS

FIG. 1 is a plan view of a floor of a warehouse to which a picking system according to a first embodiment is applied.

FIG. 2 is a perspective view of a cart robot according to the first embodiment.

FIG. 3 is a control system block diagram of an information processing apparatus according to the first embodiment.

FIG. 4 is a control system block diagram of a control center according to the first embodiment.

FIG. 5 is a control system block diagram of the robot control apparatus according to the first embodiment.

FIG. 6 is a flowchart for illustrating operation processing related to battery replacement of the cart robot according to the first embodiment.

FIG. 7 is a diagram schematically illustrating an example of a computer hardware configuration functioning as an information processing apparatus.

FIG. 8 is a perspective view of a cart robot according to a second embodiment.

FIG. 9 is a schematic diagram of the cart robot according to the second embodiment.

FIG. 10 is a schematic diagram illustrating a placement example of a compressor according to the second embodiment.

FIG. 11 is a perspective view illustrating another example of a cart robot according to the second embodiment.

FIG. 12 is a plan view of a floor 50 of a warehouse to which a picking system according to a third embodiment is applied.

FIG. 13 is a diagram illustrating an operation example of the cart robot.

FIG. 14 is a flowchart for illustrating operation processing of the picking system according to the third embodiment.

FIG. 15 is a plan view of a floor of a warehouse to which a picking system according to a fourth embodiment is applied.

FIG. 16 is a perspective view of a collection robot.

FIG. 17 is a flowchart illustrating a collection processing control routine applied to a basket, performed by the collection robot.

FIG. 18 is a view illustrating an operation example of basket collection processing performed by the collection robot.

FIG. 19 is a view illustrating an operation example of basket collection processing performed by the collection robot.

FIG. 20 is a view illustrating an operation example of basket collection processing performed by the collection robot.

FIG. 21 is a diagram illustrating an example of a case of returning the collected basket to a storage section.

FIG. 22 is a diagram illustrating an example of a case where the collection robot follows a second cart robot.

FIG. 23 is a plan view of a floor of a warehouse to which a picking system according to a fifth embodiment is applied.

FIG. 24 is a view illustrating an operation example of a placement robot.

FIG. 25 is a flowchart for illustrating operation processing of the picking system according to the fifth embodiment.

FIG. 26 is a diagram illustrating an example of information collected by a control center according to a sixth embodiment.

FIG. 27 is a flowchart illustrating a flow of processing of controlling charging of a cart robot according to the sixth embodiment.

FIG. 28 is a diagram (part 1) illustrating a placement example of baskets in a cart.

FIG. 29 is a diagram (part 2) illustrating a placement example of the baskets in the cart.

FIG. 30 is a diagram (part 3) illustrating a placement example of the baskets in the cart.

FIG. 31 is a diagram (part 4) illustrating a placement example of the baskets in the cart.

FIG. 32 is a diagram (part 1) illustrating a speed control example according to a property of a package.

FIG. 33 is a diagram (part 2) illustrating a speed control example according to a property of a package.

FIG. 34 is a diagram (part 3) illustrating a speed control example according to a property of a package.

FIG. 35 is a diagram illustrating an example of using a monitoring cart that monitors a pickup state in the storage section.

FIG. 36 is a flowchart illustrating operation processing of a cart robot according to a seventh embodiment.

FIG. 37 is a plan view of a floor of a warehouse to which a picking system according to an eighth embodiment is applied.

FIG. 38 is a flowchart for illustrating operation processing of a local cart according to the eighth embodiment.

FIG. 39 is a plan view of a floor of a warehouse to which a picking system according to a ninth embodiment is applied.

FIG. 40 is a flowchart illustrating operation processing of a cart robot according to the ninth embodiment.

FIG. 41 is a perspective view of a cart robot according to a tenth embodiment.

FIG. 42 is a flowchart illustrating operation processing of the cart robot according to the tenth embodiment.

FIG. 43 is a diagram illustrating an example of arm information.

FIG. 44 is a flowchart illustrating operation processing of a cart robot according to an eleventh embodiment.

FIG. 45 is a plan view of a floor of a warehouse to which a picking system according to a twelfth embodiment is applied.

FIG. 46 is a perspective view of a first cart robot.

FIG. 47 is a perspective view of a second cart robot.

FIG. 48 is a schematic diagram illustrating a configuration example of a first vehicle body.

FIG. 49 is a schematic diagram illustrating a configuration example of a second vehicle body.

FIG. 50 is a flowchart illustrating a pickup processing control routine regarding a basket, performed by the first cart robot.

FIG. 51 is a diagram illustrating an operation example of a basket transfer method according to the twelfth embodiment.

FIG. 52 is a diagram illustrating an operation example of a basket transfer method according to the twelfth embodiment.

FIG. 53 is a diagram illustrating an operation example of a basket transfer method according to the twelfth embodiment.

FIG. 54 is a schematic diagram illustrating a configuration example of a first vehicle body according to a thirteenth embodiment.

FIG. 55 is a schematic diagram illustrating a configuration example of a first vehicle body according to a fourteenth embodiment.

FIG. 56 is a view illustrating a configuration example of a second vehicle body according to the fourteenth embodiment.

FIG. 57 is a diagram illustrating an operation example of a basket transfer method according to the fourteenth embodiment.

FIG. 58 is a diagram illustrating an operation example of a basket transfer method according to the fourteenth embodiment.

FIG. 59 is a diagram illustrating an operation example of the basket transfer method according to the fourteenth embodiment.

FIG. 60 is a view for illustrating a method of opening and closing a second opening according to a fifteenth embodiment.

FIG. 61 is a schematic diagram illustrating a configuration example of a second vehicle body according to a sixteenth embodiment.

### DESCRIPTION OF EMBODIMENTS

Hereinafter, the present invention will be described through embodiments, but the following embodiments do not limit the invention according to the claims. In addition, not all combinations of features described in the embodiments are essential to the solution of the invention.

### First Embodiment

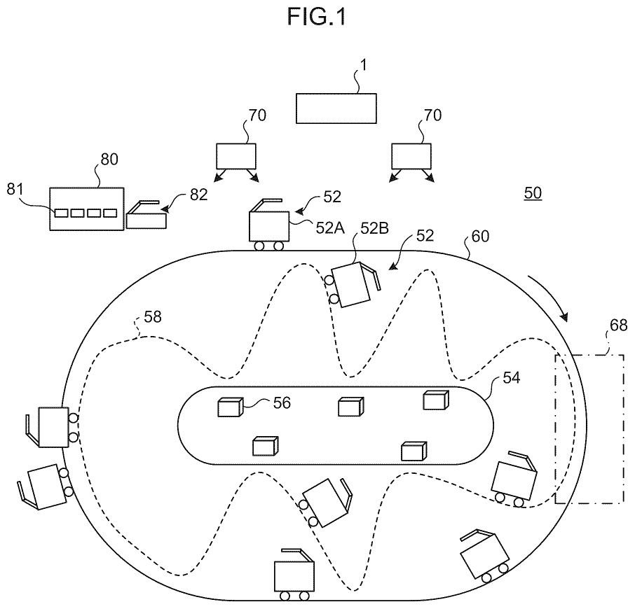

FIG. 1 is a plan view of a floor 50 of a warehouse to which a picking system according to the present embodiment is applied. Note that the picking system is an example of a system according to the embodiment.

The picking work is work of collecting (picking up) necessary items (packages). Picking staff has an essential role in shipping items in the warehouse, and thus is placed in warehouses of all genres. Note that the picking staff is a robot having an arm. In the present embodiment, the picking staff is a cart robot 52. The picking staff includes a humanoid robot.

For example, the main job of the picking staff is to collect designated items based on a list or an order instructed in advance and deliver the collected items to an inspection person or a packing person. The larger the warehouse scale, the more the types and quantity of stored items, and in this case, there will be a large number of picking staff moving in the floor 50.

There is provided a control center 1 on the floor 50 illustrated in FIG. 1. The control center 1 performs overall control of the floor 50. The control center 1 performs operations such as creation of a pickup list related to goods to be picked up by each cart robot 52 and creation of a moving route, and controls each cart robot 52 based on the various types of information created.

The floor 50 also includes a storage section (such as a warehouse and a shelf) 54, which stores a plurality of baskets 56. The basket 56 is an item (package) to be collected by picking work. The cart robot 52 moves around the storage section 54. The cart robot 52 exchanges the baskets 56, as a main function, and is classified, in terms of moving routes, into: a fast track cart 52A (fast cart 52A) as a cart moving along a fast lane 58; and a local track cart 52B (local cart 52B) as a cart moving along a local picking lane 60 (local lane 60). The local lane 60 is a lane on which the cart robot 52 travels at a lower speed than on the fast lane 58. Accordingly, the local lane 60 may also be denoted as a slow lane 60.

The cart robot 52 transfers the basket 56. The transfer includes retrieving the basket 56 from the storage section 54. The cart robot 52 is driven by a driving battery Bat. The driving battery Bat is a secondary battery that can be charged and discharged multiple times.

The local lane 60 is an inner lane on the floor 50, in other words, a lane set outside the storage section 54, on which a local cart 52B meanders to move close to and move away from the storage section 54 and temporarily decelerates or stops to pick up the basket 56 from the storage section 54. Traveling of the local cart 52B is not limited to meandering.

The fast lane 58 is an outer lane on the floor 50, in other words, a lane set outside the local lane 60, on which a cart performs non-stop traveling at 20 Km/h, for example, and receives the basket 56 from the local cart 52B moving on the local lane 60.

A series of operations of the local cart 52B in the local lane 60 includes, for example, picking up the basket 56, transferring the basket 56 to the fast cart 52A in the fast lane 58 being an outer lane without stopping while traveling at 20 Km/h in parallel with the fast cart 52A like baton hand-off in a relay race. The transfer of the basket 56 between the local cart 52B and the fast cart 52A may be performed in a state where each cart robot 52 is stopped.

On the floor 50, a docking station 68 is installed corresponding to the storage section 54. The docking station 68 is a junction point between the fast lane 58 and the local lane 60.

The docking station 68 includes twenty arms, for example, and has a function of receiving the basket 56 from the fast lane 58.

At the docking station 68, the fast cart 52A temporarily decelerates, to 2 Km/h, for example, and transfers the basket 56 within one minute, for example, and then re-accelerates.

On the floor 50, in-warehouse sensor groups 70 including a camera and LiDAR are installed on a ceiling or a wall.

These in-warehouse sensor groups 70 constantly measure the inter-vehicle distance and the speed regarding the fast cart 52A and the local cart 52B. The in-warehouse sensor group 70 include at least one of a high-end camera, a solid-state light detection and ranging (LiDAR), a multi-color laser coaxial displacement meter, or various other sensors. Furthermore, the in-warehouse sensor group 70 may include a vibratory meter, a thermography camera, a hardness meter, a radar, LiDAR, a high-pixel, telephoto, ultra-wide angle, 360 degrees, high-end camera, vision recognition, microscopic level sound, ultrasonic wave, vibration, infrared ray, ultraviolet ray, electromagnetic wave, temperature, humidity, spot AI weather forecast, high-accuracy multi-channel GPS, low-altitude satellite information, or long tail incident AI data. The in-warehouse sensor group 70 may include a plurality of sensors.

The in-warehouse sensor group 70 may detect, in addition to the above information, information such as an image, a distance, vibration, heat, odor, color, sound, ultrasonic wave, ultraviolet ray, or infrared ray. In addition, examples of the information detected by the in-warehouse sensor group 70 include the shifting of the center of gravity of the cart robot 52, or information obtained by the detection of the material of the floor on which the cart robot 52 is installed, the detection of the outside air temperature, the detection of the outside air humidity, the detection of the vertical, lateral, and diagonal inclination angles of the floor, and the detection of the moisture amount. The in-warehouse sensor group 70 performs these detections, for example, every nanosecond.

Each measured information is used as information for controlling the cart robot 52. For example, each measured information is used as information for synchronizing the fast cart 52A and the local cart 52B with each other.

On the floor 50, a battery replacement station 80 is installed. The battery replacement station 80 is a station used for replacing the driving battery of each cart robot 52. The battery replacement station 80 includes a plurality of replacement batteries 81 and a replacement robot 82.

The plurality of replacement batteries 81 is each a battery as a replacement for a driving battery of the cart robot 52, and is a battery charged in the battery replacement station 80. The replacement robot 82 is a robot that replaces the driving battery of each cart robot 52 moved to the battery replacement station 80 with a charged replacement battery 81.

For example, the replacement robot 82 charges the driving battery removed for replacement, at the battery replacement station 80. That is, the driving battery is used as the replacement battery 81 after being charged.

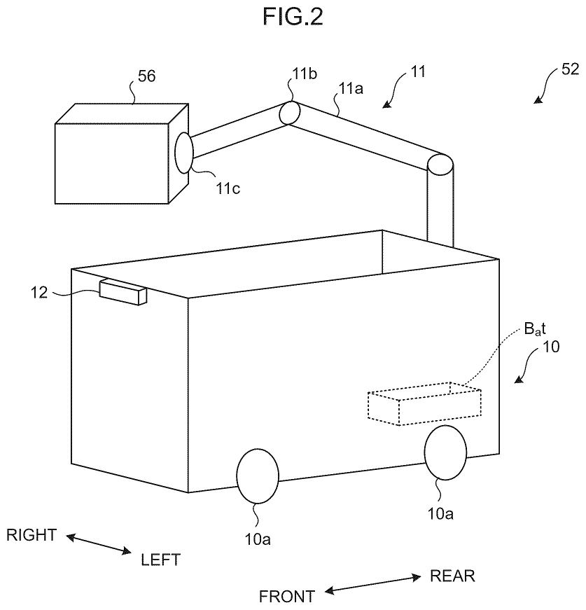

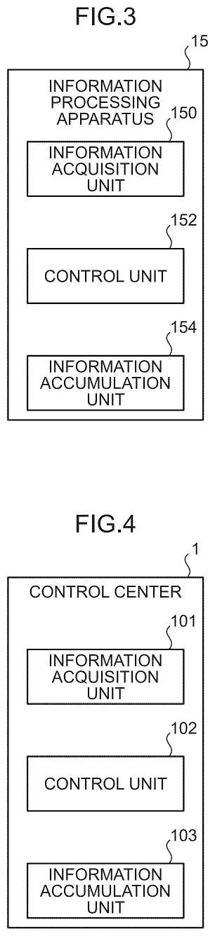

As illustrated in FIG. 2, the cart robot 52 includes a traveling vehicle body 10, an arm 11, a sensor 12, a driving battery Bat, and an information processing apparatus 15 (refer to FIG. 3). FIG. 2 is a perspective view of the cart robot 52 according to the embodiment. Note that the cart robot 52 described below is applied to at least one of the fast cart 52A or the local cart 52B.

The traveling vehicle body 10 is formed in a box shape with an open top, for example. The traveling vehicle body 10 is a body on which the basket 56 can be placed. The traveling vehicle body 10 includes a plurality of drive wheels 10a. Each of the drive wheels 10a has a motor. The rotation speed of each drive wheel 10a is adjusted by the motor. With the adjustment of the rotation speed of each drive wheel 10a, the traveling vehicle body 10 can travel in the front-rear direction, the left-right direction, and the diagonal directions. Also with the adjustment of the rotation speed of each drive wheel 10a, the traveling vehicle body 10 is rotatable by 360 degrees.

The arm 11 is attached to the traveling vehicle body 10. A proximal end of the arm 11 is attached to the traveling vehicle body 10, allowing the arm 11 to be fixed to the traveling vehicle body 10. The traveling vehicle body 10 has one arm 11. That is, the cart robot 52 includes one arm 11. The arm 11 is attached to the rear side of the traveling vehicle body 10. For example, the arm 11 is attached to the rear end of the traveling vehicle body 10. The arm 11 is attached near the center of the traveling vehicle body 10 in the left-right direction.

The arm 11 includes a plurality of rod portions 11a and a plurality of joint portions 11b. The joint portion 11b is provided between the two rod portions 11a, for example, so as to allow relative rotations of the two rod portions 11a. Each of the joint portions 11b includes a motor. The relative rotations of the rod portions 11a by individual joint portions 11b allow the arm 11 to expand, contract, and perform 360-degree rotations.

At a distal end of the arm 11, there is provided a grip portion 11c to grip the basket 56. The grip portion 11c grips the basket 56 by suction, for example. The cart robot 52 may have the arm 11 in plurality, and the grip portion 11c may be a portion referred to as a robot arm (robot hand).

The sensor 12 is attached to the traveling vehicle body 10. The sensor 12 is located on the front side of the traveling vehicle body 10. For example, the sensor 12 is located at the front end of the traveling vehicle body 10. The sensor 12 is located at the upper end of the traveling vehicle body 10. The sensor 12 may be provided so as to protrude upward from the traveling vehicle body 10. The sensor 12 is attached near the center of the traveling vehicle body 10 in the left-right direction. For example, the arm 11 and the sensor 12 are provided so as to be positioned opposite each other on the traveling vehicle body 10. The type of the sensor 12 is similar to the type of the in-warehouse sensor group 70. The sensor 12 may include a plurality of sensors.

The driving battery Bat is a battery to be a power source of the cart robot 52. The driving battery Bat is detachably attached onto the traveling vehicle body 10. In the present embodiment, when there is a decline in a remaining battery level of the driving battery Bat, the driving battery Bat is replaced with the replacement battery 81, being a charged battery, at the battery replacement station 80. Therefore, the driving battery Bat is a relatively inexpensive low-capacity secondary battery.

As illustrated in FIG. 3, the information processing apparatus 15 (control apparatus) includes an information acquisition unit 150, a control unit 152, and an information accumulation unit 154. FIG. 3 is a control system block diagram of the information processing apparatus 15 according to the embodiment.

The information acquisition unit 150 acquires information detected by the sensor 12. The information acquisition unit 150 acquires information detected by the in-warehouse sensor group 70. The information acquisition unit 150 acquires information related to the remaining battery level of the driving battery Bat. The information acquisition unit 150 acquires a signal transmitted from an apparatus such as a command apparatus (for example, the control center 1) that instructs motions of the cart robot 52.

The control unit 152 controls the operations of the arm 11 and the traveling vehicle body 10 based on a signal transmitted from the apparatus such as the command apparatus and acquired by the information acquisition unit 150.

The control unit 152 controls the motion of the arm 11 using the information acquired by the information acquisition unit 150 and using artificial intelligence (AI). The control unit 152 controls the motor of each joint portion 11b of the arm 11. The control unit 152 controls the motion of the arm 11 using the information detected by the sensor 12 and the in-warehouse sensor group 70.

In addition, the control unit 152 controls the operation of the traveling vehicle body 10 using the information acquired by the information acquisition unit 150 and using AI. The control unit 152 controls a motor of each drive wheel 10a of the traveling vehicle body 10. The control unit 152 controls the operation of the traveling vehicle body 10 using the information detected by the sensor 12 and the in-warehouse sensor group 70.

In addition, the control unit 152 detects a decline in the remaining battery level of the driving battery Bat based on the information related to the remaining battery level of the driving battery Bat acquired by the information acquisition unit 150. The detection of the decline in the remaining battery level may be performed by the control center 1.

When having detected a decline in the remaining battery level of the driving battery Bat, the control unit 152 moves the cart robot 52 to the battery replacement station 80. The moving route and the timing of moving to the battery replacement station 80 may follow an instruction from the control center 1. Furthermore, the control unit 152 may predict the remaining battery level and then move the cart robot 52 to the battery replacement station 80. For example, the control unit 152 may move the cart robot 52 to the battery replacement station 80 in a case where a time set in advance has elapsed after the replacement of the driving battery Bat or in a case where a prescribed traveling distance (mileage) is reached.

The information accumulation unit 154 is implemented by a storage medium including a semiconductor memory element such as random access memory (RAM) or flash memory, for example. The information accumulation unit 154 stores various programs executed by the control unit 152. The information accumulation unit 154 stores the information acquired by the information acquisition unit 150.

Next, a configuration example of the control center 1 will be described with reference to FIG. 4. FIG. 4 is a block diagram of a control system in the control center 1 according to the embodiment. As illustrated in FIG. 4, the control center 1 includes an information acquisition unit 101, a control unit 102, and an information accumulation unit 103.

The information acquisition unit 101 acquires information related to an order list. The information acquisition unit 101 acquires, from each cart robot 52, information related to the state of each cart robot 52. The information related to the state includes a task being executed, a remaining battery level, and the like. The information acquisition unit 101 acquires information detected by the in-warehouse sensor group 70.

The control unit 102 controls the operation of each cart robot 52 using the information acquired by the information acquisition unit 101 and using artificial intelligence (AI). For example, the control unit 102 performs creation of a pickup list, creation of a moving route, and the like for each cart robot 52. Furthermore, the control unit 102 detects a decline in the remaining battery level of the cart robot 52.

When having detected a decline in the remaining battery level of the cart robot 52, the control unit 102 moves the cart robot 52 to the battery replacement station 80. The cart robot 52 may autonomously move to the battery replacement station 80.

The information accumulation unit 103 is implemented by a storage medium including a semiconductor memory element such as random access memory (RAM) or flash memory, for example. The information accumulation unit 154 stores various programs executed by the control unit 102. The information accumulation unit 103 stores the information acquired by the information acquisition unit 101.

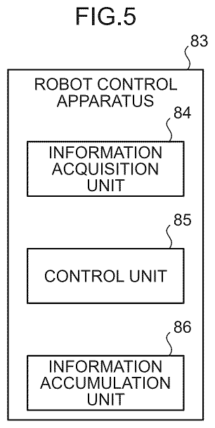

Next, a block diagram of a control system of the replacement robot 82 will be described with reference to FIG. 5. FIG. 5 is a control system block diagram of the robot control apparatus according to the embodiment. As illustrated in FIG. 5, the robot control apparatus 83 that controls the replacement robot 82 includes an information acquisition unit 84, a control unit 85, and an information accumulation unit 86.

The information acquisition unit 84 acquires an arrival notification when the cart robot 52 arrives at the battery replacement station 80. In addition, the information acquisition unit 84 acquires information related to the charge state of the replacement battery 81 being charged at the battery replacement station 80.

The control unit 85 controls the arm or the like of the replacement robot 82 to replace the driving battery Bat of the cart robot 52 that has arrived at the battery replacement station 80 with the replacement battery 81 that has been charged. In addition, the control unit 85 charges the driving battery Bat removed for replacement, at the battery replacement station 80.

The information accumulation unit 86 is implemented by a storage medium including a semiconductor memory element such as random access memory (RAM) or flash memory, for example. The information accumulation unit 86 stores various programs executed by the control unit 85. The information accumulation unit 86 stores the information acquired by the information acquisition unit 84.

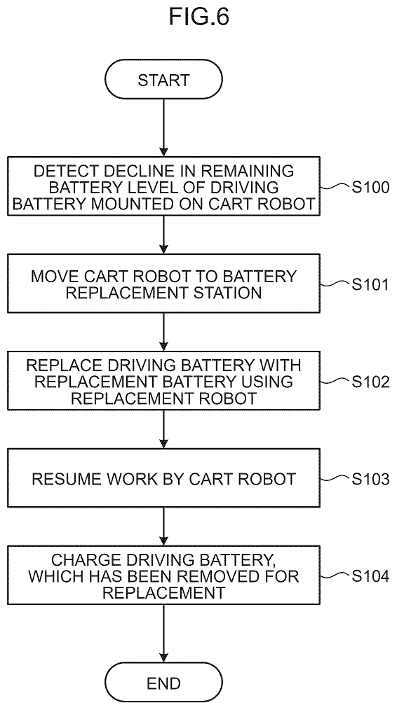

Next, a series of operation processing related to battery replacement according to the embodiment will be described with reference to a flowchart of FIG. 6. FIG. 6 is a flowchart illustrating operation processing related to battery replacement of the cart robot 52 according to the embodiment.

The information processing apparatus 15 of the cart robot 52 detects a decline in the remaining battery level of the driving battery Bat mounted on the cart robot 52 (S100). The information processing apparatus 15 moves the cart robot 52 to the battery replacement station 80 (S101).

The robot control apparatus 83 of the replacement robot 82 replaces the driving battery Bat with the replacement battery 81 by the replacement robot (Step S102). The information processing apparatus 15 of the cart robot 52 resumes the work by the cart robot 52 (S103).

The robot control apparatus 83 of the replacement robot 82 charges the driving battery Bat, which has been removed for replacement (S104). The subject of S101 to S104 may be the control center 1.

As described above, the system according to the embodiment includes: the cart robot 52 that conveys the package; and the replacement robot 82 that replaces the driving battery of the cart robot 52 with the replacement battery at the battery replacement station 80 when there is a decline in the remaining battery level of the driving battery Bat mounted on the cart robot 52. Therefore, with the system according to the embodiment, it is possible to perform unmanned long operation while using a small capacity battery as a driving battery of the cart robot 52.

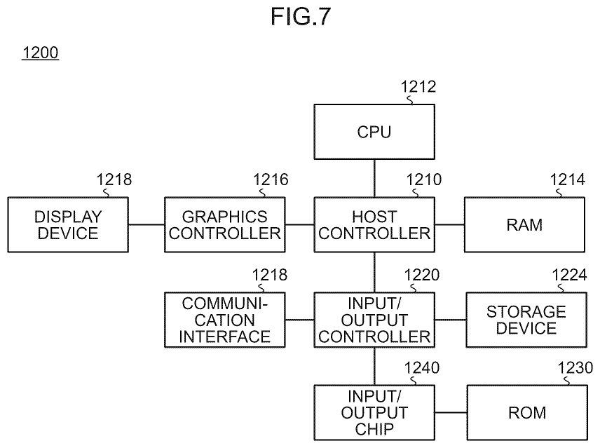

FIG. 7 is a diagram schematically illustrating an example of a hardware configuration of a computer 1200 functioning as the information processing apparatus 15. A program installed in the computer 1200 can cause the computer 1200 to function as one or a plurality of “units” of the apparatus according to the present embodiment, or cause the computer 1200 to execute an operation associated with the apparatus according to the present embodiment or to implement the one or a plurality of “units”, and/or cause the computer 1200 to execute a process according to the present embodiment or a stage of the process. Such a program may be executed by a CPU 1212 to cause the computer 1200 to perform certain operations associated with some or all of the blocks in the flowcharts and block diagrams described in the present specification.

The computer 1200 according to the present embodiment includes a CPU 1212, RAM 1214, and a graphics controller 1216, which are interconnected by a host controller 1210. The computer 1200 also includes input/output units such as a communication interface 1222, a storage device 1224, a DVD drive, and an IC card drive, which are connected to the host controller 1210 via an input/output controller 1220. The DVD drive may be a DVD-ROM drive, a DVD-RAM drive, or the like. The storage device 1224 may be a hard disk drive, a solid state drive, or the like. The computer 1200 also includes an input/output unit such as ROM 1230 and a keyboard, which are connected to the input/output controller 1220 via an input/output chip 1240.

The CPU 1212 operates according to programs stored in the ROM 1230 and the RAM 1214, thereby controlling each unit. The graphics controller 1216 obtains image data generated by the CPU 1212 in a frame buffer or the like provided in the RAM 1214 or directly in the RAM 1214, and causes the image data to be displayed on a display device 1218.

The communication interface 1222 communicates with other electronic devices via a network. The storage device 1224 stores programs and data used by the CPU 1212 in the computer 1200. The DVD drive reads a program or data from a DVD-ROM or the like and provides the read program or data to the storage device 1224. The IC card drive reads programs and data from an IC card and/or writes programs and data to the IC card.

The ROM 1230 stores therein a boot program and the like executed by the computer 1200 at the time of activation, and/or a program dependent on hardware of the computer 1200. The input/output chip 1240 may connect various input/output units to the input/output controller 1220 via a USB port, a parallel port, a serial port, a keyboard port, a mouse port, or the like.

The program is provided by a computer-readable storage medium such as a DVD-ROM or an IC card. The program is read from a computer-readable storage medium, installed in the storage device 1224, the RAM 1214, or the ROM 1230, which is also an example of a computer-readable storage medium, and executed by the CPU 1212. The information processing described in these programs is read by the computer 1200 so as to provide a linkage between the programs and various types of hardware resources described above. The apparatus or method may be configured by implementing operation or processing of information according to use of the computer 1200.

For example, when communication is performed between the computer 1200 and an external device, the CPU 1212 may execute a communication program loaded in the RAM 1214 and instruct the communication interface 1222 to perform communication processing based on processing described in the communication program. Under the control of the CPU 1212, the communication interface 1222 reads transmission data stored in a transmission buffer area provided in a recording medium such as the RAM 1214, the storage device 1224, the DVD-ROM, or the IC card, transmits the read transmission data to the network, or writes reception data received from the network into a reception buffer area or the like provided on the recording medium.

In addition, the CPU 1212 may allow the RAM 1214 to read all or a necessary portion of a file or database stored in an external recording medium such as the storage device 1224, a DVD drive (DVD-ROM), or the IC card, and may execute various types of processing on data on the RAM 1214. Next, the CPU 1212 may perform write-back of the processed data to the external recording medium.

Various types of information, such as various types of programs, data, tables, and databases, may be stored in a recording medium and subjected to information processing. The CPU 1212 may execute various types of processing on data read from the RAM 1214, including various types of operations, information processing, condition determination, conditional branching, unconditional branching, information search/replacement, and the like, which are described throughout the present disclosure and specified by a command sequence of a program, and writes back the results of processing to the RAM 1214. In addition, the CPU 1212 may search for information in a file, a database, or the like in the recording medium. For example, when a plurality of entries, each having an attribute value of a first attribute associated with an attribute value of a second attribute, is stored in the recording medium, the CPU 1212 may search for an entry in which the attribute value of the first attribute matches a designated condition from the plurality of entries, read the attribute value of the second attribute stored in the entry, and thereby acquire the attribute value of the second attribute associated with the first attribute satisfying the predetermined condition.

The above-described program or software modules may be stored in a computer-readable storage medium on the computer 1200 or in the vicinity of the computer 1200. Furthermore, a recording medium such as a hard disk or RAM provided in a server system connected to a dedicated communication network or the Internet can be used as a computer-readable storage medium, thereby providing the program to the computer 1200 via the network.

The blocks in the flowcharts and block diagrams in the present embodiment may represent stages of a process in which an operation is performed or “units” of an apparatus that are responsible for performing the operation. Certain stages and “units” may be implemented by dedicated circuits, programmable circuits provided together with computer-readable instructions stored on a computer-readable storage medium, and/or by a processor provided together with computer-readable instructions stored on a computer-readable storage medium. Dedicated circuits may include digital and/or analog hardware circuits, and may include integrated circuits (ICs) and/or discrete circuits. Programmable circuits may include reconfigurable hardware circuits including, for example, logical conjunction, logical disjunction, exclusive OR, NAND, NOR, and other logical operations, flip-flops, registers, and memory elements, such as field programmable gate arrays (FPGA) and programmable logic arrays (PLA).

A computer-readable storage medium may include any tangible device capable of storing instructions for execution by a suitable device, and as a result, the computer-readable storage medium including instructions stored in the device is to have a product including instructions that can be executed to create means for executing operations designated in the flowcharts or block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), a digital versatile disk (DVD), a Blu-ray (registered trademark) disk, a memory stick, and an integrated circuit card.

The computer-readable instructions may include either source code or object code written in any combination of one or a plurality of programming languages, including assembler instructions, instruction-set-architecture (ISA) instructions, machine instructions, machine-dependent instructions, microcode, firmware instructions, state-setting data, or an object oriented programming language such as Smalltalk (registered trademark), JAVA (registered trademark), and C++, and conventional procedural programming languages, such as the “C” programming language or similar programming languages.

The computer-readable instructions may be provided for a processor or programmable circuits of a general purpose computer, special purpose computer, or other programmable data processing apparatus, either locally or over a local area network (LAN), a wide area network (WAN) such as the Internet so as to cause the processor or programmable circuits of the general purpose computer, special purpose computer, or other programmable data processing apparatus to execute the computer readable instructions in order to generate means to execute the operations designated in the flowcharts or block diagrams. Examples of the processor include a computer processor, a processing unit, a microprocessor, a digital signal processor, a controller, and a microcontroller.

### Second Embodiment

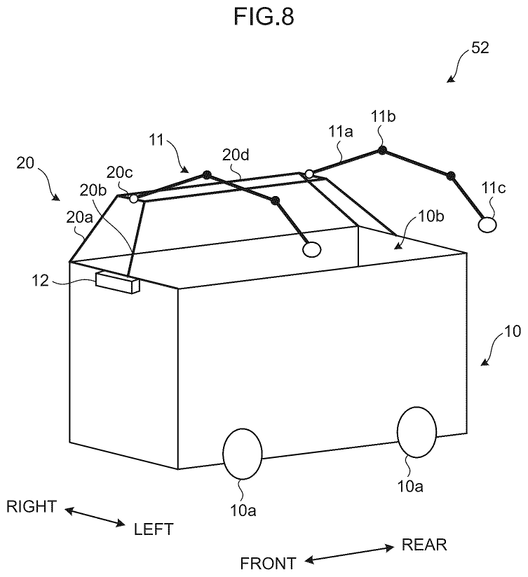

Next, a second embodiment will be described. The second embodiment will omit description of portions overlapping with the first embodiment. FIG. 8 is a perspective view of a cart robot according to the second embodiment. For example, the cart robot 52 operates on a floor of a warehouse to which a picking system is applied. As illustrated in FIG. 8, the cart robot 52 includes a traveling vehicle body 10, an arm 11, a sensor 12, a fixing frame 20, and an information processing apparatus 15. The traveling vehicle body 10 includes a cart 10b formed in a box shape with an open top, for example. The traveling vehicle body 10 includes a plurality of drive wheels 10a.

The arm 11 transfers a package. The proximal end of the arm 11 is fixed to the traveling vehicle body 10 via the fixing frame 20. Two arms 11 are provided with respect to the traveling vehicle body 10. That is, the cart robot 52 is a dual arm robot including two arms 11. The quantity of the arms 11 is not limited to two.

Each joint portion 11b of the arm 11 includes an actuator such as a motor. The relative rotations of the rod portions lla by individual joint portions 11b allow the arm 11 to expand, contract, and perform 360-degree rotations.

The grip portion 11c for gripping the package is, for example, a suction plate, and grips the package by suction by the compressor 30 described below. The grip portion 11c may be implemented by a member referred to as a robot hand.

The cart robot 52 grips a package by the grip portion 11c provided in each of the two arms 11. That is, the cart robot 52 can stably transfer the package by gripping the package at two points.

Meanwhile, in conventionally cases, a cart robot having a relatively long arm has been used for operations in a warehouse, in which a high load has been applied to an actuator that moves the arm by the increased length of the arm. In addition, in a warehouse, shelfs or the like are designed in some cases to facilitate operations by a human on the premise of work by the picking staff who performs picking work. In such a warehouse, by designing the cart robot in accordance with the shelf designed for humans, it is possible to improve the efficiency of the picking work.

Under such a background, the cart robot 52 according to the embodiment is designed to fix the arm 11 to the cart via the fixing frame 20. That is, the cart robot 52 can shorten the length of the arm 11 as compared with the conventional arm by adjusting the height for fixing the arm 11 with the fixing frame 20, the width between the arms 11, and the like.

The fixing frame 20 is provided on a frame of the cart 10b, and is used to fix the arm 11 that transfers a package, to the inside of the cart. The inside of the cart indicates that the proximal end of the arm 11 is positioned inside the outer frame of the cart 10b in top view.

As illustrated in FIG. 8, the fixing frame 20 is provided on one side when viewed in the traveling direction (front direction) of the traveling vehicle body 10, and fixes the arm 11 so as to transfer the package on the opposite side.

That is, in the example illustrated in FIG. 8, the fixing frame 20 is provided on the right side when viewed in the traveling direction (front direction) of the traveling vehicle body 10, and the arm 11 retrieves a package from a shelf (not illustrated) on the left side and puts the package into the cart.

That is, the cart robot 52 provides the fixing frame 20 on one side of the cart 10b and causes the arm 11 to work on the opposite side. With this operation, the package of the cart 10b can be taken in and out without carrying the package by the arm 11.

Furthermore, with such a configuration, the cart robot 52 can set the minimum required arm 11 and efficiently fetch a package (goods, products, etc.) from the shelf on the side opposite to the fixing frame 20 into the cart.

In addition, since the arm 11 is fixed to the traveling vehicle body 10 via the fixing frame 20, it is possible to use a commercially available inexpensive arm. That is, since there is no need to use an arm designed for the traveling vehicle body 10, the cost related to the arm 11 can be reduced.

The fixing frame 20 includes a first support 20a, a second support 20b, a fixing rod 20c, and a reinforcing rod 20d. The first support 20a and the second support 20b are rod-shaped members that support the fixing rod 20c and the arm 11 fixed to the fixing rod 20c.

The first support 20a is fixed to the corner portions of the frame of the cart 10b, and the second support 20b is fixed from the center of the frame to the corner portion side when viewed in the traveling direction of the traveling vehicle body 10. The corner portions refers to corners (four corners) of the frame and portions around the corners. That is, the first support 20a may be fixed to a corner of the frame of the cart 10b, or may be fixed around the corner.

The first support 20a and the second support 20b are fixed, in a state of being inclined toward the inside of the cart 10b as described below, upward from the frame of the cart, with a fixing rod 20c and a reinforcing rod 20d coupled to the distal end.

The fixing rod 20c is a rod-like member to which the arm 11 is fixed. As described above, the fixing rod 20c is supported by the first support 20a and the second support 20b, and its state is reinforced by the reinforcing rod 20d.

For example, the arm 11 is fixed to the fixing rod 20c by a predetermined fixing member such as a clamp. The reinforcing rod 20d is a rod-shaped member that reinforces the strength of the first support 20a, the second support 20b, and the fixing rod 20c.

The reinforcing rod 20d is provided horizontally and fixes two pairs of the first supports 20a, the second supports 20b, and the fixing rods 20c. With this configuration, even when the arm 11 grips a heavy package, the arm 11 can be operated in a stable state.

In the example of FIG. 8, two pairs of first supports 20a, second supports 20b, and fixing rods 20c are reinforced by two pairs of reinforcing rods 20d, but the configuration is not limited thereto. For example, in addition to the first support 20a and the second support 20b, a support may be further added, and the reinforcing rod 20d may be added or reduced.

For example, the first supports 20a, the second supports 20b, the fixing rods 20c, and the reinforcing rod 20d are each formed of rod-shaped metal, but these may be a member formed of plastic or resin. Furthermore, the first supports 20a and the second supports 20b may be detachably fixed to the cart 10b by a method such as clamping and screwing, for example, or may be fixed to the cart 10b by welding or the like. The fixing frame 20 may be formed integrally with the cart 10b. As described below, the reinforcing rod 20d is not necessarily required.

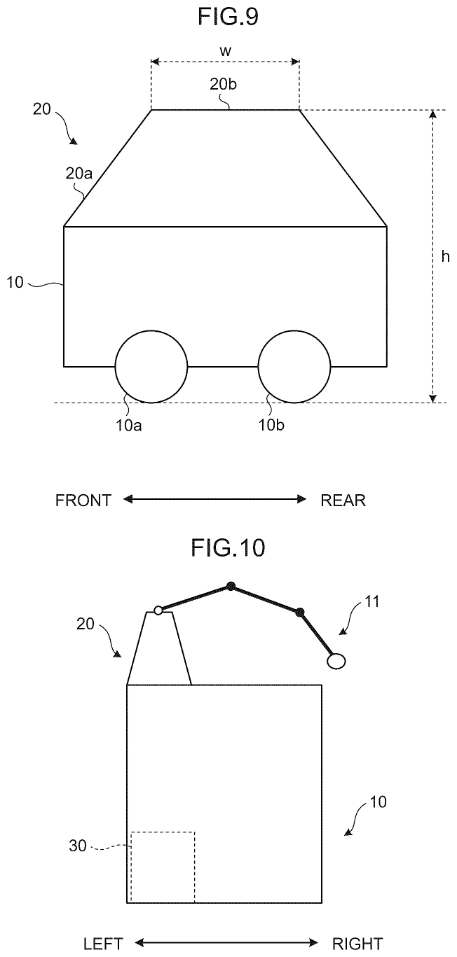

Next, a height at which the arm 11 is fixed and a fixing interval of the arm 11 will be described with reference to FIG. 9. FIG. 9 is a schematic diagram of the cart robot 52 according to the embodiment. In FIG. 2, the cart robot 52 viewed in the left-right direction is illustrated in a simplified manner.

As illustrated in FIG. 9, it is possible, in the cart robot 52, to adjust a fixing height h for fixing the arm 11 and a fixing width w of the arm 11 by the fixing frame 20. For example, the fixing width w and the fixing height h are values designed based on a common denominator of humans, such as an average shoulder height and shoulder width of workers performing the picking work.

More specifically, the fixing width w is a value set according to a common denominator of the average shoulder width of the workers. For example, the fixing width w is about 50 cm. The fixing height h is a value set as a common denominator of the average shoulder height of the workers. For example, the fixing height h is about 150 cm on the premise that the worker performs work in a standing posture. For example, assuming that the worker performs the work in the forward bent posture, the fixing height h is about 90 cm, for example.

The fixing height h is designed to be different between a case where the worker is assumed to perform the picking work while standing upright and a case where the worker is assumed to perform the picking work in the forward bent posture.

In particular, when the shelf or the like is designed on the assumption that the worker performs the picking work in the forward bent posture, the fixing width w is designed to a value corresponding to the forward bent posture of the worker. That is, in this case, the fixing frame 20 causes the arm 11 to have a shape following the forward bent posture of the worker.

In particular, in an old-fashioned warehouse not assumed to introduce a cart robot, the warehouse is designed to fit a worker performing picking work. To handle this, the cart robot 52 according to the embodiment can perform work with the work manner similar to the worker in an old-fashioned warehouse designed for the worker, leading to improvement of work efficiency.

As described above, in the cart robot 52, the fixing frame 20 and the arm 11 are horizontally asymmetrical with respect to the traveling vehicle body 10. Therefore, for example, when a heavy package is lifted by the arm 11, the cart robot 52 may lose its posture.

To handle this, the cart robot 52 is equipped with a grip portion 11c which is a suction plate, for example, and the grip portion 11c is operated by a compressor. That is, in a case where a suction plate is adopted as the grip portion 11c, the compressor is mounted on the cart robot 52, in which the cart robot 52 uses the compressor as a balancer.

FIG. 10 is a schematic diagram illustrating a placement example of the compressor according to the embodiment. As illustrated in FIG. 10, the cart robot 52 places the compressor 30 below the fixing frame 20. That is, in this case, even when a heavy package is gripped by the arm 11, the compressor 30 functions as a balancer, making it possible to prevent the cart robot 52 from Overturning or the like.

Although the case where the compressor 30 is used as a balancer is illustrated here, the balancer may be a battery of the cart robot 52, or the cart robot 52 may be equipped with a weight.

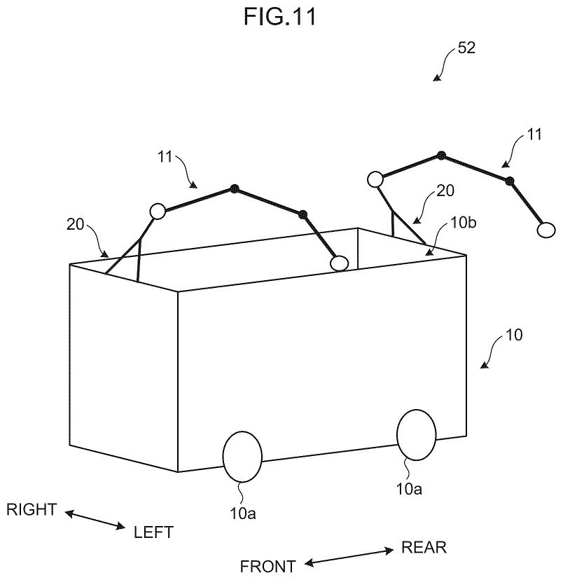

Meanwhile, although the above-described cart robot 52 has been described as a case where the strength of the fixing frame 20 is reinforced by the reinforcing rod 20d, the configuration is not limited thereto. As illustrated in FIG. 11, the reinforcing rod 20d is not necessarily required.

FIG. 11 is a perspective view illustrating another example of the cart robot according to the second embodiment. As illustrated in FIG. 11, the cart robot 52 has a configuration in which the fixing frame 20 is fixed to the frame in the front-rear direction of the cart 10b, and the arm 11 is fixed to the distal end of the fixing frame 20.

Each fixing frame 20 is fixed in a state of being inclined toward the cart 10b. At this time, the height of the distal end of the fixing frame 20 and the distance between the distal ends of the fixing frame 20 are designed based on the average shoulder height of the worker and the average shoulder width of the worker, for example.

That is, even in the cart robot 52, it is also possible to adopt the short arm 11, which is relatively short, and possible to move the arm 11 in a state of mimicking the posture of the worker, leading to reduction of the load of the actuator and improvement in efficiency of the picking work.

The cart robot 52 includes a traveling vehicle body 10 and a fixing frame 20. The traveling vehicle body 10 includes a cart 10b on which a package can be placed. The fixing frame 20 is provided on a frame of the cart 10b, and is used to fix the arm 11 that transfers a package, to the inside of the cart 10b.

With this configuration, the cart robot 52 can shorten the arm 11 by the amount of the fixing frame 20, it is possible to reduce the load on the actuator that operates the arm 11. Furthermore, since the cart robot 52 can use a highly versatile arm that does not depend on the shape of the cart 10b, making it possible to reduce the cost related to the arm 11.

In addition, the fixing frame 20 fixes the plurality of arms at intervals designed based on the shoulder width of the human, and fixes the arms at a height designed based on the height of the shoulder of the human. With this configuration, the cart robot 52 can improve the efficiency of the picking work in the warehouse or the like.

In addition, the fixing frame 20 is provided on one side when viewed in the traveling direction of the traveling vehicle body 10, and fixes the arm 11 so as to transfer the package on the opposite side. With this configuration, the cart robot 52 can take in and out the package of the cart 10b without carrying the package by the arm 11.

The fixing frame 20 includes: the first support 20a fixed to the corner portion of the frame; and the second support 20b fixed to the corner portion side from the center of the frame as viewed in the traveling direction of the traveling vehicle body 10. With this configuration, the cart robot 52 can mount the arm 11 with a good load balance.

In addition, the traveling vehicle body 10 has, on the lower side of the fixing frame, the compressor 30 that operates the suction plate of the arm 11. With this configuration, the cart robot 52 can utilize the compressor 30 as a balancer, and thus can suppress falling.

### Third Embodiment

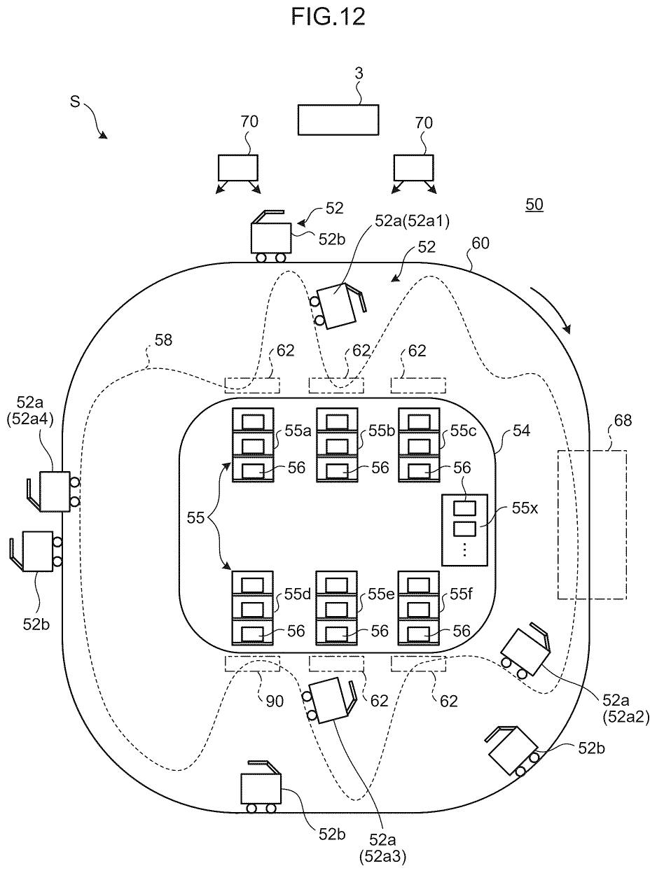

Next, a third embodiment will be described. Description of portions overlapping with the above-described embodiment will be omitted. FIG. 12 is a plan view of a floor 50 of a warehouse to which a picking system according to a third embodiment is applied. As illustrated in FIG. 12, a picking system S includes a cart robot 52. The cart robot 52 is a robot that performs placement of a package (basket 56) and pickup and conveyance of the package. The cart robot 52 includes a plurality of first cart robots 52a and a plurality of second cart robots 52b.

In addition, the picking system S includes a storage section 54, a docking station 68, and a plurality of in-warehouse sensor groups 70. The picking system S includes a control center 3.

The floor 50 illustrated in FIG. 12 has a storage section 54 storing a plurality of baskets 56. The basket 56 is an item (package) to be collected by picking work.

The storage section 54 includes a warehouse section 55x and a shelf 55. The warehouse section 55x accommodates the basket 56 before being placed on the shelf 55. The shelf 55 accommodates the basket 56 to be picked up by the cart robot 52. The shelf 55 can accommodate a plurality of baskets 56. On the floor 50, the shelf 55 is provided in plurality (six, for example). Hereinafter, the six shelves 55 may be denoted as “a first shelf 55a”, “a second shelf 55b”, “a third shelf 55c”, “a fourth shelf 55d”, “a fifth shelf 55e”, and “a sixth shelf 55f”. When the first to sixth shelves 55a to 55f are described with no particular distinction, the shelf may be described as “the shelf 55”.

The cart robot 52 is designed to move around the storage section 54 described above. The first cart robot 52a and the second cart robot 52b transfer the basket 56. The transfer includes retrieving (picking up) the basket 56 from the shelf 55 of the storage section 54.

The first cart robot 52a is a cart robot that moves on the local lane 60. While moving along the local lane 60, the first cart robot 52a picks up the basket 56 and places the basket 56. The second cart robot 52b is a cart robot that moves at a higher speed than the first cart robot 52a, and moves along the fast lane 58.

Although FIG. 12 illustrates an exemplary case where the plurality of second cart robots 52b moves along the same fast lane 58, the plurality of second cart robots 52b may move along different fast lanes 58.

The local lane 60 is set outside the storage section 54 and inside the fast lane 58. That is, the local lane 60 is set between the storage section 54 and the fast lane 58. The first cart robot 52a moves in one direction along the local lane 60. The first cart robot 52a approaches the shelf 55 and picks up the basket 56 or places the basket 56 and then moves away from the shelf 55. Next, the first cart robot 52a approaches the fast lane 58 and transfers the basket 56 to the second cart robot 52b, and then moves in a meandering manner so as to be away from the fast lane 58.

The first cart robot 52a temporarily decelerates or stops in a pickup section to pick up the basket 56 from the shelf 55 of the storage section 54. In addition, the first cart robot 52a passes the basket 56 to the second cart robot 52b while traveling in parallel with the second cart robot 52b in a parallel travel section.

A series of work to be performed by the first cart robot 52a and the second cart robot 52b includes an operation of picking up the basket 56 from the shelf 55 by the first cart robot 52a of the local lane 60. At this time, the first cart robot 52a may place the basket 56. Thereafter, the first cart robot 52a transfers the basket 56 to the second cart robot 52b in the outer fast lane 58 without stopping while traveling at a speed of 20 km/h in parallel with the second cart robot 52b like baton hand-off in a relay race. Note that the transfer of the basket 56 between the first cart robot 52a and the second cart robot 52b may be performed in a state where each cart robot 52 is stopped.

Meanwhile, the basket 56 before being picked up by the first cart robot 52a is placed on the shelf 55 of the storage section 54. Here, it is conceivable that the worker performs the work of placing the basket 56 on the shelf 55, but the manual placement work is not efficient in that it takes time and labor. Therefore, the present embodiment uses a configuration in which the basket 56 can be efficiently placed on the shelf 55.

In the picking system S, the cart robot 52 places the basket 56 on the shelf 55 from which the basket 56 is to be picked up by the cart robot 52. That is, in addition to picking up the basket 56 from the shelf 55, the cart robot 52 in the picking system S also performs placement work of placing the basket 56 on the shelf 55. The cart robot 52 that is to perform the placement work is not limited to the specific cart robot 52, and all the cart robots 52 can perform the placement work.

In this manner, the picking system S allows the cart robot 52 to place the basket 56 on the shelf 55, making it possible to reduce the work time and labor as compared with the case where the worker performs the placement work, leading to efficient placement of the basket 56 on the shelf 55.

Furthermore, as described above, the first cart robot 52a places the basket 56 on the shelf 55 from which the basket 56 is to be picked up by the first cart robot 52a. This makes it possible for the first cart robot 52a to efficiently place the basket 56 on the shelf 55 for the first cart robot 52a.

Incidentally, the first cart robot 52a that is to perform placement may first pick up the basket 56 to be picked up by oneself and then place the basket 56 to be picked up by another first cart robot 52a, on the shelf 55 corresponding to the another first cart robot 52a. Alternatively, the first cart robot 52a that is to perform placement may place the basket 56 to be picked up by another first cart robot 52a, on the shelf 55 corresponding to the another first cart robot 52a, before picking up the basket 56 to be picked up by oneself. Still alternatively, the first cart robot 52a that is to perform placement may place the basket 56 to be picked up by another first cart robot 52a, on the shelf 55 corresponding to the another first cart robot 52a, regardless of the pickup performed by oneself.

Furthermore, the cart robot 52 is controlled based on the placement plan information created by the control center 3 described above. For example, the control unit 102 creates placement plan information including a placement list of the baskets 56 to be placed on the shelf 55 by the cart robot 52 and a moving route of the cart robot 52 in the storage section 54. The placement list may include information such as identification information of the shelf 55 on which the basket 56 is to be placed, identification information of the basket 56 to be placed on the shelf 55, and a placement order of the baskets 56. Furthermore, the placement plan information may include information such as information regarding the timing at which the cart robot 52 places the basket 56 on the shelf 55.

The control center 3 transmits the created placement plan information to the cart robot 52. Subsequently, the cart robot 52 controls the traveling vehicle body 10 and the arm 11 according to the placement plan information received.

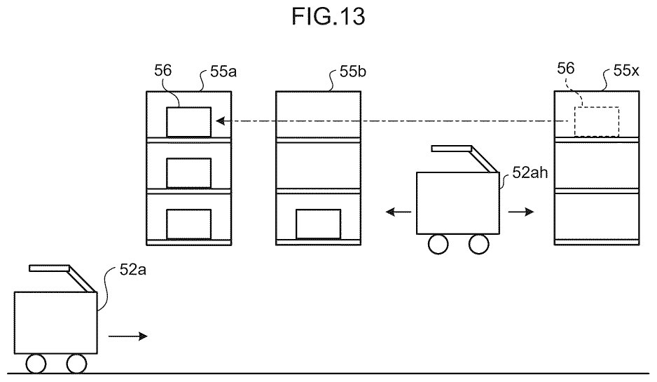

Here, an operation example of the cart robot 52 will be described with reference to FIG. 13. FIG. 13 is a diagram illustrating an operation example of the cart robot 52. The example of FIG. 13 is a case assuming there are a first shelf 55a and a second shelf 55b, and the first cart robot 52a is traveling near the first shelf 55a. In addition, the basket 56 in the warehouse section 55x is assumed to be the basket 56 to be picked up by the first cart robot 52a.

In such a case, a first cart robot 52ah that is to perform placement places the basket 56 on the first shelf 55a near the first cart robot 52a, among the first shelf 55a and the second shelf 55b. Specifically, the first cart robot 52ah that is to perform placement retrieves the basket 56 from the warehouse section 55x, conveys the retrieved basket 56, and places the basket on the first shelf 55a existing near the first cart robot 52a (refer to a one-dot arrow). In FIG. 13, the basket 56 retrieved from the warehouse section 55x is indicated by a broken line.

In this manner, the first cart robot 52a according to the present embodiment places the basket 56 on the shelf 55 (here, the first shelf 55a) near another first cart robot 52a among the plurality of shelves 55 (here, the first shelf 55a and the second shelf 55b). With this configuration, the first cart robot 52a can pick up the basket 56 to be picked up as soon as possible, leading to improved pickup efficiency.

The operation example of the first cart robot 52a will be continued with reference to FIG. 12. In the present embodiment, each of the plurality of shelves 55 is set to correspond to one cart robot 52 or two or more first cart robots 52, among the plurality of first cart robots 52a.

As an example, the first shelf 55a is set to correspond to a first cart robot 52a1. In other words, the first shelf 55a is a shelf for the first cart robot 52a1, and the basket 56 on this shelf is picked up by the first cart robot 52a1. The second shelf 55b and the third shelf 55c are set to correspond to a first cart robot 52a2. The fourth shelf 55d is set to correspond to the first cart robot 52a2 and a first cart robot 52a3. The fifth shelf 55e and the sixth shelf 55f are set to correspond to a first cart robot 52a4. The correspondence relationship between the shelf 55 and the first cart robot 52a described above is merely an example and is not limited.

Subsequently, the first cart robot 52a that is to perform placement places the basket 56 picked up by another first cart robot 52a on the shelf 55 corresponding to the first cart robot 52a.

For example, the first cart robot 52a2 places the basket 56 to be picked up by the subsequent first cart robot 52a1 on the first shelf 55a corresponding to the first cart robot 52a1. In this manner, the first cart robot 52a places the basket to be picked up by the subsequent first cart robot 52a on the first shelf 55 corresponding to the subsequent first cart robot 52a.

With this configuration, the first cart robot 52a can pick up the basket 56 to be picked up as soon as possible, leading to further improvement in pickup efficiency.

Furthermore, in a case where the basket 56 to be picked up is loaded, the first cart robot 52a places the package on another shelf. For example, in a case where the basket 56 to be picked up by another first cart robot 52a is loaded, the first cart robot 52a places the basket 56 to be picked up by the another first cart robot 52 on the first shelf 55 corresponding to the another first cart robot 52a.

With this configuration, at the time of pickup, the first cart robot 52a can perform an early pickup without performing a procedure of moving a basket that is not a pickup target, leading to improvement in pickup efficiency.

Furthermore, in the above description, the plurality of shelves 55 and the plurality of first cart robots 52a correspond to each other in advance. However, the correspondence is not limited thereto, and the shelves 55 corresponding to the first cart robot 52a may be changed.

For example, the first cart robot 52a may change the quantity of shelves 55 on which the baskets 56 are to be placed in accordance with the amount of the baskets 56 to be picked up by another first cart robot 52a. As an example, in a case where the quantity of baskets 56 to be picked up by the first cart robot 52al exceeds the quantity that can be accommodated in the corresponding first shelf 55a, the second shelf 55b, in addition to the first shelf 55a, is set as a shelf corresponding to the first cart robot 52a1. With this configuration, the first cart robot 52a can place the baskets 56 on the second shelf 55b in an amount exceeding the quantity of baskets that can be accommodated in the first shelf 55a.

With this configuration, the present embodiment makes it possible to set the quantity of shelves 55 according to the amount of the basket 56 to be picked up by the first cart robot 52a.

Here, charging in the first cart robot 52a will be described. As illustrated in FIG. 12, the floor 50 has a charging station 90 for charging the driving battery Bat of the first cart robot 52a. The charging station 90 can be a non-contact charging area that can perform non-contact charging with the driving battery Bat of the first cart robot 52a, but the charging station is not limited thereto, and may be a contact charging area.

Subsequently, the first cart robot 52a performs charging processing of charging the mounted driving battery Bat at least in one of situations: when picking up of the basket 56 from the shelf 55 or when placing the basket 56 on the shelf 55.

With this configuration, the first cart robot 52a can effectively use the time for picking up the basket 56 from the shelf 55 or the waiting time generated during the time for placing the basket 56 on the shelf 55, as the charging time.

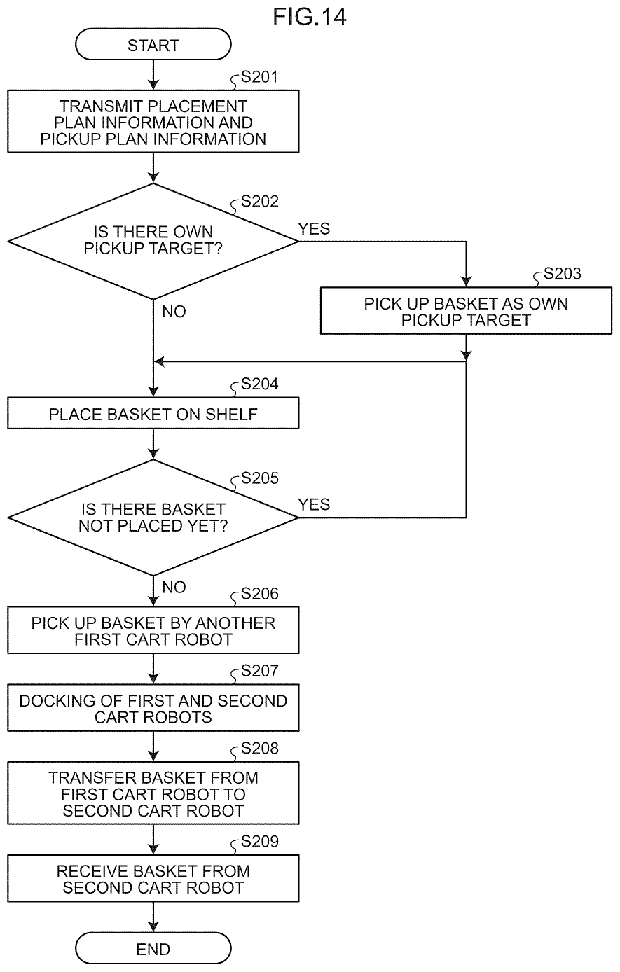

Next, operation processing of the picking system S according to the embodiment will be described with reference to FIG. 14. FIG. 14 is a flowchart illustrating operation processing of the picking system S according to the third embodiment. The following Steps S201 to S209 may be executed in different orders. In addition, some of the following Steps S201 to S209 may be omitted.

As illustrated in FIG. 14, the control center 3 transmits the placement plan information and the pickup plan information to the first cart robot 52a, and transmits the pickup plan information to the second cart robot 52b (Step S201).

Upon receiving the placement plan information and the pickup plan information, the first cart robot 52a that is to perform the placement work judges whether there is an own pickup target (Step S202). In a case where there is a pickup target basket (Step S202 “YES”), the first cart robot 52a to perform the placement work picks up the pickup target basket 56 (Step S203).

Thereafter, the first cart robot 52a that is to perform the placement work places the basket 56 on the shelf 55 based on the placement plan information received (Step S204). In contrast, when having judged that there is no pickup target (Step S202 “NO”), the first cart robot 52a that is to perform the placement work similarly places the basket 56 on the shelf 55 based on the placement plan information received (Step S204).

Subsequently, the first cart robot 52a that is to perform the placement work judges whether there is a basket 56 not placed yet (Step S205). In a case where the first cart robot 52a that is to perform the placement work judges that there is a basket 56 not placed yet (Step S205 “YES”), the processing returns to the processing of Step S204.

In contrast, when having been judged that there is no basket 56 not placed yet, by the first cart robot 52a that is to perform the placement work (Step S205 “NO”), the first cart robot 52a moves to the shelf 55 as the destination at the first moving speed (for example, 5 Km/h) along the local lane 60 and picks up the basket 56 (Step S206).

Subsequently, the first cart robot 52a (including the first cart robot 52a that is to perform placement work) moves toward the parallel travel section of the fast lane 58 at a second moving speed (for example, 20 Km/h), and docks (performs parallel traveling) with the second cart robot 52b in the parallel travel section (Step S207).

Subsequently, the basket 56 is transferred from the first cart robot 52a to the second cart robot 52b (Step S208). Thereafter, the second cart robot 52b moves to the docking station 68, and reception of the basket 56 from the second cart robot 52b is performed (Step S209).

As described above, the picking system S according to the present embodiment includes the plurality of cart robots 52 that picks up and conveys the basket 56 (an example of package) and places the basket 56 on the shelf 55 from which the basket 56 is to be picked up by the cart robot 52. This allows the basket 56 to be efficiently placed on the shelf 55.

### Fourth Embodiment

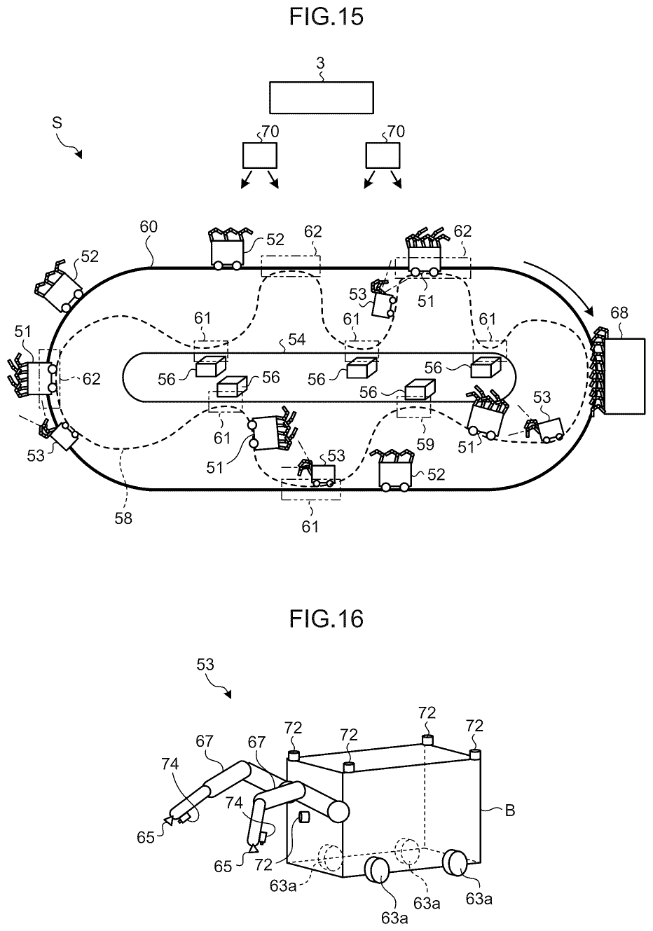

Next, a fourth embodiment will be described. Description of portions overlapping with the above-described embodiment will be omitted. FIG. 15 is a plan view of the floor 50 of a warehouse to which a picking system S according to the fourth embodiment is applied. As illustrated in FIG. 15, the picking system S is different from the above-described embodiment in including a plurality of collection robots 53.

In the picking system S, there is a possibility that the basket 56 will drop when the basket 56 is transferred from a first cart robot 51 to the second cart robot 52. In such a case, for example, it is conceivable that the worker collects the dropped package, but manual collection work is considered to be inefficient in terms of requiring time and labor.

The situation in which the basket 56 can drop is not limited to the transfer from the first cart robot 51 to the second cart robot 52. For example, the basket 56 can drop when the first cart robot 51 retrieves the basket 56 from the storage section 54 or when the second cart robot 52 passes the basket 56 to the docking station 68.

In view of this, the picking system S according to the present embodiment further includes the collection robot 53 that collects the dropped basket 56, in addition to the first cart robot 51 and the second cart robot 52.

FIG. 16 is a perspective view of the collection robot 53. As illustrated in FIG. 16, the collection robot 53 includes a traveling vehicle body B, a plurality of (two in this example) recovery arms 67, a plurality of (five in this example) vehicle body sensor groups 72, and a plurality of (two in this example) arm sensor groups 74.

One of the plurality of vehicle body sensor groups 72 included in the collection robot 53 may be located at the front end of the traveling vehicle body B, for example. The vehicle body sensor group 72 located at the front end of the traveling vehicle body B includes a camera, for example, and captures an image of a floor surface in front of the collection robot 53 in the traveling direction. The vehicle body sensor group 72 located at the front end of the traveling vehicle body B is an example of a detection unit. The information acquisition unit 150 of the information processing apparatus 15 included in the collection robot 53 or the control unit 102 of the control center 3 detects the basket 56 that has dropped onto the floor 50 based on the images captured by the vehicle body sensor group 72. The vehicle body sensor group 72 may include a device such as an ultrasonic sensor, for example, in addition to or instead of the camera.

As will be described below, the collection robot 53 is located behind the first cart robot 51 and moves to follow the first cart robot 51. Therefore, when the first cart robot 51 drops the basket 56, for example, the basket 56 has been dropped in front of the collection robot 53. Therefore, with the detection unit (vehicle body sensor group 72) located at the front end of the traveling vehicle body B of the collection robot 53, the dropped basket 56 can be accurately and quickly detected.

The detection unit that detects the basket 56 dropped on the floor 50 may be another vehicle body sensor group 72 located at the front end of the traveling vehicle body B of the collection robot 53, or may be the vehicle body sensor group 72 included in the collection robot 53. Furthermore, the detection unit that detects the basket 56 dropped on the floor 50 may be the vehicle body sensor group 72 or the arm sensor group 74 included in the first cart robot 51 and the second cart robot 52, or may be the in-warehouse sensor group 70.

The plurality of recovery arms 67 each is an arm used for work of picking up the basket 56 dropped on the floor 50 and placing it on the traveling vehicle body B. The recovery arm 67 is provided at the front end of the traveling vehicle body B, for example. With the recovery arm 67 located at such a position, the basket 56 dropped in front of the collection robot 53 can be efficiently collected. In addition, since the collection operation can be performed while confirming the detection results (images and the like) obtained by the vehicle body sensor group 72 provided at the front end of the traveling vehicle body B, making it possible to perform the collection operation with high accuracy.

The plurality of recovery arms 67 may be located at positions lower than the upper end of the traveling vehicle body B and higher than the lower end of the traveling vehicle body B. With such a configuration, the basket 56 dropped on the floor 50 can be efficiently picked up, and the picked basket 56 can be efficiently placed on the traveling vehicle body B.

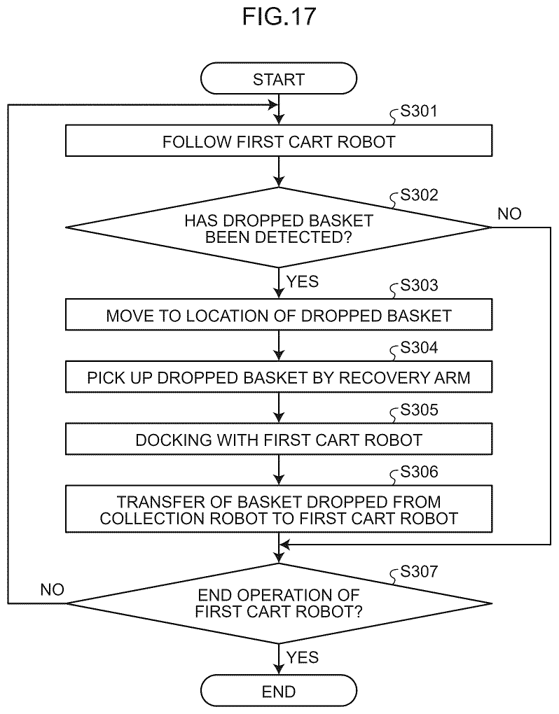

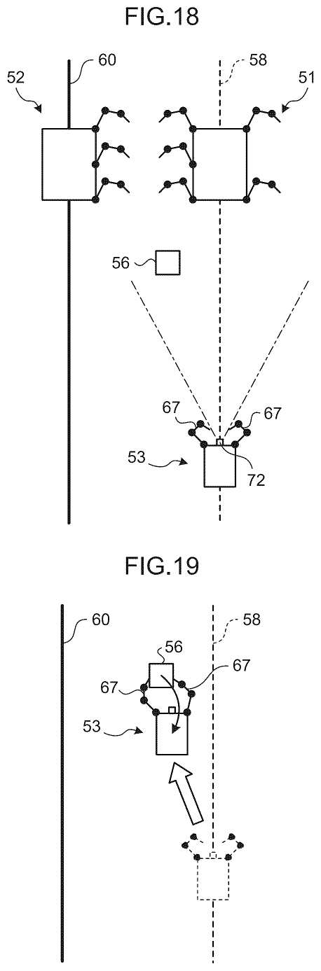

FIG. 17 is a flowchart illustrating a collection processing control routine for the basket 56 performed by the collection robot 53. FIGS. 18 to 20 are views illustrating an operation example of the collection processing for the basket 56 performed by the collection robot 53. Each procedure illustrated in FIG. 17 is executed under the control of the control unit 152 of the collection robot 53, for example. Each procedure illustrated in FIG. 17 may be performed under the control of the control unit 102 of the control center 3.

As illustrated in FIG. 17, the collection robot 53 moves behind the first cart robot 51 to follow the first cart robot 51 (Step S301). That is, the collection robot 53 moves along the local lane 60.

The first cart robot 51 paired with the collection robot 53 may be predetermined. In this case, the collection robot 53 may start moving in synchronization with the first cart robot 51 when the pair of first cart robots 51 starts the picking processing. The paring is not limited thereto, and the first cart robot 51 paired with the collection robot 53 may be designated each time by the control unit 102 of the control center 3, for example.

Subsequently, the collection robot 53 judges whether the dropped basket 56 has been detected (Step S302). For example, the collection robot 53 detects the dropped basket 56 using the vehicle body sensor group 72 located at the front end of the traveling vehicle body B (refer to FIG. 18). FIG. 18 illustrates a state in which the basket 56 drops at the time of transfer from the first cart robot 51 to the second cart robot 52 in a parallel travel section 61. The basket 56 drops in front of the collection robot 53, and thus, with the detection unit provided at the front end of the collection robot 53 in the traveling direction, the dropped basket 56 can be accurately and quickly detected.

When having judged in Step S302 that the dropped basket 56 has been detected (Step S302, Yes), the collection robot 53 temporarily cancels the operation of following the first cart robot 51 and moves to where the dropped basket 56 exists (Step S303). At this time, the collection robot 53 may deviate from the local lane 60.

Subsequently, the collection robot 53 picks up the dropped basket 56 using one or a plurality of recovery arms 67 (Step S304). The collection robot 53 places the picked-up basket 56 on the traveling vehicle body B (refer to FIG. 19).

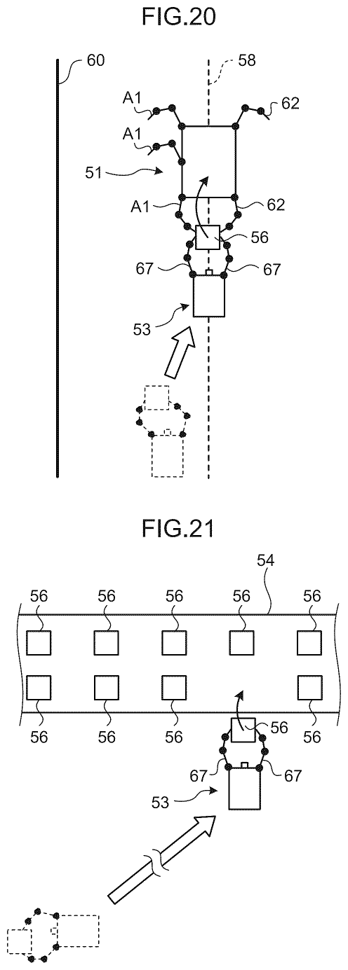

Subsequently, the collection robot 53 moves at a speed higher than the moving speed (first moving speed) of the first cart robot 51 so as to approach the first cart robot 51, and then docks (performs parallel travel) with the first cart robot 51 (Step S305). Subsequently, the collection robot 53 passes the dropped basket 56 to the first cart robot 51 (Step S306). For example, the collection robot 53 takes the basket 56 from the traveling vehicle body B using the recovery arm 67 and holds out the basket to the first cart robot 51. The first cart robot 51 receives the basket 56 held out from the collection robot 53 using picking arms 62 and passing arms A1, and places the received basket 56 on the traveling vehicle body B (refer to FIG. 20).

In this manner, the collection robot 53 can minimize the deviation from the original pickup plan by passing the collected basket 56 to the first cart robot 51.

In addition, by transferring the basket 56 in the same direction as the traveling direction of the first cart robot 51 and the collection robot 53, it is possible to efficiently transfer the dropped basket 56. The transfer direction is not limited thereto, and the collection robot 53 may transfer the basket 56 from the side of the first cart robot 51.

When the processing of Step S306 has been completed, or when the dropped basket has not been detected in Step S302 (Step S302, No), the collection robot 53 judges whether a series of operations of the first cart robot 51 based on the pickup plan has been completed (Step S307). When having determined in this processing that the work of the first cart robot 51 has not been completed, (Step S307, No), the collection robot 53 returns the processing to Step S301 and continues the processing from Step S301. In contrast, when having judged in Step S307 that the work of the first cart robot 51 has completed (Step S307, Yes), the collection robot 53 ends the series of collection processing.

In this manner, the picking system S according to the present embodiment includes: the detection unit that detects the basket 56 dropped from the first cart robot 51 or the second cart robot 52; and the collection robot 53 that collects the basket 56 detected by the detection unit. With this configuration, the picking system S according to the present embodiment can efficiently collect the dropped package.

The first cart robot 51 that has received the basket 56 from the collection robot 53 may pass the basket 56 received from the collection robot 53 to the second cart robot 52 in the next parallel travel section 61, for example.

### Other Embodiments

FIG. 21 is a diagram illustrating an example of a case of returning the collected basket 56 to the storage section 54. While the above embodiment has described an example in which the collected basket 56 is passed to the first cart robot 51, the conveyance destination of the collected basket 56 does not necessarily need to be the first cart robot 51.

For example, as illustrated in FIG. 21, the collection robot 53 may return the collected basket 56 to the storage section 54. Specifically, the collection robot 53 may place the collected basket 56 at a position where the collected basket 56 has been placed before being picked up by the first cart robot 51 within the storage section 54.

Alternatively, the collection robot 53 may place the collected basket 56 on the basket 56 scheduled to be picked up by one of the first cart robots 51 among the baskets 56 placed in the storage section 54.

The conveyance destination of the collected basket 56 may be the second cart robot 52. That is, the collection robot 53 may pass the collected basket 56 to the second cart robot 52.

The conveyance destination of the collected basket 56 may be the docking station 68. That is, the collection robot 53 may pass the collected basket 56 to the docking station 68.

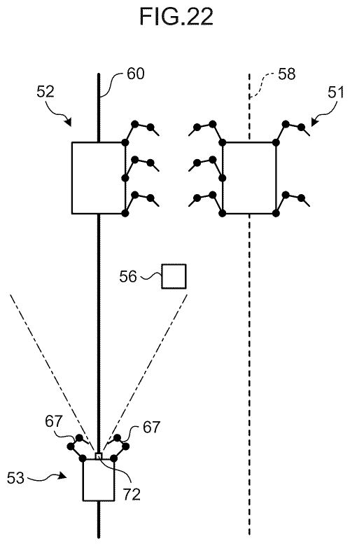

FIG. 22 is a diagram illustrating an example of a case where the collection robot 53 follows the second cart robot 52. While the above embodiment has described the example in which the collection robot 53 follows the first cart robot 51, the object to be followed by the collection robot 53 does not necessarily need to be the first cart robot 51.

For example, as illustrated in FIG. 22, the collection robot 53 may be positioned behind the second cart robot 52 and move to follow the second cart robot 52. In other words, the collection robot 53 may circle around the fast lane 58 together with the second cart robot 52.

Furthermore, when following the first cart robot 51 or the second cart robot 52, the collection robot 53 does not necessarily need to move along the local lane 60 or the fast lane 58. For example, the collection robot 53 may move along a collection lane extending equidistant from the local lane 60 or the fast lane 58. The collection lane may be located inside the local lane 60 or outside the fast lane 58. Furthermore, the collection lane may be located between the local lane 60 and the fast lane 58.

The collection robot 53 does not necessarily need to follow the first cart robot 51 or the second cart robot 52. For example, the collection robot 53 may be waiting at a predetermined waiting place in normal times and start the collection operation when having received a collection command from the control unit 102 of the control center 3.

While the above embodiment has described an example in which the collection robot 53 includes the cart-like traveling vehicle body B, the collection robot 53 does not necessarily need to include a cart. That is, the collection robot 53 may move to a conveyance destination (first cart robot 51, second cart robot 52, storage section 54, and the like) while holding the collected basket 56 by the recovery arm 67.

As described above, the picking system according to the embodiment includes the first cart robot (as an example, the first cart robot 51) that moves along the slow lane (as an example, the slow lane 60) and the second cart robot (as an example, the second cart robot 52) that moves along the fast lane (as an example, the fast lane 58) at a higher speed than the first cart robot. The picking system picks up a package (as an example, the basket 56) using the first cart robot and passes the package to the second cart robot. The picking system also includes: the detection unit (as an example, at least one of the vehicle body sensor group 72, the arm sensor group 74, or the in-warehouse sensor group 70) that detects the package dropped from the first cart robot or the second cart robot; and the collection robot (as an example, the traveling vehicle body B) that collects the package detected by the detection unit.

Accordingly, with the picking system according to the embodiment, the dropped package can be efficiently collected.

### Fifth Embodiment

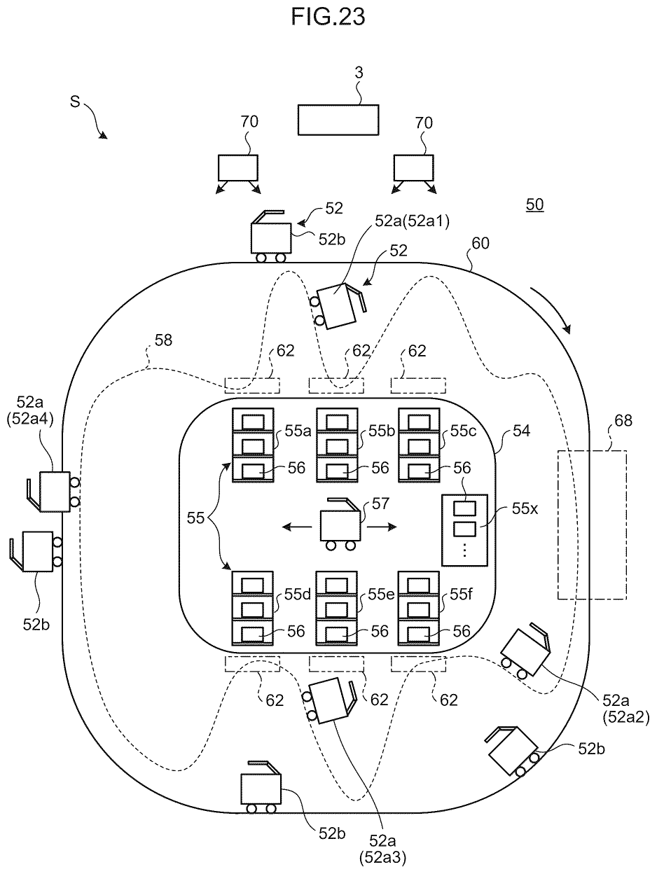

Next, a fifth embodiment will be described. Description of portions overlapping with the above-described embodiment will be omitted. FIG. 23 is a plan view of the floor 50 of a warehouse to which a picking system S according to the fifth embodiment is applied. As illustrated in FIG. 23, the picking system S is different from the above-described embodiment in including a placement robot 57. Although FIG. 23 illustrates an example in which the quantity of the placement robots 57 is one, the number is not limited thereto, and the placement robot 57 may be provided in plurality.

As described above, on the shelf 55 of the storage section 54, the basket 56 before being picked up by the first cart robot 52a is placed. Here, it is conceivable that the worker performs the work of placing the basket 56 on the shelf 55, for example, but the manual placement work is not efficient in that it takes time and labor. Therefore, the present embodiment uses a configuration in which the basket 56 can be efficiently placed on the shelf 55.

Specifically, the picking system S further includes, in addition to the cart robot 52, the placement robot 57 to place the basket 56 on the shelf 55 from which the basket 56 is to be picked up by the cart robot 52 (first cart robot 52a). That is, the picking system S includes the placement robot 57 dedicated to the placement work of placing the basket 56 on the shelf 55.

In this manner, the picking system S according to the present embodiment includes the placement robot 57, making it possible to reduce the work time and labor as compared with the case where the worker performs the placement work, leading to efficient placement of the basket 56 on the shelf 55.

Furthermore, as described above, the placement robot 57 is configured to place the basket 56 on the shelf 55 from which the basket 56 is to be picked up by the first cart robot 52a. With this configuration, the placement robot 57 can efficiently place the basket 56 on the shelf 55 to be used for the first cart robot 52a.

In addition, the placement robot 57 is controlled based on the placement plan information created by the control center 3 described above. For example, the control center 3 creates placement plan information including: a placement list of the baskets 56 to be placed on the shelf 55 by the placement robot 57; and a moving route of the placement robot 57 in the storage section 54. The placement list may include information such as identification information of the shelf 55 on which the basket 56 is to be placed, identification information of the basket 56 to be placed on the shelf 55, and a placement order of the baskets 56. Furthermore, the placement plan information may include information such as information regarding the timing at which the placement robot 57 places the basket 56 on the shelf 55.

The control center 3 transmits the created placement plan information to the placement robot 57. Subsequently, the placement robot 57 controls the traveling vehicle body 10 and the arm 11 according to the placement plan information received.

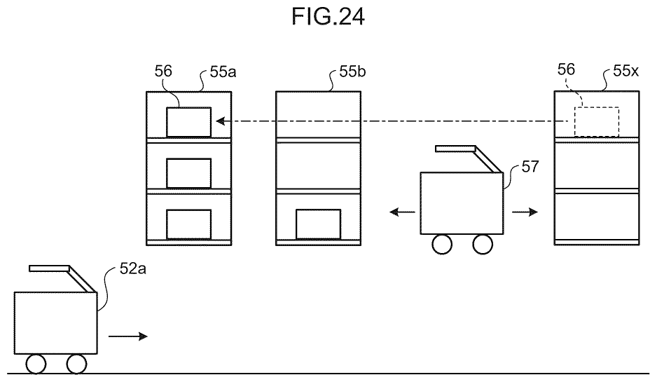

Here, an operation example of the placement robot 57 and the like will be described with reference to FIG. 24. FIG. 24 is a view illustrating an operation example of the placement robot 57. The example of FIG. 24 is a case assuming there are a first shelf 55a and a second shelf 55b, and the first cart robot 52a is traveling near the first shelf 55a. In addition, the basket 56 in the warehouse section 55x is assumed to be the basket 56 to be picked up by the first cart robot 52a.

The placement robot 57 places the basket 56 on the first shelf 55a near the first cart robot 52a, among the first shelf 55a and the second shelf 55b. Specifically, the placement robot 57 retrieves the basket 56 from the warehouse section 55x, conveys the retrieved basket 56, and places the basket on the first shelf 55a existing near the first cart robot 52a (refer to a one-dot arrow). In FIG. 24, the basket 56 retrieved from the warehouse section 55x is indicated by a broken line.

In this manner, the placement robot 57 places the basket 56 on the shelf 55 (here, the first shelf 55a) near the first cart robot 52a among the plurality of shelves 55 (here, the first shelf 55a and the second shelf 55b). With this configuration, the first cart robot 52a can pick up the basket 56 to be picked up as soon as possible, leading to improved pickup efficiency.

The shelf 55 near the first cart robot 52a described above will preferably be the shelf 55 closest to the first cart robot 52a in the traveling direction, but there is no limitation to this, and may be the shelf 55 at which the first cart robot 52a can arrive relatively early. Furthermore, the shelf 55 near the first cart robot 52a described above may be selected based on conditions such as the positions, moving speeds, moving routes of the first cart robot 52a and the placement robot 57, for example. For example, the control unit 102 selects, from among the plurality of shelves 55, the shelf 55 (here, the first shelf 55a) having the first cart robot 52a being estimated to travel in its vicinity at a timing of completion of the placement of the basket 56 on the shelf 55 by the placement robot 57, and creates placement plan information regarding the placement of the basket 56 on the selected shelf 55. The placement robot 57 performs a delivery work based on the placement plan information, making it possible for the first cart robot 52a to pick up the basket 56 as soon as possible after the placement is completed, leading to improvement in the pickup efficiency.

An operation example of the placement robot 57 and the like will be described with reference to FIG. 23. In the present embodiment, each of the plurality of shelves 55 is set to correspond to one cart robot 52 or two or more first cart robots 52, among the plurality of cart robots 52 (more precisely, first cart robots 52a).

As an example, the first shelf 55a is set to correspond to the first cart robot 52al. In other words, the first shelf 55a is a shelf for the first cart robot 52al, and the basket 56 on this shelf is picked up by the first cart robot 52a1. The second shelf 55b and the third shelf 55c are set to correspond to a first cart robot 52a2. The fourth shelf 55d is set to correspond to the first cart robot 52a2 and a first cart robot 52a3. The fifth shelf 55e and the sixth shelf 55f are set to correspond to a first cart robot 52a4. The correspondence relationship between the shelf 55 and the first cart robot 52a described above is merely an example and is not limited.

Subsequently, the placement robot 57 places the basket 56 picked up by the first cart robot 52a on the shelf 55 corresponding to the first cart robot 52a.

For example, the placement robot 57 places the basket 56 to be picked up by the subsequent first cart robot 52a1 on the first shelf 55a corresponding to the first cart robot 52a1. Similarly, the placement robot 57 places the basket 56 to be picked up by the first cart robot 52a2 on any one of the second shelf 55b to the fourth shelf 55d corresponding to the first cart robot 52a2. In addition, the placement robot 57 places the basket 56 to be picked up by the first cart robot 52a3 on the fourth shelf 55d corresponding to the first cart robot 52a3. In addition, the placement robot 57 places the basket 56 to be picked up by the first cart robot 52a4 on the fifth shelf 55e or the sixth shelf 55f corresponding to the first cart robot 52a4.

With this configuration, the first cart robot 52a can pick up the basket 56 to be picked up as soon as possible from the corresponding shelf 55, leading to further improvement in pickup efficiency.

In a case where the shelf 55 corresponding to the first cart robot 52a is set, the travel of the first cart robot 52a is not limited to the meandering travel illustrated in FIG. 23, and may be, for example, a reciprocating travel of traveling back and forth between the shelf 55 (more precisely, the shelf 55 corresponding to the first cart robot 52a) and the fast lane 58.

Furthermore, in the above description, the plurality of shelves 55 and the plurality of first cart robots 52a correspond to each other in advance. However, the correspondence is not limited thereto, and the shelves 55 corresponding to the first cart robot 52a may be changed.

For example, the placement robot 57 may change the quantity of shelves 55 on which the baskets 56 are to be placed in accordance with the amount of the baskets 56 to be picked up by the first cart robot 52a. As an example, in a case where the quantity of baskets 56 to be picked up by the first cart robot 52a1 exceeds the quantity that can be accommodated in the corresponding first shelf 55a, the second shelf 55b, in addition to the first shelf 55a, is set as a shelf corresponding to the first cart robot 52a1. With this configuration, the placement robot 57 can place the baskets 56 on the second shelf 55b in an amount exceeding the quantity of baskets that can be accommodated in the first shelf 55a.

This configuration makes it possible to set the quantity of shelves 55 according to the amount of the basket 56 to be picked up by the first cart robot 52a. That is, the quantity of shelves 55 can be appropriately set, leading to efficient placement of the basket 56.

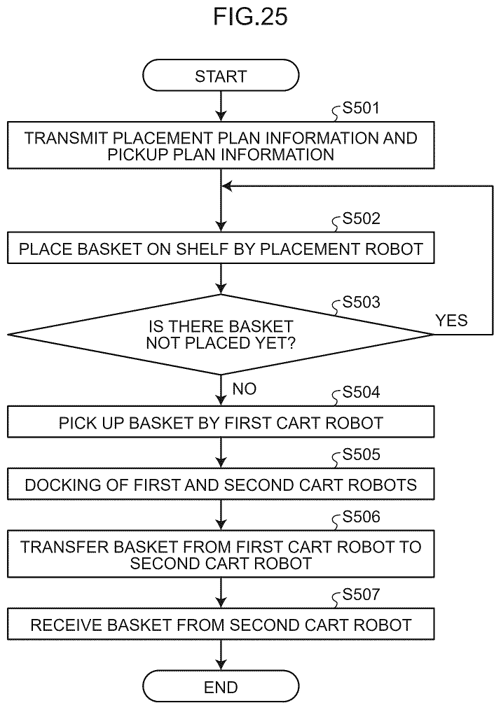

Next, operation processing of the picking system S according to the fifth embodiment will be described with reference to FIG. 25. FIG. 25 is a flowchart for illustrating operation processing of the picking system S according to the fifth embodiment.

As illustrated in FIG. 25, the control center 3 transmits the placement plan information to the placement robot 57, and transmits the pickup plan information to the first cart robot 52a and the second cart robot 52b (Step S501).

Upon receiving the placement plan information, the placement robot 57 places the basket 56 on the shelf 55 based on the placement plan information (Step S502). Subsequently, the placement robot 57 judges whether there is a basket 56 not placed yet (Step S503). When having judged that there is the basket 56 which is not placed yet (Step S503, Yes), the placement robot 57 returns to the processing of Step S502.

In contrast, when having judged that there is no basket 56 not placed yet, by the placement robot 57 that is to perform the placement work (Step S503 “NO”), the first cart robot 52a moves to the shelf 55 as the destination at the first moving speed (for example, 5 Km/h) along the local lane 60 and picks up the basket 56 (Step S504).

Subsequently, the first cart robot 52a moves toward the parallel travel section of the fast lane 58 at a second moving speed (for example, 20 Km/h), and docks (performs parallel traveling) with the second cart robot 52b in the parallel travel section (Step S505).

Subsequently, the basket 56 is transferred from the first cart robot 52a to the second cart robot 52b (Step S506). Thereafter, the second cart robot 52b moves to the docking station 68, and the basket 56 is received from the second cart robot 52b (Step S507).

As described above, the picking system S according to the present embodiment includes: the cart robot 52 that picks up and conveys the basket 56 (an example of package); and the placement robot 57 that places the basket 56 on the shelf 55 from which the basket 56 is to be picked up by the cart robot 52. This allows the basket 56 to be efficiently placed on the shelf 55.

### Sixth Embodiment

Next, a sixth embodiment will be described. Description of portions overlapping with the above-described embodiment will be omitted. In the picking system according to the sixth embodiment includes a charging station (charging apparatus). The charging station is a station for charging the driving battery of each cart robot 52. The charging station includes a connector and is connected to a charging port of the cart robot 52.

The charging station receives power supply from a warehouse or the like. The charging station supplies the supplied power to the cart robot 52. This enables charging of the driving battery of the cart robot 52.

Furthermore, when receiving the supply of power from the charging station, the cart robot 52 moves to a position where the charging port can be connected to the connector. The connector only needs to be electrically connected to the charging port, and does not necessarily need to be mechanically connected to the charging port.

The charging station wirelessly supplies power to the cart robot 52. For example, the charging station charges the cart robot 52 using an existing wireless power supply technology (non-contact charging).

Note that the charging station may be mechanically connected to the charging port to supply power by wired connection. In this case, the connector and the charging port are connected by a cable, for example. The cable connection may be performed by a person or may be automatically performed by a device.

The cart robot 52 performs the following operations under the control of the control center 1. That is, the cart robot 52 moves from the lane (the fast lane 58 or the local lane 60) currently used for traveling toward the charging station. At this point, the main operation (for example, transfer of the basket 56) of the cart robot 52 is stopped.

Subsequently, the cart robot 52 adjusts its own position and orientation to enable connection between the charging port and the connector. When the adjustment of the position and orientation is completed, the cart robot 52 receives power supply from the charging station. Thereafter, when the condition is satisfied, the cart robot 52 completes the charging, returns to the designated lane, and resumes the operation.

In this manner, there is a period in which the cart robot 52 cannot operate due to charging. The control center 1 controls the operation for charging the cart robot 52 in consideration of the efficiency of the operation of the entire picking system.

The control center 1 acquires information related to the order list. The control center 1 acquires information related to the state of each cart robot 52 from each cart robot 52. The information related to the state includes a task being executed, a remaining battery level, and the like. The control center 1 acquires information detected by the in-warehouse sensor group 70.

When a trigger is activated, the control center 1 starts a processing sequence for charging. The trigger corresponds to cases including: a case where the remaining battery level of any of the cart robots 52 falls below a threshold (for example, 15%) , a case where the start of the processing sequence for charging is requested from one of the cart robots 52, or a case where a predetermined time has arrived. In addition, the control center 1 may start the processing sequence at a constant time cycle (for example, a cycle of 30 minutes).

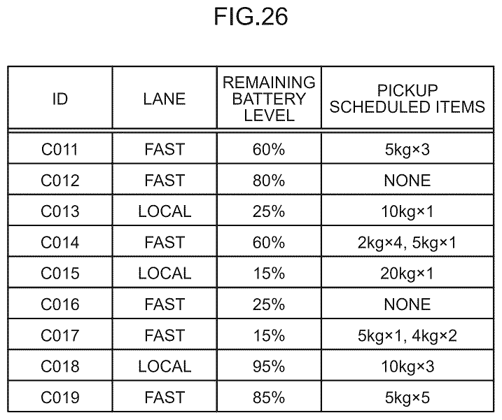

In the processing sequence, the control center 1 collects information including the remaining battery level. Subsequently, the control center 1 calculates the charging priority for each of the cart robots 52 based on the collected information. The control center 1 calculates the priority using the information illustrated in FIG. 26. FIG. 26 is a diagram illustrating an example of information collected by the control center according to the embodiment. The information illustrated in FIG. 26 includes information acquired by the control center 1 and information accumulated in the information accumulation unit.

In FIG. 26, “ID” is information for identifying the cart robot 52. “Lane” is information indicating a lane on which the cart robot 52 is currently traveling. “Fast” corresponds to the fast lane 58. “Local” corresponds to the local lane 60.

The “remaining battery level” is a remaining battery level of each driving battery of the cart robot 52. The “Pickup scheduled items” is the weight and quantity of the baskets 56 scheduled to be transferred by each of the cart robots 52 in a specific period. For example, the specific period is a period from the current time to 30 minutes later. The “Pickup scheduled items” is acquired from the pickup list created by the control unit 102.

For example, FIG. 26 illustrates a case where the cart robot 52 identified by “C011” is traveling on the fast lane 58 with the remaining battery level “60%”, and is scheduled to transfer three baskets 56, each being 5 kg.

For example, FIG. 26 illustrates a case where the cart robot 52 identified by “C013” is traveling on the local lane 60 with the remaining battery level “25%”, and is scheduled to transfer one basket 56 of 10 kg.

### (Priority Based on Lane)

As illustrated in “Lane” in FIG. 26, the control center 1 collects information including the quantity of cart robots 52 traveling in each of the plurality of lanes. Subsequently, the control center 1 sets the priority of each of the plurality of cart robot 52 such that the more the quantity of the cart robots 52 traveling on the lane, the higher the priority for the cart robot 52 on the lane.

The control center 1 counts the quantity of cart robots 52 traveling on the fast lane 58 and the quantity of cart robots 52 traveling on the local lane 60 based on the information in FIG. 26. Subsequently, the higher priority is set for the cart robot 52 traveling on the lane having the larger number of cart robot 52.

This is because the operation of the cart robot 52 stopped for charging can be more easily compensated by another cart robot 52 in the lane on which the larger number of cart robots 52 are traveling.

In the example of FIG. 26, the number of cart robots 52 traveling on the fast lane 58 is six, while the number of cart robots 52 traveling on the local lane 60 is three. Accordingly, the control center 1 sets the priority of the cart robot 52 traveling on the fast lane 58 to be higher than the priority of the cart robot 52 traveling on the local lane 60.

The control center 1 may calculate the priority based on a prescribed number of cart robot 52 for each lane. For example, it is assumed that the number of cart robots 52 required for the fast lane 58 is prescribed as six, and the number of cart robots 52 required for the local lane 60 is prescribed as two.

In this case, in the example of FIG. 26, the prescribed number of fast lanes 58 is exactly satisfied, while the number of cart robots 52 traveling on the local lane 60 exceeds the prescribed number. Accordingly, the control unit 102 sets the priority of the cart robot 52 traveling on the local lane 60 to be higher than the priority of the cart robot 52 traveling on the fast lane 58.

### (Priority Based on Remaining Battery Level)

Based on the information of FIG. 26, the control center 1 sets the priority such that the lower the remaining battery level, the higher the priority will be. This is because the cart robot 52 having a lower remaining battery level needs to be charged more quickly in order to avoid running-out of the battery.

When the remaining battery level exceeds an upper limit (for example, 50%), the control center 1 may keep the priority constant. Furthermore, in a case where the remaining battery level is below a lower limit value (for example, 20%), the control unit 102 may further increase the degree of raising the priority. With this setting, when the control unit 102 calculates the final priority by adding or multiplying the priority based on the remaining battery level and other priorities, the impact of the priority based on the remaining battery level can be increased.

For example, the control center 1 sets the priority to a constant value (for example, 1) when the remaining battery level is within a range of 100% to 50%.

When the remaining battery level is in a range of 50% to 20%, the control center 1 sets the priority inversely proportional to the remaining battery level (for example, when the remaining battery level is 25%, the priority will be the reciprocal of 25/100, resulting in 4). Furthermore, when the remaining battery level is in a range of 20% to 0%, the control unit 102 sets the priority inversely proportional to the square of the remaining battery level (for example, when the remaining battery level is 10%, the priority is a reciprocal of the square of (10/100), resulting in 100).

### (Priority Based on Pickup Scheduled Items)

As illustrated in “Pickup scheduled items” in FIG. 26, the control center 1 collects information including the weight and the quantity of packages to be conveyed by each of the plurality of cart robots 52. For each of the plurality of cart robots 52, the control unit 102 sets the priority such that, the higher the load base on the weight and the quantity of the packages to be conveyed, the higher the priority will be. This is because the remaining battery level decreases rapidly together with an increase of the load.

The control center 1 calculates, as the load, a total weight obtained by multiplying the weight and the quantity of the baskets 56 for each cart robot 52 based on the “Pickup scheduled items”. Subsequently, the control unit 102 sets the priority such that the larger the total weight, the higher the priority will be.

For example, the control unit 102 calculates the total weight of the cart robot 52 identified by “C013” as 5 kg×3=15 kg. The control unit 102 calculates the total weight of the cart robot 52 identified by “C012” as 0 kg.

In addition, the control unit 102 calculates the total weight of the cart robot 52 identified by “C014” as 2 kg×4+5 kg×1=13 kg.

The control center 1 calculates a final priority by using one priority, or combining a plurality of the priority based on the lane, the priority based on the remaining battery level, and the priority based on the pickup scheduled items described above.

Subsequently, the control center 1 controls the cart robot 52 of which the priority is included in the upper certain number (one or more) among the plurality of cart robots 52 to stop the conveyance of the package and perform charging.

It is conceivable that the stoppage of operation of the cart robot 52 along with the charging might hinder normal business operation. In such a case, in order to enable business operation to be performed normally, the control center 1 may re-create (update) the pickup list and the moving route of the cart robot 52 that does not perform charging.

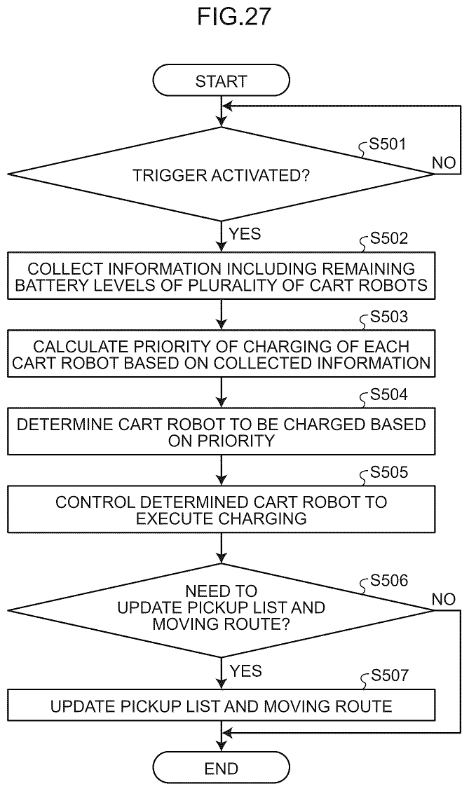

Next, processing of controlling charging of the cart robot 52 according to the embodiment will be described with reference to the flowchart of FIG. 27. FIG. 27 is a flowchart illustrating a flow of processing of controlling charging of a cart robot according to the sixth embodiment. The processing of Step S502 and subsequent steps in FIG. 27 corresponds to a processing sequence for charging.

The control center 1 waits until a trigger is activated (Step S501, No). When a trigger is activated (Step S501, Yes), the control center 1 proceeds to Step S502 and starts a processing sequence for charging. Examples of the trigger include a situation in which the remaining battery level of any of the cart robots 52 falls below a threshold.

The control center 1 collects information including the remaining battery levels of the plurality of cart robots 52 (Step S502). For example, the control center 1 collects information as illustrated in FIG. 26.

Next, the control center 1 calculates the charging priority of each cart robot 52 based on the collected information (Step S503). The control center 1 may calculate one priority out of the above-described priorities or may calculate a plurality of priorities.

Subsequently, the control center 1 determines a cart robot to be charged based on the priority (Step S504). Subsequently, the control center 1 controls the determined cart robot 52 to perform charging (Step S505).

The control center 1 then judges whether the pickup list and the moving route need to be updated along with the charging (Step S506). When having judged that the pickup list and the moving route need to be updated (Step S506, Yes), the control center 1 updates the pickup list and the moving route of the cart robot 52 that does not perform charging (Step S507), and ends the processing sequence.

When having judged that there is no need to update the pickup list and the moving route (Step S506, No), the control center 1 ends the processing sequence.

The processing sequence for charging may be executed by another apparatus instead of the control center 1. For example, the information processing apparatus 15 provided in the cart robot 52 may execute the processing sequence for charging. In this case, the cart robot 52 should be able to collect the information illustrated in FIG. 26.

### Seventh Embodiment

Next, a seventh embodiment will be described. Description of portions overlapping with the above-described embodiment will be omitted. A package has various properties such as being durable, fragile, warm, and cold for each package. Uniformly treating and mixing the packages having various properties, for example, a fragile article (being fragile) and an ordinary article (being durable) in a cart 16 might damage the fragile article. Similarly, uniformly treating and mixing a high-temperature article being warm and a low-temperature article being cold in the cart 16 might cause a failure in maintaining individual temperatures.

The packages having different properties are preferably to be handled differently according to the properties, for example, by separately storing the packages in the cart 16, conveying the packages by separate cart robots 52, or conveying the packages at different conveyance speeds.

Therefore, the picking system S according to the embodiment acquires the property of the package and executes the placement control of the package according to the property of the package. In addition, the picking system S also performs various speed controls according to the property of the package.

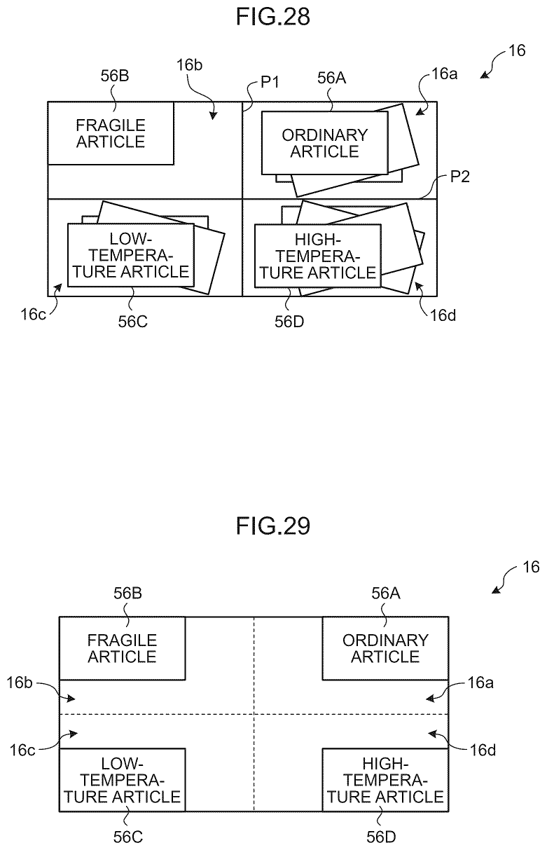

First, the package placement control will be described. FIGS. 28 to 31 are diagrams (part 1) to (part 4) each illustrating a placement example of the baskets 56 in the cart 16.

When mixing the packages having different properties on the cart 16, the picking system S can internally divide the cart 16 into several sections, for example, and then accommodate the packages having different properties in the different sections, as illustrated in FIG. 28.

FIG. 28 illustrates an example in which four sections 16a, 16b, 16c, and 16d are formed in the cart 16 by partitions P1 and P2. The drawing illustrates an example in which the section 16a accommodates a basket 56A of an ordinary article, the section 16b accommodates a basket 56B of a fragile article, the section 16c accommodates a basket 56C of a low-temperature article, and the section 16d accommodates a basket 56D of a high-temperature article. An ordinary article corresponds to an article less likely to break compared to a fragile article.

The cart robot 52 acquires the properties of these packages based on information from a sensor or a camera installed in the cart robot 52 and the control center 3. For example, a difference in properties such as an ordinary article and a fragile article can be acquired based on information from the control center 3. Alternatively, a difference in properties such as an ordinary article and a fragile article can be acquired by, for example, AI recognition of a label or the like such as “Fragile”, “Fragile Article”, “This Side UP”, “Handle with Care”, or “Precision machinery” attached to a package.

In addition, a difference in properties such as a high-temperature article and a low-temperature article can be acquired based on information from the control center 1. Alternatively, the difference in properties such as a low-temperature article and a high-temperature article can be acquired, for example, by AI recognition of a label or the like such as “Cool”, “Hot”, “Frozen”, “Warm”, or “Danger Hot Surface” attached to a package.

Subsequently, the cart robot 52 sorts and accommodates the packages in the sections 16a to 16d pre-allocated according to the acquired properties of the packages. At this time, for example, the cart robot 52 stores the basket 56B of a fragile article while pressing the basket 56B against the corner of the cart 16 as illustrated in FIG. 29. This makes it possible to increase the stability of the accommodated state of the basket 56B in the cart 16 and reduce the impact of vibration or the like during traveling of the cart robot 52, for example.

Furthermore, it is also allowable to provide, for example, a cushioning material (not illustrated) on the inner wall of the fragile article section 16b, for example. For example, it is also allowable to provide a heat insulating material, for example, on the inner walls of the sections 16c and 16d for a low-temperature article or a high-temperature article.

Furthermore, as illustrated in FIG. 29, the cart 16 does not necessarily need to be divided by the partitions P1 and P2 in FIG. 28. In this case, for example, the cart robot 52 accommodates each package in the sections 16a to 16d assigned to each property, and places the packages having different properties at intervals so as not to allow the packages having different properties to come into contact with each other. For example, as illustrated in FIG. 29, the cart robot 52 houses the baskets 56A to 56D while pressing each package having different properties against the corner of the cart 16.

This makes it possible to prevent the packages having different properties from coming into contact with each other, making it possible, for example, to prevent a damage on the packages or a change in the temperature.

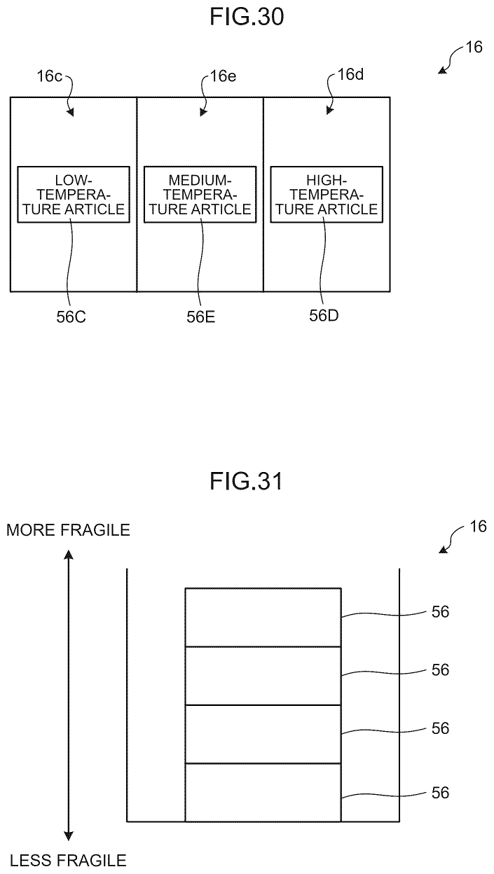

Furthermore, regarding the property regarding the temperature, for example, as illustrated in FIG. 30, the cart 16 may be partitioned by a section 16c for a low-temperature article, a section 16d for a high-temperature article, and a section 16e for a medium-temperature article, with the section 16e provided between the section 16c and the section 16d.

With this configuration, even when the medium-temperature article is affected by the temperature of the package in the adjacent section, the medium-temperature article acts as a buffer, making it possible to moderate the temperature rise of the low-temperature article and the temperature fall of the high-temperature article, for example.

In addition, as illustrated in FIG. 31, for example, when there is a need to load a fragile article and an ordinary article on the cart 16, the cart robot 52 may stack the baskets 56 so as to allow more highly fragile articles to be placed at a higher position. This makes it possible to prevent the fragile article from being damaged by the weight of the articles stacked thereon.

The description using FIGS. 28 to 31 is a placement example of the basket 56 in the cart 16. Alternatively, packages having different properties may be separately conveyed by different cart robots 52. In this case, only the basket 56A of an ordinary article is accommodated and conveyed in the cart 16 of a certain cart robot 52, while only the basket 56B of a fragile article is accommodated and conveyed in the cart 16 of another cart robot 52. Such sorting of the cart robot 52 according to the property of the package is performed by, for example, the control center 3.

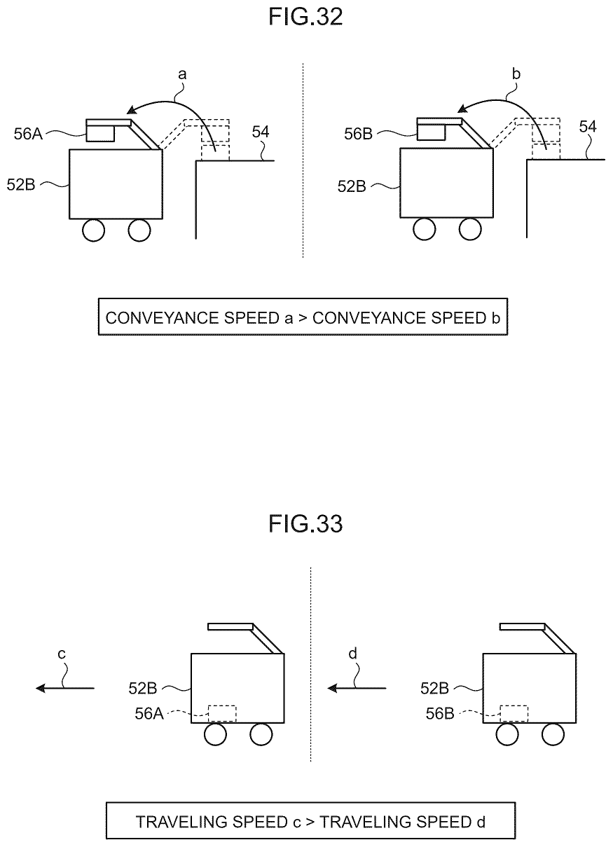

Next, various speed controls according to the property of the package will be described with reference to FIGS. 32 to 34. FIGS. 32 to 34 are (part 1) to (part 3) illustrating speed control examples according to the properties of the package.

As illustrated in FIG. 32, for example, it is also allowable to perform conveyance speed control so as to differentiate the conveyance speed by the arm 11 between a case where the local cart 52B picks up the basket 56A being an ordinary article from the storage section 54 and a case where the basket 56B picks up the basket B of a fragile article from the storage section 54. FIG. 32 illustrates an example of performing the speed control of the local cart 52B so as to have a relationship between a conveyance speed a of the basket 56A of an ordinary article and a conveyance speed b of the basket 56B of a fragile article to satisfy “conveyance speed a>conveyance speed b”. This makes it possible to reduce a risk of damaging the fragile article by conveyance by the arm 11.

Furthermore, as illustrated in FIG. 33, for example, it is also allowable to perform the control so as to differentiate the traveling speed of the local cart 52B between a case where the local cart 52B carries the basket 56A of an ordinary article and travels, and a case where the local cart 52B carries the basket 56B of a fragile article and travels. FIG. 33 illustrates an example of performing the speed control of the local cart 52B so as to set a relationship between a traveling speed c of the local cart 52B carrying the basket 56A of an ordinary article and a traveling speed d of the local cart 52B carrying the basket 56B of a fragile article to satisfy “traveling speed c>traveling speed d”. With this control, it is possible to reduce the risk of damaging the fragile article by traveling of the local cart 52B.

Although FIGS. 32 and 33 illustrate examples of the local cart 52B, the similar applies to the fast cart 52A.

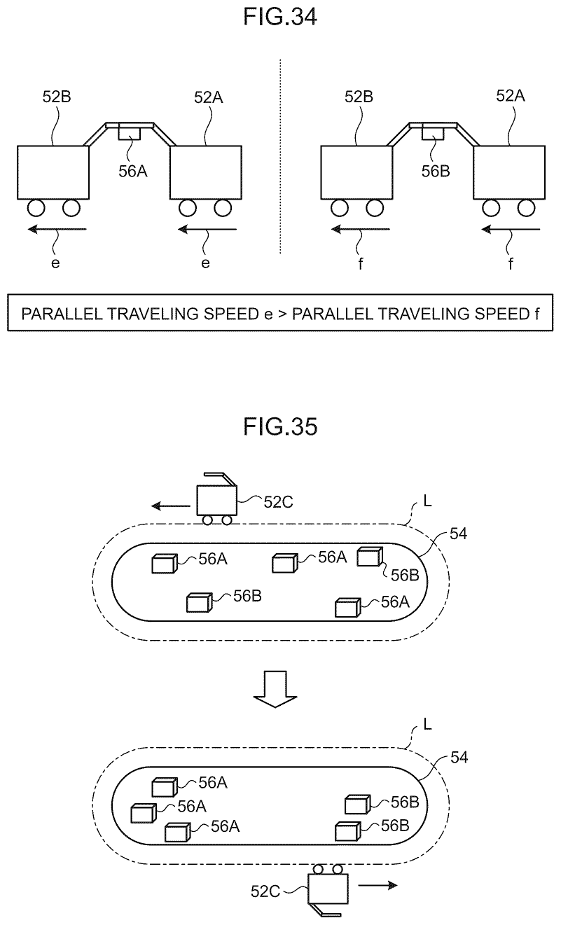

Furthermore, as illustrated in FIG. 34, for example, it is also allowable to perform the control so as to differentiate the parallel traveling speed at the transfer between the local cart 52B and the fast cart 52A, between a case of transferring the basket 56A of an ordinary article is transferred and a case of transferring the basket 56B of a fragile article. FIG. 34 illustrates an example of performing a speed control in which the speed of the local cart 52B and the speed of the fast cart 52A is controlled such that the relationship between a parallel traveling speed e in a case of transferring the basket 56A of the ordinary article and a parallel traveling speed f in a case of transferring the basket 56B of the fragile article satisfies “the parallel traveling speed e>the parallel traveling speed f”. This makes it possible to reduce the risk of damaging the fragile article at the time of transfer between the local cart 52B and the fast cart 52A. The examples illustrated in FIGS. 32 to 34 may be appropriately combined with each other.

Incidentally, the picking system S may include a dedicated cart robot 52 that monitors a package pickup state in the storage section 54 and appropriately sorts the basket 56 in the storage section 54 in accordance with the property of the package.

FIG. 35 is a diagram illustrating an example of using a monitoring cart 52C that monitors the pickup state in the storage section 54. The monitoring cart 52C is a cart robot 52 that constantly monitors the package pickup state in the storage section 54 and appropriately sorts the basket 56 in the storage section 54 in accordance with the property of the package.

As illustrated in FIG. 35, the monitoring cart 52C is provided to move along a dedicated lane L around the storage section 54, for example. The dedicated lane L is provided along the storage section 54 inside the local lane 60. Note that the dedicated lane L does not physically restrict the movement of the monitoring cart 52C.

The monitoring cart 52C circles around the storage section 54 constantly, periodically, or at any selected timing, and monitors the package pickup state in the storage section 54. In addition, as illustrated in FIG. 35, for example, in a case where packages having different properties are scattered around in the storage section 54, the monitoring cart 52C collects the packages having same properties using the arm 11 and moves the baskets 56 so as to be locally concentrated.

FIG. 35 illustrates an example in which scattered baskets 56A of an ordinary article or the baskets 56B of a fragile article have been sorted by the monitoring cart 52C so as to allow the baskets 56A or the baskets 56B to be locally concentrated. This makes it possible to improve efficiency when the local cart 52B picks up a package from the storage section 54.

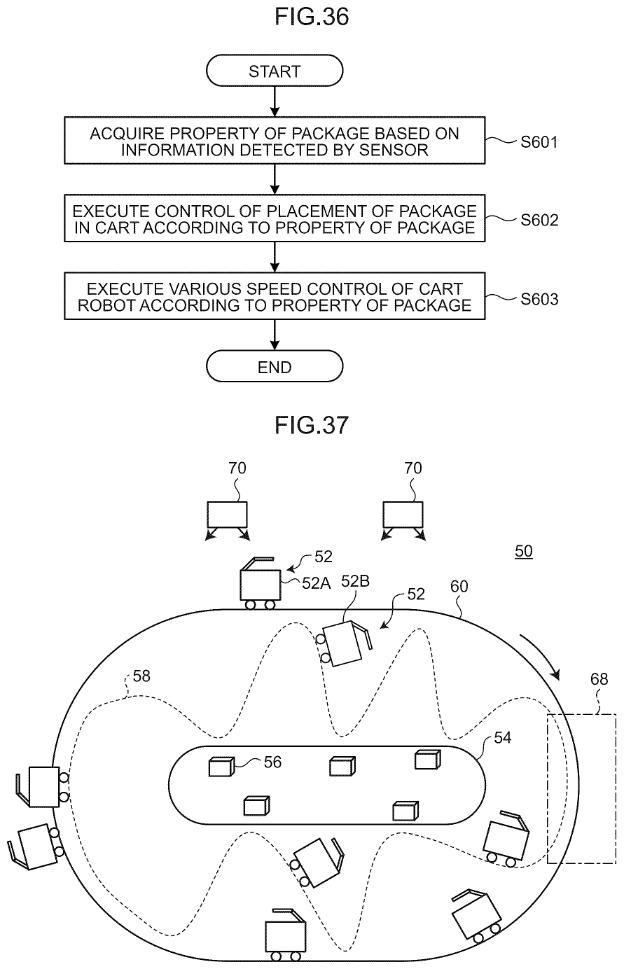

Next, operation processing of the cart robot 52 according to the embodiment will be described with reference to FIG. 36. FIG. 36 is a flowchart illustrating operation processing of the cart robot 52 according to a seventh embodiment. Here, the information processing apparatus 15 is supposed to control the operation processing.

The cart robot 52 acquires the property of the package based on the information detected by the sensor (Step S601).

Subsequently, the cart robot 52 executes placement control of the package in the cart 16 according to the acquired property of the package (Step S602). The cart robot 52 executes the placement control so that the placement according to the property of the package is to be performed in each placement example described with reference to FIGS. 28 to 31, for example.

Subsequently, the cart robot 52 performs various types of speed control of the cart robot 52 according to the acquired property of the package (Step S603). The cart robot 52 performs the speed control so that various types of speed control according to the property of the package are performed in the individual speed control examples described with reference to FIGS. 32 to 34, for example.

Although the above has described package property examples such as being hardly broken, being fragile, being warm, and being cold, but these are merely examples. That is, placement control and/or speed control may be performed according to the other package properties such as being long, short, heavy, and light.

### Eighth Embodiment

Next, an eighth embodiment will be described. Description of portions overlapping with the above-described embodiment will be omitted. FIG. 37 is a plan view of a floor 50 of a warehouse to which a picking system according to the eighth embodiment is applied.

The cart robot 52 is classified into a fast cart 52A that travels on the fast lane 58 and a local cart 52B that travels on the local lane 60.

The local cart 52B retrieves the basket 56 from the storage section 54 while moving along the local lane 60. The local cart 52B has a first retrieval mode and a second retrieval mode as retrieval modes.

The first retrieval mode is a mode of retrieving the basket 56 from the storage section 54 by the arm 11 during traveling of the traveling vehicle body 10. When the retrieval mode is the first retrieval mode, the local cart 52B retrieves the basket 56 from the storage section 54 by the arm 11 while traveling at a predetermined speed. The predetermined speed is a speed set in advance.

The second retrieval mode is a mode of stopping the traveling vehicle body 10 and retrieving the basket 56 from the storage section 54 by the arm 11. In a case where the retrieval mode is the second retrieval mode, the local cart 52B stops the traveling vehicle body 10 and retrieves the basket 56 from the storage section 54 by the arm 11.

The local cart 52B sets the retrieval mode to either the first retrieval mode or the second retrieval mode based on the size of the basket 56, the placement of the basket 56, and the length of the arm 11. That is, the local cart 52B switches the retrieval mode to the first retrieval mode or the second retrieval mode in accordance with the size of the basket 56, controls the traveling vehicle body 10 and the arm 11, and retrieves the basket 56 from the storage section 54.

The size of basket 56 includes the weight of basket 56. The length of the arm 11 is a length of the arm 11 when the arm 11 extends the most, for example. The length of the arm 11 may be a length set for each basket 56 to be retrieved.

The placement of basket 56 is the position of basket 56 placed in the storage section 54. That is, the placement of basket 56 includes information related to the height at which basket 56 was placed and information related to the position of basket 56 relative to the local lane 60. For example, the placement of baskets 56 is position information in three-dimensional orthogonal coordinates on the floor 50 of the warehouse. The orthogonal coordinates include, for example, a Z axis having a vertically upward direction as a positive direction, a Y axis orthogonal to the Z axis, and an X axis orthogonal to the Z axis and the Y axis.

The local cart 52B acquires, from the control center or the like, information related to the size of the basket 56 to be retrieved from the storage section 54 and the placement of the basket 56 to be retrieved from the storage section 54, and stores the acquired information in an internal storage section.

The local cart 52B stores mode switching data set in advance for the size of the basket 56, the placement of the basket 56, and the length of the arm 11. The mode switching data is data for setting whether the retrieval mode is to be set to the first retrieval mode or the second retrieval mode when the local cart 52B retrieves the basket 56 from the storage section 54.

The mode switching data is set in advance in accordance with the placement of the basket 56 in the storage section 54, the size of the basket 56, and the length of the arm 11, and stored in the local cart 52B. The mode switching data is updated when the placement or the like of the basket 56 in the storage section 54 is changed. The mode switching data is transmitted from the control center to the information processing apparatus 15, for example.

The mode switching data is provided so as to stabilize the posture of the local cart 52B when the local cart 52B retrieves the basket 56 from the storage section 54. The mode switching mode is set so as to prevent the local cart 52B from falling when the local cart 52B retrieves the basket 56 from the storage section 54. The mode switching data is created based on an experimental result and a simulation result, for example.

For example, when the local cart 52B has retrieved the basket 56 from the storage section 54 while traveling, and the posture of the local cart 52B is unstable with a risk of falling, the first retrieval mode is set to correspond to the mode switching data. When the local cart 52B has retrieved the basket 56 from the storage section 54 while traveling, and the posture of the local cart 52B is stable with no risk of falling, the second retrieval mode is set to correspond to the mode switching data.

That is, the information regarding the first attachment mode or the information regarding the second attachment mode is associated with the size of the basket 56, the placement of the basket 56, and the length of the arm 11, and the mode switching data is stored in the information accumulation unit 154 of the local cart 52B.

The control unit 152 of the local cart 52B sets the retrieval mode to the first retrieval mode or the second retrieval mode based on the size of the basket 56 to be retrieved from the storage section 54, the placement of the basket 56 to be retrieved from the storage section 54, and the length of the arm 11.

The control unit 152 of the local cart 52B retrieves the basket 56 from the storage section 54 using set retrieval mode.

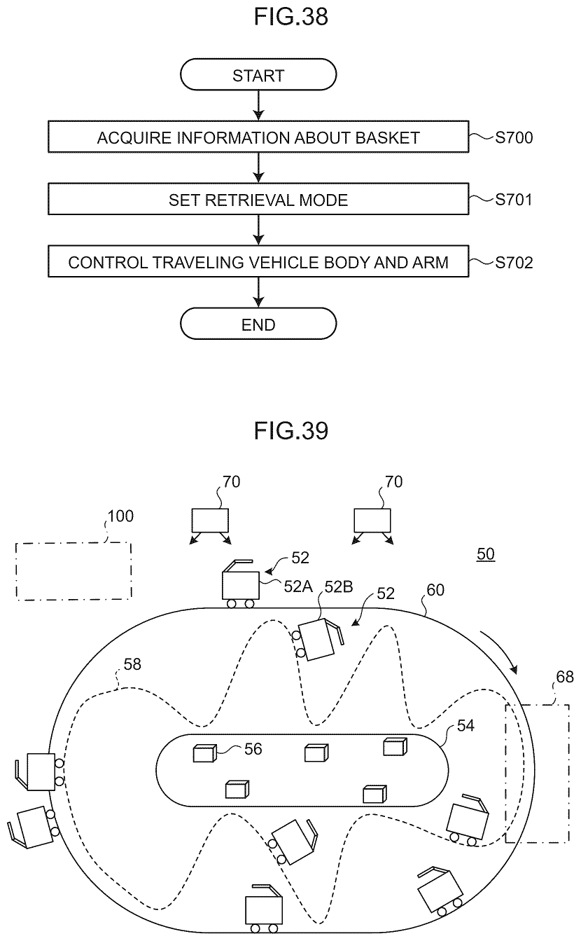

Next, operation processing of the local cart 52B according to the embodiment will be described with reference to the flowchart of FIG. 38. FIG. 38 is a flowchart for illustrating operation processing of the local cart 52B according to the eighth embodiment. The operation processing described below is executed by the information processing apparatus 15 of the local cart 52B.

The information processing apparatus 15 acquires information of the basket 56 to be retrieved from the storage section 54 (S700). The information processing apparatus 15 sets the retrieval mode based on the acquired information of the basket 56 and the length of the arm 11 (S701). The information processing apparatus 15 sets the retrieval mode to the first retrieval mode or the second retrieval mode based on the size of the basket 56 to be retrieved from the storage section 54, the placement of the basket 56 in the storage section 54, and the length of the arm 11.

The information processing apparatus 15 controls the traveling vehicle body 10 and the arm 11 to retrieve the basket 56 from the storage section 54 according to the set retrieval mode (S702).

The information processing apparatus 15 may control the operation of the arm 11 and the operation of the traveling vehicle body 10 by using information detected by the in-warehouse sensor group 70.

The local cart 52B includes an arm 11, a traveling vehicle body 10, and an information processing apparatus 15. The arm 11 retrieves the basket 56 from the storage section 54. The arm 11 is attached to the traveling vehicle body 10. The basket 56 retrieved by the arm 11 can be placed on the traveling vehicle body 10. The information processing apparatus 15 controls the arm 11 and the traveling vehicle body 10. The information processing apparatus 15 can execute the first retrieval mode of retrieving the basket 56 from the storage section 54 by the arm 11 while the traveling vehicle body 10 is traveling, and the second retrieval mode of stopping the traveling vehicle body 10 and retrieving the basket 56 from the storage section 54 by the arm 11. The information processing apparatus 15 sets the retrieval mode to either the first retrieval mode or the second retrieval mode based on the size of the basket 56, the placement of the basket 56, and the length of the arm 11.

With this configuration, in a case where the posture of the local cart 52B is stabilized even if the basket 56 is retrieved of the storage section 54 while the traveling vehicle body 10 is traveling, the local cart 52B retrieves the basket 56 from the storage section 54 while allowing the traveling vehicle body 10 to travel. Therefore, the local cart 52B can quickly collect the baskets 56, leading to improvement in work efficiency in the case of retrieving the baskets 56 from the storage section 54.

The local cart 52B may stabilize the posture of the local cart 52B to retrieve the basket 56 from the storage section 54. For example, in a case where retrieving the basket 56 while traveling will hinder stabilization of the posture of the local cart 52B, the local cart 52B stops the traveling vehicle body 10, and retrieves the basket 56 from the storage section 54. With this configuration, the local cart 52B can prevent the local cart 52B from falling when retrieving the basket 56 from the storage section 54. That is, the local cart 52B may improve safety when retrieving the basket 56 from the storage section 54.

In addition, when retrieving the plurality of baskets 56 from the storage section 54, and when a distance between the baskets 56 to be retrieved from the storage section 54 on the local lane 60 is a predetermined distance or less, the information processing apparatus 15 of the local cart 52B sets the retrieval mode to the second retrieval mode.

The predetermined distance is a distance set in advance, and is a distance at which the plurality of baskets 56 cannot be retrieved by one travel along the local lane 60 while the traveling vehicle body 10 travels. For example, when the local cart 52B has two baskets 56 located at a predetermined distance or less, and the traveling vehicle body 10 is to retrieve the two baskets 56 from the storage section 54, the two baskets 56 cannot be retrieved from the storage section 54 with one travel along the local lane 60.

In such a case, the local cart 52B first retrieves the first basket 56 from the storage section 54 while allowing the traveling vehicle body 10 to travel by the first travel on the local lane 60. Subsequently, the local cart 52B retrieves the second basket 56 from the storage section 54 while allowing the traveling vehicle body 10 to travel by the second traveling on the local lane 60. That is, the local cart 52B need to travel two rounds in the local lane 60 in order to retrieve the two baskets 56.

In such a case, the information processing apparatus 15 of the local cart 52B sets the retrieval mode to the second retrieval mode. In this mode, the local cart 52B stops the traveling vehicle body 10 at the time of traveling on the local lane 60 once, and retrieves the two baskets 56 from the storage section 54 by the arm 11. For example, the local cart 52B stops at a position where the two baskets 56 can be retrieved by the arm 11 and retrieves the two baskets 56.

The number of the plurality of baskets 56 retrieved from the storage section 54 described above as an example is not limited to two. The number of the plurality of baskets 56 may be three or more.

With this configuration, when retrieving the plurality of baskets 56 from the storage section 54, the local cart 52B can shorten a time for retrieving the plurality of baskets 56, leading to improvement in work efficiency.

### Ninth Embodiment

Next, a ninth embodiment will be described. Description of portions overlapping with the above-described embodiment will be omitted. FIG. 39 is a plan view of a floor 50 of a warehouse to which a picking system according to the ninth embodiment is applied.

The floor 50 includes a base 100 in which maintenance work of the cart robot 52 is to be performed. For example, base 100 stores equipment necessary for maintenance and constantly has a worker who performs maintenance. On the floor 50, maintenance work of the cart robot 52 that has returned to the base 100 is performed. Note that the maintenance work of the cart robot 52 may be performed by a robot.

In the base 100, it is allowable to prepare a spare cart robot 52 that performs work instead of the cart robot 52 currently performing the maintenance work. The spare cart robot 52 may constantly patrol on the floor 50. In this case, for example, the spare cart robot 52 may be a robot that picks up a package instead of the cart robot 52 when the cart robot 52 currently working has dropped the package.

Furthermore, as will be described below, in a case where the cart robot 52 has its own abnormality, it autonomously travels and returns to the base 100. With this configuration, it is only required for the worker to stand by in the base 100, making it possible to improve the work efficiency. Note that there may be a plurality of bases 100 in the floor 50, and the bases 100 may also be provided outside the floor 50.

In a case where the cart robot 52 has an own abnormality, it controls the traveling vehicle body 10 to return to the base 100. The own abnormality includes a malfunction of the traveling vehicle body 10 and the arm 11.

For example, the cart robot 52 detects an own abnormality based on self images captured by various cameras. The control unit 152 detects an own abnormality using the images and AI. At this time, the cart robot 52 may detect an own abnormality based on an image captured by another cart robot 52.

For example, the other cart robot 52 may be the currently working cart robot 52, or may be the cart robot 52 patrolling on the floor 50 in order to capture an image of each cart robot 52.

Furthermore, the cart robot 52 may detect an own abnormality based on sound, for example. For example, the cart robot 52 detects an own abnormality based on the presence or absence of an abnormal sound of a motor or the like. The abnormality detection processing may be performed at a control center (not illustrated).

Having detected its own abnormality, the cart robot 52 controls the traveling vehicle body 10 to return the cart robot 52 to the base 100. At this time, the control unit 152 may perform control to return to the base 100 after completion of the current task, or may suspend the task and return to the base 100.

Furthermore, in a case where the cart robot 52 returns to the base 100, the cart robot notifies the base 100, the control center, or the like, of the return. For example, the notification includes information related to reservation of maintenance and details of abnormality. This makes it possible to perform the maintenance promptly in the base 100.

Furthermore, in a case where the cart robot 52 suspends the task and returns to the base 100, the task may be handed over to the spare cart robot 52 waiting in the base 100 or another cart robot 52. The handover of the task here includes transfer of a package between the cart robots 52.

Thereafter, when the abnormality is cleared in the base 100, the cart robot 52 returns to the work on the floor 50. At this time, the cart robot 52 may resume the work from the interrupted task, or may start the work from a new task.

Furthermore, the cart robot 52 may return to the base 100 when having detected a sign of abnormality. For example, the cart robot 52 detects a sign of abnormality using AI that has learned signs of abnormality.

That is, in this case, maintenance can be received before an abnormality occurs. This makes it possible to prevent occurrence of abnormality in the cart robot 52.

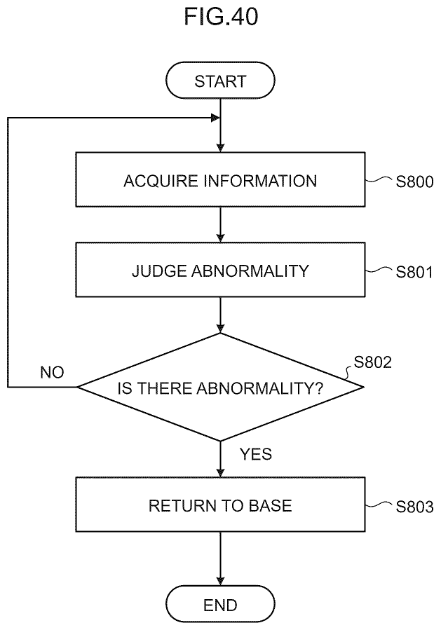

Next, operation processing of the cart robot 52 according to the embodiment will be described with reference to the flowchart of FIG. 40. FIG. 40 is a flowchart illustrating operation processing of the cart robot 52 according to the ninth embodiment.

The information processing apparatus 15 acquires various types of information related to detection of an own abnormality (S800). The information processing apparatus 15 performs abnormality judgment based on various types of information acquired (S801). The information processing apparatus 15 judges whether there is an abnormality as a result of the abnormality judgment (S802).

When having judged that there is an abnormality (S802; Yes), the information processing apparatus 15 performs control to return to the base 100 (S803). When the information processing apparatus 15 judges that there is no abnormality (S802; No), the processing proceeds to S800.

Note that the processes of S800 to S802 may be performed by the control center. In this case, the information detected by each cart robot 52, the in-warehouse sensor group 70, and the like is transmitted to the control center. When the control center has detected an abnormality in each cart robot 52, the control center transmits a return instruction to the cart robot 52.

The information processing apparatus 15 may control the operation of the arm 11 and the operation of the traveling vehicle body 10 by using information detected by the in-warehouse sensor group 70.

The cart robot 52 includes: the arm 11 that transfers a package: the traveling vehicle body to which the arm is attached and on which the package can be placed; and the information processing apparatus 15 (an example of a control apparatus) that controls the traveling vehicle body 10 to return the cart robot 52 to the base 100 in a case of occurrence of an own abnormality.

Furthermore, the information processing apparatus 15 makes a maintenance request when performing control to return its own cart robot to the base 100. Furthermore, in a case where an own abnormality is detected from the camera image obtained by imaging its own cart robot, the information processing apparatus 15 performs control to return the own cart robot to the base 100.

Furthermore, in a case where an own abnormality is detected from a camera image captured by the own cart robot or a camera image captured by another cart robot, the information processing apparatus 15 performs control to return the own cart robot to the base 100. In addition, the information processing apparatus 15 performs control to return the own cart robot to the base 100 in the presence of an indication related to the abnormality of the own cart robot. Furthermore, in a case of performing control to return the own cart robot to the base 100, the information processing apparatus 15 hands over the current task to another cart robot.

This makes it possible for the cart robot 52 to accurately perform the operation of the arm 11.

### Tenth Embodiment

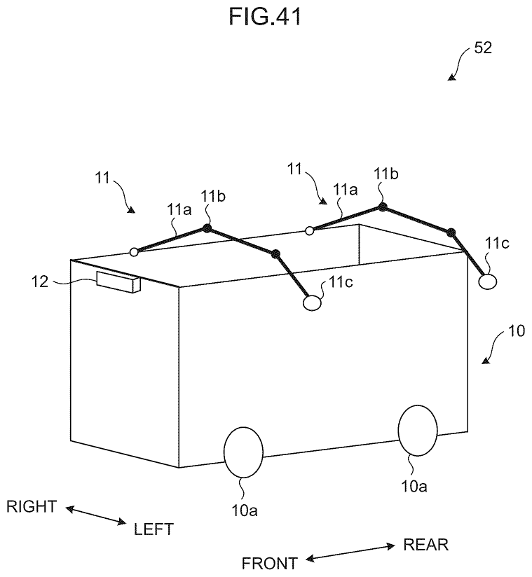

Next, a tenth embodiment will be described. Description of portions overlapping with the above-described embodiment will be omitted. FIG. 41 is a perspective view of a cart robot according to the tenth embodiment. As illustrated in FIG. 41, the cart robot 52 includes a traveling vehicle body 10, a plurality of arms 11, a sensor 12, and an information processing apparatus 15.

The traveling vehicle body 10 is formed in a box shape with an open top, for example. The traveling vehicle body 10 is a body on which a basket can be placed. The traveling vehicle body 10 includes a plurality of drive wheels 10a. Each of the drive wheels 10a has a motor.

The arm 11 is attached to the traveling vehicle body 10. A proximal end of the arm 11 is attached to the traveling vehicle body 10, allowing the arm 11 to be fixed to the traveling vehicle body 10. For example, the proximal end of the arm 11 is attached to the upper end of the traveling vehicle body 10. The arm 11 is provided in plurality with respect to the traveling vehicle body 10.

The arm 11 includes a plurality of rod portions 11a and a plurality of joint portions 11b. The joint portion 11b is provided between the two rod portions 11a, for example, so as to allow relative rotations of the two rod portions 11a. The relative rotations of the rod portions 11a by individual joint portions 11b allow the arm 11 to expand, contract, and perform 360-degree rotations.

The sensor 12 is attached to the traveling vehicle body 10. The sensor 12 is located on the front side of the traveling vehicle body 10. For example, the sensor 12 is located at the front end of the traveling vehicle body 10. The sensor 12 is located at the upper end of the traveling vehicle body 10. The sensor 12 may be provided so as to protrude upward from the traveling vehicle body 10. The sensor 12 is attached near the center of the traveling vehicle body 10 in the left-right direction. For example, the arm 11 and the sensor 12 are provided so as to be positioned opposite each other on the traveling vehicle body 10.

The information processing apparatus 15 (control apparatus) determines the quantity of the arms 11 that performs the transfer, in accordance with the package. Specifically, the control unit 152 determines the quantity of the arms 11 in accordance with the weight, volume, quantity, and the like of the package to be transferred.

For example, the information processing apparatus 15 compares the weight of the package with a threshold and then determines the quantity of the arms 11. For example, in a case where the weight of the package is less than a threshold, the threshold being defined as a weight as a load capacity per arm 11, the control unit 152 determines the quantity of the arms 11 as one.

Furthermore, in a case where the weight of the package exceeds the threshold, the information processing apparatus 15 determines the quantity of the arms 11 to be two or more. That is, the information processing apparatus 15 transfers the package with the minimum number of the arm 11 in accordance with the weight of the package.

This can reduce the power consumption as compared with the case where the package is constantly transferred by the plurality of arms 11. Furthermore, with such a configuration, for example, another arm 11 can be used to transfer another package simultaneously.

This makes it possible for the cart robot 52 to efficiently transfer the package. Note that the information processing apparatus 15 may acquire the weight of the package in advance by an order or the like, or may use a value detected by a weight sensor of the traveling vehicle body 10.

Furthermore, the information processing apparatus 15 determines the quantity of the arms 11 according to the size of the package. In other words, in this case, in a case where there is a possibility that the package will drop when conveyed by one arm, the information processing apparatus 15 transfers the package by the plurality of arms 11.

Furthermore, the information processing apparatus 15 may determine the quantity of the arms 11 in accordance with the quantity of packages to be transferred at one time. For example, the control unit 152 increases the quantity of the arms 11 with an increase in the quantity of packages.

In addition, the information processing apparatus 15 may determine the quantity of the arms 11 according to the type of package. For example, in a case where a package is a package that may be damaged by a shock when dropped, such as a broken object or a precision machine, the information processing apparatus 15 may allow a margin for the quantity of the arms 11.

Furthermore, in a case where the package is transferred with another cart robot 52, the information processing apparatus 15 may determine the quantity of the arms 11 according to the arms 11 used by the another cart robot 52 for transfer of the package.

That is, the information processing apparatus 15 extends the above-described determination processing related to the quantity of the arms 11 to other cart robots 52 to determine the quantity of the arms 11. Note that the quantity of the arms 11 may be determined in accordance with an instruction from the control center in a case where the cart robot 52 performs a cooperative operation with another cart robot to transfer the package.

Furthermore, after determining the quantity of the arms 11, the information processing apparatus 15 may perform the transfer of the package by selecting the arm 11 capable of efficiently performing the transfer of the package, for example. In this case, the control unit 152 may perform the transfer by the arm 11 close to the package among the plurality of arms 11.

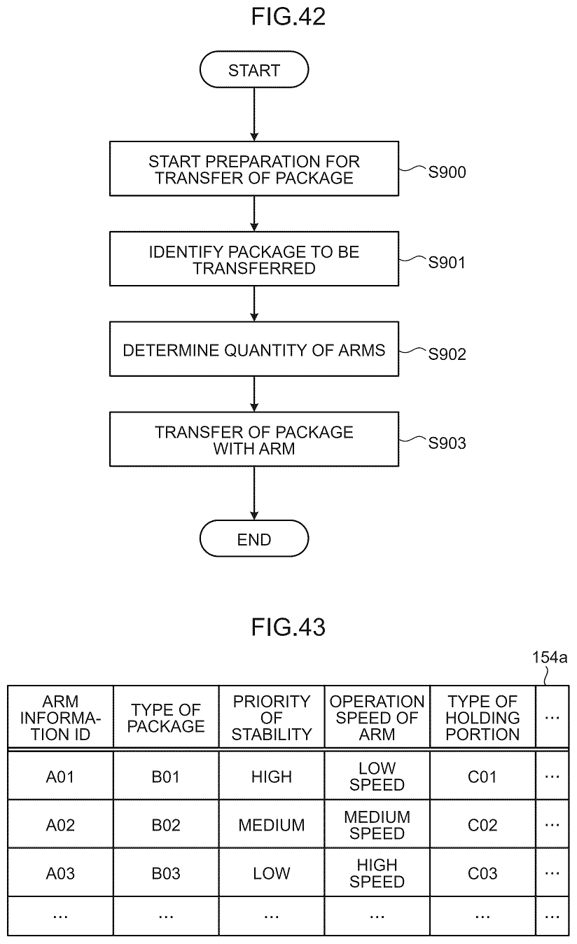

Next, operation processing of the cart robot 52 according to the embodiment will be described with reference to the flowchart of FIG. 42. FIG. 42 is a flowchart illustrating operation processing of the cart robot 52 according to the tenth embodiment.

The information processing apparatus 15 starts preparation for transfer of the package (S900). The information processing apparatus 15 identifies a package to be transferred (S901). The information processing apparatus 15 determines the quantity of the arms 11 to be used to perform transfer, based on the identified package (S902).

The information processing apparatus 15 transfers the package with the determined quantity of the arms 11 (S903). Note that the information processing apparatus 15 may perform these series of processing based on an instruction from a control center (not illustrated).

Subsequently, the information processing apparatus 15 moves the traveling vehicle body 10 to the determined position of the traveling vehicle body 10. The information processing apparatus 15 moves the arm 11 to the determined position of the arm 11 along with the movement of the traveling vehicle body 10. The information processing apparatus 15 controls the operation of the traveling vehicle body 10 and the operation of the arm 11 in accordance with the placement of the storage section 54, the position of the basket 56, and the presence or absence of another local cart 52B.

The cart robot 52 includes: the plurality of arms 11 to be used for transfer of packages; the traveling vehicle body 10 to which the arms 11 are attached and on which the packages can be placed; and the information processing apparatus 15 (an example of a control apparatus) that determines the quantity of arms to be used for transfer, in accordance with the packages.

Furthermore, the information processing apparatus 15 determines the quantity of the arms 11 according to the weight of the package. Furthermore, the information processing apparatus 15 determines the quantity of the arms 11 according to the size of the package. Furthermore, the information processing apparatus 15 determines the quantity of the arms 11 according to the quantity of packages.

With this configuration, the cart robot 52 can efficiently transfer the package.

### Eleventh Embodiment

Next, an eleventh embodiment will be described. Description of portions overlapping with the above-described embodiment will be omitted. In the eleventh embodiment, the cart robot 52 determines the operation speed of the arm 11 in accordance with the type of package. For example, the cart robot 52 determines the operation speed of the arm 11 based on the arm information illustrated in FIG. 43. FIG. 43 is a diagram illustrating an example of arm information.

As illustrated in FIG. 43, arm information 154a includes items such as “Arm information ID”, “Package type”, “Priority of stability”, “Operation speed of arm”, and “Holding portion type”, in which data of each item being associated (linked) with each other. The information included in the individual items of “Package type”, “Priority of stability”, “Operation speed of arm”, and “Type of holding portion” is information set in advance, but is not limited thereto.

The “Arm information ID” is information identifying the arm information. The “Type of package” is information indicating the type of the basket (package) 56. Examples of “Type of package” include, but are not limited to, information indicating electronic devices, precision machinery, home electric appliances, clothing, food, and books. In the example illustrated in FIG. 4, the “Type of package” is described in abstract notation such as “B01” for convenience, but specific information is stored in “B01” in practice. Hereinafter, other information may be described in abstract notation.

In the present embodiment, the operation speed of the arm 11 is determined in accordance with the type of the basket (package) 56 described above, so that the cart robot 52 can appropriately transfer the basket 56, which will be described below.

The “Priority of stability” is information indicating a degree to which stability is prioritized when the corresponding basket (package) 56 is conveyed by transfer or the like. The “Priority of stability” is set in stages such as high, medium, and low, for example.

Although FIG. 43 illustrates an example in which the “Priority of stability” is in three stages, the quantity of stages is not limited thereto, and may be in two stages or four or more stages.

Specifically, the “Types of package” includes electronic devices, precision machinery, home electric appliances, and the like, which are likely to be affected by vibration and the like during conveyance due to the property of the package. Therefore, it is preferable that the electronic device and the like receive relatively little vibration during conveyance, and thus stability during conveyance has high priority. In other words, regarding the electronic device or the like, stability is prioritized over speed at the time of conveyance. Accordingly, the “Priority of stability” for the item in which the “Type of package” corresponds to the electronic device or the like is set to be high.

Meanwhile, the “Types of package” includes items such as clothing, food, and books, having higher resistance to vibration and the like at the time of conveyance as compared to electronic devices and the like, and thus highly prioritizing speed over stability at the time of conveyance. In other words, items such as clothing highly prioritize speed while maintaining, to some extent, stability at the time of conveyance. Accordingly, the “Priority of stability” for the item in which the “Type of package” corresponds to items such as clothing is set to be medium or low. In other words, the “Priority of stability” of the “Type of package” corresponding to items such as clothing is set to be lower than the “Priority of stability” corresponding to items such as electronic devices.

Note that the above-described electronic devices, precision machinery, home electric appliances, and the like are examples of a package of a predetermined type. In addition, items such as clothing, food, and books described above are examples of a package of other types, being different from the predetermined type. Accordingly, a package of a predetermined type (here, electronic devices or the like) is a package that highly prioritize stability during conveyance over package of another type (here, clothing or the like).

The “Operation speed of arm” is information indicating the operation speed of the arm 11. Specifically, the “Operation speed of arm” is the operation speed when the arm 11 transfers the basket 56, in other words, information indicating the operation speed when the arm 11 holds and conveys the basket 56.

The “operation speed of the arm” is set in stages such as high speed, medium speed, and low speed, for example. Specifically, the “Operation speed of the arm” corresponding to the “Package type” highly prioritizing stability priority is set to low speed. The “Operation speed of arm” corresponding to the “Package type” having a medium priority on stability is set to medium speed higher than low speed. The “Operation speed of the arm” corresponding to the “package type” having a low priority on stability is set to high speed, higher than the low speed or the medium speed. Although FIG. 43 illustrates an example in which the “Operation speed of arm” is in three stages, the quantity of stages is not limited thereto, and may be in two stages or four or more stages.

The “type of holding portion” is information indicating the type of a holding portion 12c of the arm 11 used to transfer the basket 56. The “Type of holding portion” includes the grip portion and the suction holding portion described above, as well as a magnetic force holding portion. The type of the holding portion 12c attached to the arm 11 is assumed to be set in the “Type of holding portion”.

As an example, in the “Type of holding portion” corresponding to the“ Type of package” having a high priority in stability, the type (for example, grip portion) of the holding portion 12c that can stably hold and convey the basket 56 is set. In addition, in the “Type of holding portion” corresponding to the “Type of package” having a medium or low priority on stability (in other words, the “Type of package” having high priority on speed), the type of the holding portion 12c (for example, suction holding portion or magnetic force holding portion) capable of holding the basket 56 relatively quickly and conveying the basket at a medium or high speed is set. In the above description, the type of the holding portion 12c corresponding to the “Type of package” has been specifically described. However, this description is an example and is not limited thereto.

In the example illustrated in FIG. 43, the arm information identified by the arm information ID “A01” indicates that the type of the package is “B01”, the priority of the stability is “high”, the operation speed of the arm is “low”, and the type of the holding portion is “C01”. The arm information identified by the arm information ID “A02” indicates that the type of package is “B02”, the priority of stability is “medium”, the operation speed of arm is “medium speed”, and the type of the holding portion is “C02”. The arm information identified by the arm information ID “A03” indicates that the type of package is “B03”, the priority of stability is “low”, the operation speed of arm is “high speed”, and the type of the holding portion is “C03”.

The information processing apparatus 15 controls the operation of the arm 11 based on the information indicating the type of the basket 56 and the arm information described above. Specifically, the information processing apparatus 15 determines the operation speed of the arm 11 to transfer the basket 56 in accordance with the type of the basket 56. In other words, the information processing apparatus 15 determines the operation speed of the arm 11, from when the arm 11 holds the basket 56 until when passing the basket 56 or placing the basket 56 on the traveling vehicle body 10, in accordance with the type of the basket 56. That is, the information processing apparatus 15 determines the operation speed of the arm 11 after holding the basket 56, in accordance with the type of the basket 56.

With this configuration, the information processing apparatus 15 according to the present embodiment can determine the operation speed of the arm 11 to a value suitable to the type of the basket 56 to be transferred, making it possible to appropriately perform the transfer of the basket 56 by the cart robot 52.

Specifically, the information processing apparatus 15 varies the operation speed, that is, makes a differentiation between the operation speed of the arm 11 that transfers the basket 56 (package of a predetermined type) of the electronic device or the like and the operation speed of the arm 11 that transfers the basket 56 (package of another type) of the clothing or the like. Specifically, the information processing apparatus 15 varies the operation speed, that is, makes a differentiation between the operation speed of the arm 11 when the type of the basket 56 to be transferred is an electronic device or the like and having a relatively high priority on stability at the time of conveyance and the operation speed of the arm 11 when the type of the basket 56 to be transferred is clothing or the like and having lower priority in stability at the time of conveyance compared with that of the electronic device or the like.

In this manner, the information processing apparatus 15 varies the operation speed of the arm 11 depending on the type of the basket 56 to be transferred. This makes it possible to determine the operation speed of the arm 11 suitable to the type of the basket 56, and achieving more appropriate transfer of the basket 56 by the cart robot 52.

More specifically, when the basket 56 to be transferred is of a type of an electronic device or the like and is the basket 56 that puts higher priority on stability at the time of conveyance over clothing or the like, the information processing apparatus 15 decreases the operation speed of the arm 11 that is to perform the transfer of the basket 56 (package of a predetermined type) of the electronic device or the like to be lower than the operation speed of the arm 11 that is to perform the transfer of the clothing or the like (package of another type). In other words, the information processing apparatus 15 set the operation speed of the arm 11 to the low speed.

With this configuration, in the present embodiment, the basket 56 (package of a predetermined type) of the electronic device or the like is stably transferred and conveyed by the arm 11 at a relatively low speed, making it possible to suppress vibration, dropping, and the like on the basket 56, achieving further appropriate transfer of the basket 56.

Furthermore, when the basket 56 to be transferred is a type of clothing or the like, and is the basket 56 that puts higher priority on speed at the time of conveyance over the electronic device or the like, the information processing apparatus 15 increases the operation speed of the arm 11 that is to perform the transfer of the basket 56 (package of another type) of the clothing or the like to be higher than the operation speed of the arm 11 that is to perform the transfer of the basket 56 (package of a predetermined type) of the electronic device or the like. In other words, the information processing apparatus 15 sets the operation speed of the arm 11 to medium speed or high speed.

With this configuration, the basket 56 (other types of package) such as clothing is quickly transferred and conveyed while maintaining stability by the medium-speed or high-speed arm 11, making it possible to appropriately perform the transfer of the basket 56.

In this manner, in the present embodiment, by determining the operation speed of the arm 11 in accordance with the type of the basket 56 to be transferred, it is possible to achieve both stability and speed at the time of conveyance.

Note that the information processing apparatus 15 may set the operation speed of the arm 11 when the arm 11 is not holding the basket 56 to an initial speed (for example, high speed) set in advance. Specifically, the information processing apparatus 15 may set the operation speed of the arm 11 to the initial speed (for example, high speed) before the arm 11 holds the basket 56, after transferring the basket 56, after placing the basket 56 on the traveling vehicle body 10, or the like. The information processing apparatus 15 may determine the operation speed of the arm 11 before holding the basket 56, in accordance with the type of the basket 56.

The information processing apparatus 15 may change the type of the holding portion 12c of the arm 11 that is to transfer the basket 56, in accordance with the type of the basket (package) 56. With this configuration, it is possible, in the present embodiment, to appropriately hold the basket 56 by the arm 11, achieving more appropriate transfer of the basket 56.

Specifically, the information processing apparatus 15 varies the operation speed, that is, makes a differentiation between the holding portion 12c of the arm 11 that transfers the basket 56 (a package of a predetermined type) of the electronic device or the like and the holding portion 12c of the arm 11 that transfers the basket 56 (package of another type) of the clothing or the like. Specifically, the information processing apparatus 15 varies the operation speed, that is, makes a differentiation between the holding portion 12c of the arm 11 when the type of the basket 56 to be transferred is an electronic device or the like and having a relatively high priority on stability at the time of conveyance and the holding portion 12c of the arm 11 when the type of the basket 56 to be transferred is clothing or the like and having priority in stability at the time of conveyance lower than that of the electronic device or the like.

More specifically, when the basket 56 to be transferred is of a type of an electronic device or the like and is the basket 56 that puts higher priority on stability at the time of conveyance over clothing or the like, the information processing apparatus 15 uses the holding portion 12c (the grip portion, for example) capable of stably hold and convey the basket 56, as the holding portion 12c of the arm 11 that is to perform the transfer of the basket 56 (package of a predetermined type) such as an electronic device.

With this configuration, the basket 56 (package of a predetermined type) such as the electronic device is stably held, transferred and conveyed by the arm 11, making it possible to suppress vibration, dropping, and the like on the basket 56, achieving further appropriate transfer of the basket 56.

Furthermore, in a case where the basket 56 to be transferred is of a type of clothing or the like, and is the basket 56 that puts higher priority on speed at the time of conveyance over the electronic device or the like, the information processing apparatus 15 uses the holding portion 12c (for example, a suction holding portion or a magnetic force holding portion) capable of holding the basket 56 relatively quickly and conveying the basket 56 at a medium speed or a high speed, as the holding portion 12c of the arm 11 that is to transfer the basket (package of another type) such as clothing.

With this configuration, the basket 56 (package of another type) such as clothing is quickly transferred and conveyed while being held, with stability, by the medium-speed or high-speed arm 11, making it possible to further appropriately transfer the basket 56. In this manner, by changing the type of the holding portion 12c of the arm 11 in accordance with the type of the basket 56 to be transferred, it is possible to achieve both stability and speed at the time of conveyance.

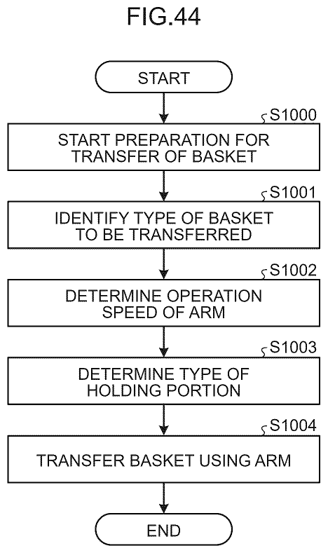

Next, operation processing of the cart robot 52 according to the embodiment will be described with reference to FIG. 44. FIG. 44 is a flowchart illustrating operation processing of the cart robot 52 according to the eleventh embodiment.

As illustrated in FIG. 44, the information processing apparatus 15 starts preparation for the transfer of the basket 56 based on a signal or the like transmitted from a control center or the like that instructs the operation of the cart robot 52 (Step S1000). Next, the information processing apparatus 15 identifies the type of the basket 56 to be transferred by the arm 11 (Step S1001). For example, the information processing apparatus 15 identifies the type of the basket 56 based on a signal transmitted from a control center or the like, or information related to the basket 56 detected by the sensor 12 or the in-warehouse sensor group 70.

Next, the information processing apparatus 15 determines the operation speed of the arm 11 in accordance with the identified type of the basket 56 (Step S1002). The information processing apparatus 15 determines the type of the holding portion 12c of the arm 11 in accordance with the type of the basket 56 (Step S1003). In the example of FIG. 44, the processing has been described in the order of Step S1002 and Step S1003. However, the processing may be performed in the order of Step S1003 and Step S1002, or the processing of Step S1002 and Step S1003 may be performed in parallel.

Next, the information processing apparatus 15 transfers the basket 56 using the arm 11 to which the determined operation speed and the type of the holding portion 12c are applied (Step S1004). Note that the information processing apparatus 15 may perform these series of processing based on an instruction from a control center (not illustrated).

As described above, the cart robot 52 according to the present embodiment includes the arm 11 and the information processing apparatus 15 (an example of a control apparatus). The arm 11 transfers the basket 56. The information processing apparatus 15 determines the operation speed of the arm 11 to transfer the basket 56 in accordance with the type of the basket 56. With this configuration, the transfer of the basket 56 can be appropriately performed in accordance with the type of the basket 56.

### Twelfth Embodiment

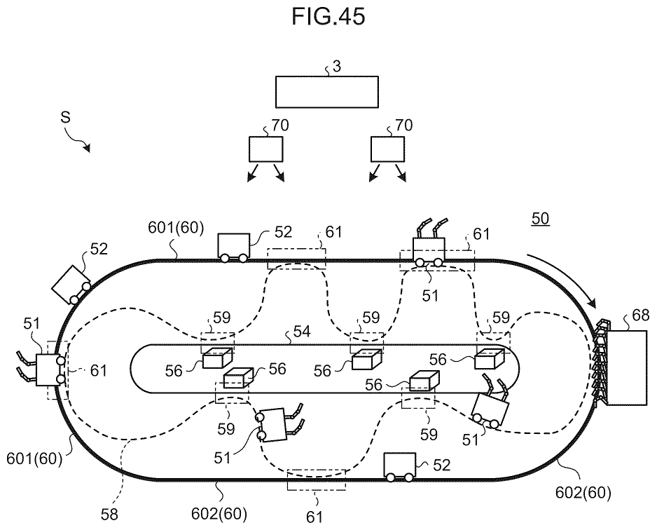

Next, a twelfth embodiment will be described. Description of portions overlapping with the above-described embodiment will be omitted. FIG. 45 is a plan view of the floor 50 of a warehouse to which a picking system S according to the twelfth embodiment is applied. As illustrated in FIG. 45, the picking system S includes a plurality of first cart robots 51 and a plurality of second cart robots 52.

The floor 50 illustrated in FIG. 1 includes a storage section (such as a warehouse and a shelf) 54, which stores a plurality of baskets 56. The basket 56 is an item (package) to be collected by picking work. The first cart robot 51 and the second cart robot 52 move around the storage section 54.

The first cart robot 51 is a cart robot that moves along the local lane 60 (an example of the first lane). The second cart robot 52 is a cart robot that moves at a higher speed than the first cart robot 51, and moves along the fast lane 58 (an example of the second lane).

The local lane 60 includes: a pickup section 59 close to the storage section 54; and a parallel travel section 61 close to the fast lane 58 and travels in parallel with the fast lane 58. The first cart robot 51 meanders between the storage section 54 and the fast lane 58.

The first cart robot 51 temporarily decelerates or stops in the pickup section 59 and picks up the basket 56 from the storage section 54. Furthermore, the first cart robot 51 passes the basket 56 to the second cart robot 52 in the parallel travel section 61.

The first cart robot 51 and the second cart robot 52 transfer the basket 56. The transfer includes retrieving the basket 56 from the storage section 54.

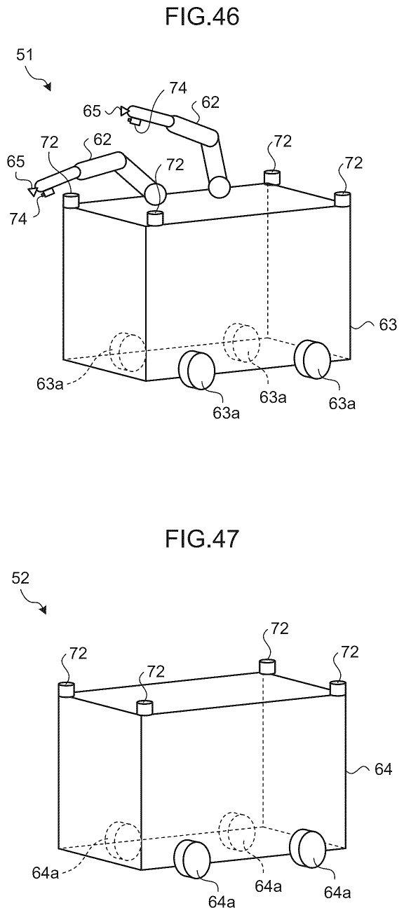

Next, an example of the configuration of the first cart robot 51 and the second cart robot 52 will be described with reference to FIGS. 46 and 47. FIG. 46 is a perspective view of the first cart robot 51. FIG. 47 is a perspective view of the second cart robot 52.

As illustrated in FIG. 46, the first cart robot 51 includes a first vehicle body 63 on which a plurality of baskets 56 can be placed. The first vehicle body 63 is formed in a box shape with an open top, for example. The first vehicle body 63 is equipped with a plurality of drive wheels 63a.

In addition, the first cart robot 51 includes a plurality of picking arms 62. The plurality of picking arms 62 is attached to the first vehicle body 63. The plurality of picking arms 62 is fixed, at its proximal end, to the first vehicle body 63.

The plurality of picking arms 62 is an arm used for work of retrieving the basket 56 from the storage section 54 and placing the basket on the first vehicle body 63. The plurality of picking arms 62 is provided on a side facing the storage section 54 out of both sides of the first vehicle body 63 of the first cart robot 51 in a state where the first cart robot 51 is located in the pickup section 59.

The picking arm 62 includes a plurality of arm portions and a plurality of joint portions. For example, the joint portion is provided between two arm portions, and connects the two arm portions so as to be relatively rotatable. Each joint portion includes a motor. When the arm portion is relatively rotated by each joint portion, the picking arm 62 expands and contracts and can rotate by 360 degrees.

At a distal end of the picking arm 62, a holding portion 65 for holding the basket 56 is provided. The holding portion 65 may be a suction hand that holds the basket 56, a gripping hand that holds the basket 56, or a magnetic force hand that holds a metal portion provided in the basket 56 by magnetic force.

As illustrated in FIG. 47, the second cart robot 52 includes a second vehicle body 63B on which a plurality of baskets 56 can be placed. a second vehicle body 64 is formed in a box shape with an open top, for example. The second vehicle body 64 is equipped with a plurality of drive wheels 64a. Each of the drive wheels 64a has a motor. With the adjustment of the rotation speed of each drive wheel 64a, the second vehicle body 64 is rotatable by 360 degrees.

A plurality of vehicle body sensor groups 72 including a camera and LiDAR is installed in the second vehicle body 64. The plurality of vehicle body sensor groups 72 is installed, for example, at four corners of the upper side of the second vehicle body 64.

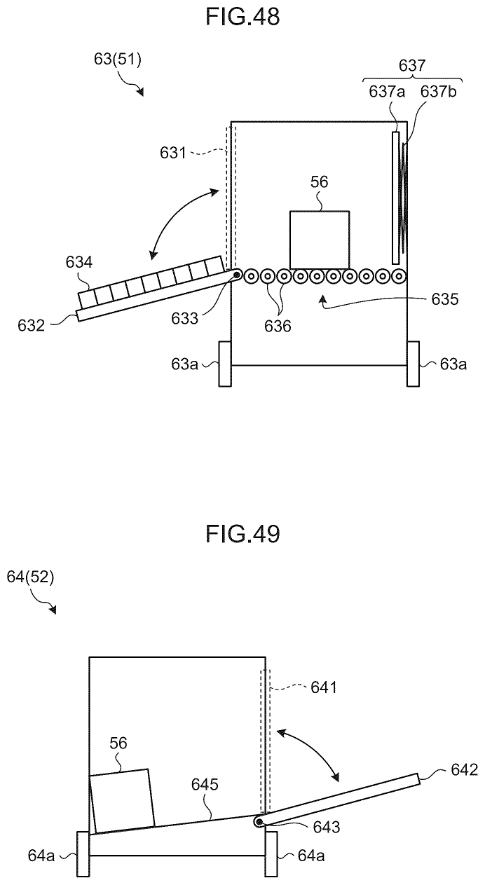

Next, a configuration example of the first vehicle body 63 included in the first cart robot 51 will be described with reference to FIG. 48. FIG. 48 is a schematic diagram illustrating a configuration example of the first vehicle body 63. As illustrated in FIG. 48, the first vehicle body 63 of the first cart robot 51 includes a first opening 631 and a first sidewall 632. The first opening 631 is provided at a position facing the second vehicle body 64 of the second cart robot 52 traveling in parallel along the parallel travel section 61 (refer to FIG. 45). The first opening 631 is only needed to be formed in a size into which at least one basket 56 can be inserted.

The first sidewall 632 is a sidewall capable of opening and closing the first opening 631. Specifically, the first sidewall 632 can open and close the first opening 631 by pivoting about a rotation shaft 633 provided at the lower end. The first sidewall 632 can close the first opening 631 by standing vertically. In addition, the first sidewall 632 can open the first opening 631 by being inclined to the outside of the first vehicle body 63 from the vertically standing state. The first sidewall 632 can open at an angle of 90 degrees or more with reference to the first opening 631.

The first sidewall 632 has a fence 634 on a wall surface facing the inside of the first vehicle body 63 when the first opening 631 is closed. The fence 634 is provided at the rear end of the wall surface of the first sidewall 632 in the traveling direction of the first vehicle body 63.

In addition, the first vehicle body 63 includes a first bottom portion 635 on which the basket 56 is placed. In the first embodiment, the first bottom portion 635 includes a plurality of rollers 636. The plurality of rollers 636 each rotates about a rotation shaft extending in the traveling direction of the first vehicle body 63.

In addition, the first vehicle body 63 includes a push-out portion 637 that pushes out the basket 56 accommodated in the first vehicle body 63 toward the first opening 631. In the first embodiment, the push-out portion 637 includes a contact body 637a and an expansion/contraction mechanism 637b, for example. The expansion/contraction mechanism 637b has its one end provided on a wall surface located on the opposite side of the first opening 631, and has its other end provided with the contact body 637a. The push-out portion 637 can push out the basket 56 toward the first opening 631 by pushing and retracting the contact body 637a using the expansion/contraction mechanism 637b.

Next, a configuration example of the second vehicle body 64 included in the second cart robot 52 will be described with reference to FIG. 49. FIG. 49 is a schematic diagram illustrating a configuration example of the second vehicle body 64.

As illustrated in FIG. 49, the second vehicle body 64 of the second cart robot 52 includes a second opening 641 and a second sidewall 642. The second opening 641 is provided at a position facing the first vehicle body 63 of the first cart robot 51 traveling in parallel along the parallel travel section 61 (refer to FIG. 45). The second opening 641 is only needed to be formed in a size into which at least one basket 56 can be inserted.

The second sidewall 642 is a sidewall capable of opening and closing the second opening 641. Specifically, the second sidewall 642 can open and close the second opening 641 by pivoting about a rotation shaft 643 provided at the lower end. The second sidewall 642 can close the second opening 641 by standing vertically. In addition, the second sidewall 642 can open the second opening 641 by being inclined to the outside of the second vehicle body 64 from the vertically standing state.

In addition, the second vehicle body 64 includes a second bottom portion 645 on which the basket 56 is placed. The second bottom portion 645 is inclined downward from the second opening 641.

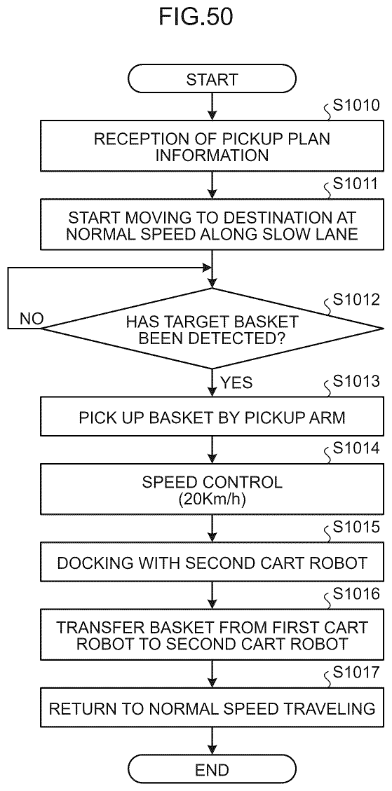

FIG. 50 is a flowchart illustrating a pickup processing control routine regarding the basket 56, performed by the first cart robot 51.

As illustrated in FIG. 50, having received the pickup plan information from the control center 3 (Step S1010), the first cart robot 51 starts moving to the destination at the first moving speed (for example, 5 km/h) along the local lane 60 (Step S1011).

Subsequently, the first cart robot 51 judges whether the target basket 56 has been detected based on the detection result obtained by the vehicle body sensor group 72 or the arm sensor group 74 (Step S1012). In this processing, when the target basket 56 has been detected (Step S1012, Yes), the first cart robot 51 picks up the basket 56 using the picking arm 62 and places the basket 56 on the first vehicle body 63 (Step S1013).

Subsequently, the first cart robot 51 moves toward the parallel travel section 61 at the second moving speed (for example, 20 km/h) (Step S1014), and docks (performs parallel traveling) with the second cart robot 52 along the parallel travel section 61 (Step S1015).

Subsequently, the basket 56 is transferred from the first cart robot 51 to the second cart robot 52 (Step S1016). A method of transferring the basket 56 from the first cart robot 51 to the second cart robot 52 will be described below.

Thereafter, the first cart robot 51 returns the moving speed to the first moving speed and waits for the next command, to complete this routine.

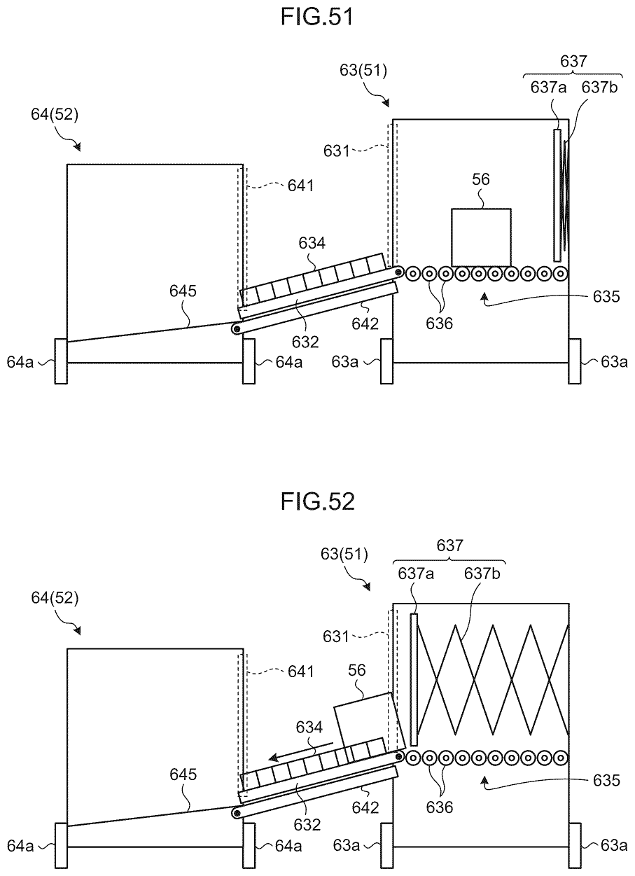

Next, an example of a method of transferring the basket 56 from the first cart robot 51 to the second cart robot 52 will be described with reference to FIGS. 51 to 53. FIGS. 51 to 53 are diagrams illustrating an operation example of the method of transferring the basket 56 according to the twelfth embodiment.

First, as illustrated in FIG. 51, in a state where the first cart robot 51 and the second cart robot 52 are traveling in parallel, the first sidewall 632 of the first vehicle body 63 and the second sidewall 642 of the second vehicle body 64 are opened. Specifically, the second sidewall 642 is opened first, and then, the first sidewall 632 is opened. In a state where the first sidewall 632 and the second sidewall 642 are opened, the distal end of the first sidewall 632 is located inside the second vehicle body 64, while the distal end of the second sidewall 642 is located inside the first vehicle body 63.

The first bottom portion 635 of the first vehicle body 63 is provided at a position higher than the second bottom portion 645 of the second vehicle body 63B. As described above, the first sidewall 632 can be opened at an angle of 90 degrees or more with reference to the first opening 631. With this configuration, when the first sidewall 632 and the second sidewall 642 are opened, the first vehicle body 63 and the second vehicle body 64 are coupled to each other via the first sidewall 632 inclined downward from the first opening 631 of the first vehicle body 63 toward the second opening 641 of the second vehicle body 63B.

Subsequently, as illustrated in FIG. 52, the basket 56 accommodated in the first vehicle body 63 is pushed out toward the first opening 631 using the push-out portion 637 of the first vehicle body 63. This allows the basket 56 to be pushed out of the first vehicle body 63 through the first opening 631. Since the first bottom portion 635 of the first vehicle body 63 has the plurality of rollers 636, the basket 56 can be smoothly pushed out. The basket 56 pushed out of the first vehicle body 63 goes down the first sidewall 632 toward the second opening 641 of the second vehicle body 64. With the fence 634 provided on the first sidewall 632, it is possible to suitably suppress dropping of the basket 56 from the first sidewall 632.

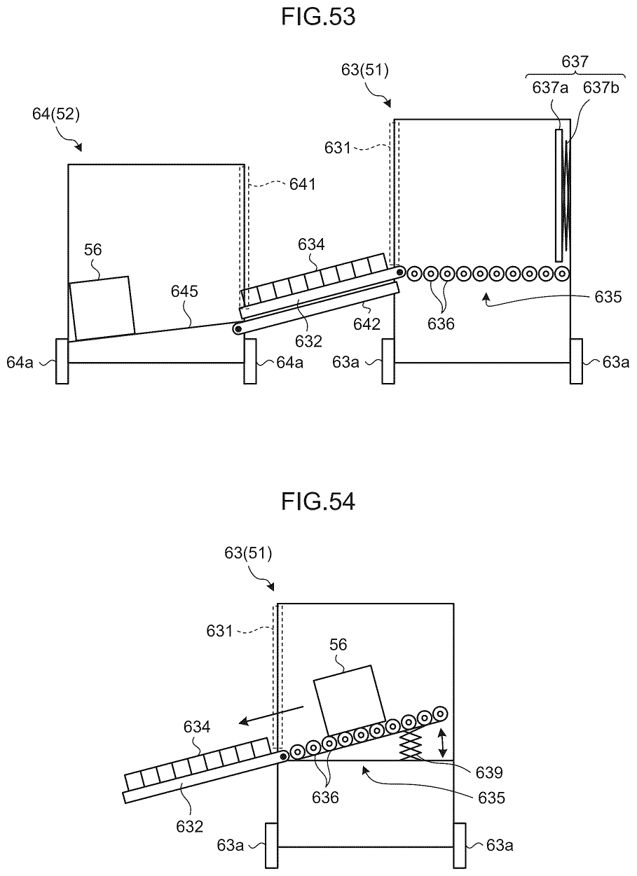

Thereafter, as illustrated in FIG. 53, the basket 56 is accommodated inside the second vehicle body 64 through the second opening 641. Since the second bottom portion 645 of the second vehicle body 64 is inclined downward from the second opening 641, it is possible to suitably suppress the basket 56 from jumping out of the second vehicle body 64 through the second opening 641.

Thereafter, the first sidewall 632 is closed, and then the second sidewall 642 is closed. This completes the transfer of the basket 56 from the first cart robot 51 to the second cart robot 52.

In this manner, the picking system S according to the tenth embodiment transfers the basket 56 from the first vehicle body 63 to the second vehicle body 64 through the first opening 631 of the first vehicle body 63 and the second opening 641 of the second vehicle body 64. According to such a transfer method, there is no need to transfer the basket 56 over the sidewall, making it possible to efficiently transfer the basket 56 as compared with a case where the basket 56 is transferred through the openings above the first vehicle body 63 and the second vehicle body 64, for example. Therefore, according to the picking system S according to the tenth embodiment, the basket 56 can be efficiently picked and transported to a predetermined position.

Here, an example in which the first bottom portion 635 of the first vehicle body 63 includes the plurality of rollers 636 has been described, but the first bottom portion 635 does not necessarily need to include the plurality of rollers 636. For example, the first bottom portion 635 may include a conveyor having a drive source such as a motor. In this case, the first vehicle body 63 can retrieve the basket 56 from the first vehicle body 63 without using the push-out portion 637, for example.

Here, an example in which the push-out portion 637 includes the contact body 637a and the expansion/contraction mechanism 637b has been described, but the configuration of the push-out portion 637 is not limited to the above example. For example, the push-out portion 637 may be configured to push out the basket 56 by air pressure by delivering compressed gas toward the basket 56. Furthermore, the push-out portion 637 may be an arm such as a picking arm 62, for example.

### Thirteenth Embodiment

Next, a thirteenth embodiment will be described. Description of portions overlapping with the above-described embodiment will be omitted. FIG. 54 is a schematic diagram illustrating a configuration example of the first vehicle body 63 according to the thirteenth embodiment. As illustrated in FIG. 54, the first vehicle body 63 may include an angle adjuster 639 that changes the inclination angle of the first bottom portion 635. Specifically, the angle adjuster 639 can adjust the angle of the first bottom portion 635 (the plurality of rollers 636) in a range between the horizontal state and the inclined state inclined downward toward the first opening 631.

When transferring the basket 56 from the first cart robot 51 to the second cart robot 52 in the parallel travel section 61, the picking system S opens the first sidewall 632 and the fence 634, and then inclines the first bottom portion 635 using the angle adjuster 639. With this configuration, the basket 56 slides down on the plurality of rollers 636 and moves from the first opening 631 to the outside of the first cart robot 51 (first sidewall 632).

In this manner, the first bottom portion 635 may be inclined downward toward the first opening 631. According to such a configuration, for example, the basket 56 can be retrieved from the first vehicle body 63 without using the push-out portion 637.

Here, an example of a case where the first bottom portion 635 is configured to be angularly adjustable by the angle adjuster 639 has been described. However, the first vehicle body 63 does not necessarily need to include the angle adjuster 639. That is, the first bottom portion 635 may be constantly inclined downward toward the first opening 631. In this case, opening the first sidewall 632 will allow the basket 56 to roll on the roller 636 from the inside of the first vehicle body 63 so as to move to the first sidewall 632.

### Fourteenth Embodiment

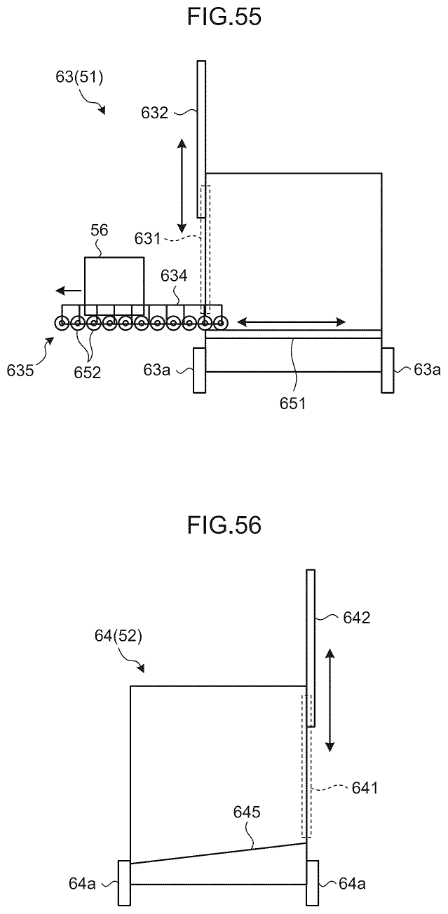

Next, a configuration example of the first vehicle body 63 and the second vehicle body 64 according to a fourteenth embodiment will be described with reference to FIGS. 55 and 56. FIG. 55 is a schematic diagram illustrating a configuration example of the first vehicle body 63 according to the fourteenth embodiment. FIG. 56 is a view illustrating a configuration example of a second vehicle body 64 according to the fourteenth embodiment.

As illustrated in FIG. 55, the first vehicle body 63 includes a first sidewall 632 that can be raised and lowered. Specifically, the first sidewall 632 can be raised to open the first opening 631 and can be lowered to close the first opening 631.

In addition, the first vehicle body 63 includes a moving unit 651 that horizontally moves the first bottom portion 635 toward the second vehicle body 64. Specifically, the moving unit 651 can horizontally move the first bottom portion 635 between a transfer position that is the outside of the first vehicle body 63 and an accommodation position that is the inside of the first vehicle body 63.

The first bottom portion 635 includes a conveyor 652 that conveys the placed basket 56 toward the second opening 641 of the second cart robot 52. The conveyor 652 is a belt conveyor, for example, and can convey the basket 56 using a drive source such as a motor.

As illustrated in FIG. 56, the second vehicle body 64 includes a second sidewall 642 that can be raised and lowered. Specifically, the second sidewall 642 can be raised to open the second opening 641 and can be lowered to close the second opening 641.

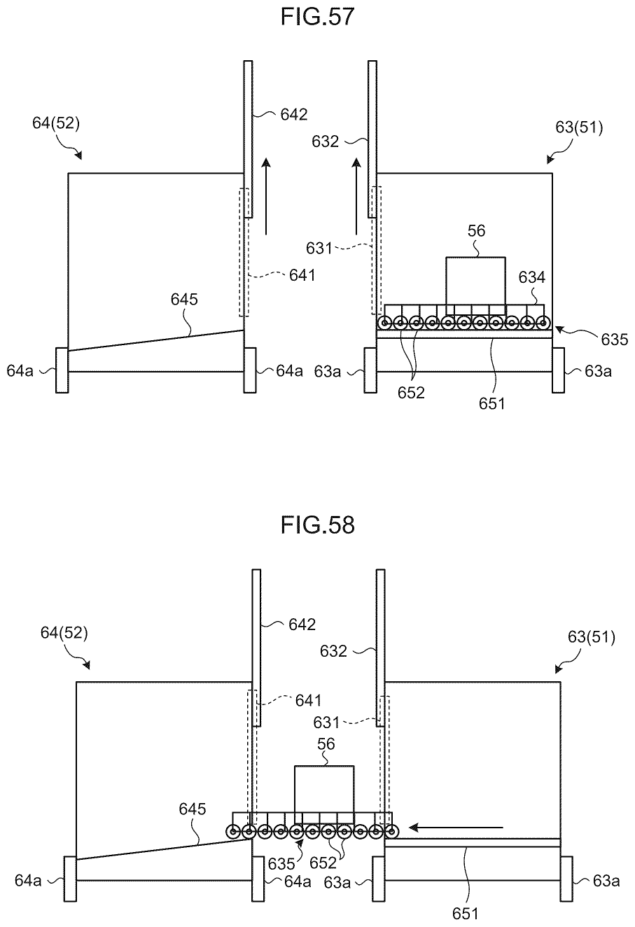

Next, a method of transferring the basket 56 according to the fourteenth embodiment will be described with reference to FIGS. 57 to 59. FIGS. 57 to 59 are diagrams illustrating an operation example of the method of transferring the basket 56 according to the fourteenth embodiment.

First, as illustrated in FIG. 57, in a state where the first cart robot 51 and the second cart robot 52 are traveling in parallel, the first sidewall 632 of the first vehicle body 63 and the second sidewall 642 of the second vehicle body 64 are opened.

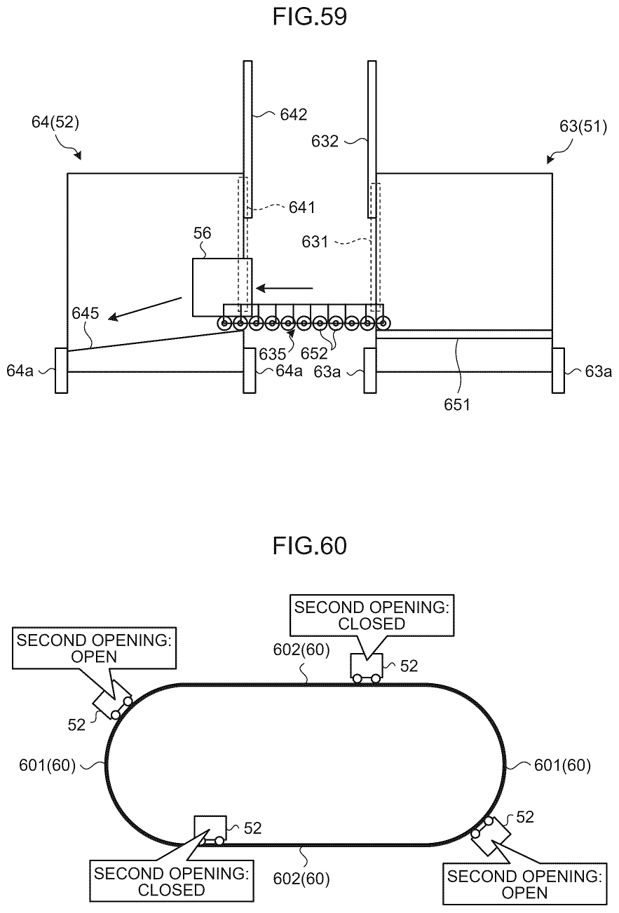

Subsequently, as illustrated in FIG. 58, the first bottom portion 635 is horizontally moved by using the moving unit 651 so as to allow the first bottom portion 635 to go inside the second vehicle body 64. Thereafter, as illustrated in FIG. 59, the basket 56 is moved toward the second vehicle body 64 by using the conveyor 652. This allows the basket 56 to be transferred to the second vehicle body 64.

Here, an example in which the first bottom portion 635 includes the conveyor 652 has been described, but the first bottom portion 635 does not necessarily need to include the conveyor 652. For example, the first bottom portion 635 may include the plurality of rollers 636 described in the first embodiment. In this case, the first vehicle body 63 may include the push-out portion 637 described above, for example.

### Fifteenth Embodiment

Next, a fifteenth embodiment will be described. Description of portions overlapping with the above-described embodiment will be omitted. FIG. 60 is a view for illustrating a method of opening and closing the second opening 641 according to the fifteenth embodiment. As described above, since the second cart robot 52 circles around the fast lane 58 in a certain direction, the direction of the centrifugal force applied to the basket 56 in the second cart robot 52 is constant when the second cart robot 52 is traveling on a curved portion 601. Specifically, the basket 56 is constantly subjected to centrifugal force toward the outside of the fast lane 58. Therefore, the basket 56 is less likely to drop from the second opening 641 that opens toward the inside of the fast lane 58.

Therefore, as illustrated in FIG. 60, the second cart robot 52 may maintain the state in which the second sidewall 642 is open while traveling on the curved portion 601. This makes it possible to omit the time required to open the second sidewall 642 when the basket 56 is transferred from the first cart robot 51 to the second cart robot 52, leading to more efficient transfer of the basket 56.

Furthermore, since the second bottom portion 645 of the second cart robot 52 is inclined downward from the second opening 641 as described above, it is possible to more suitably suppress the dropping of the basket 56 from the second sidewall 642.

In contrast, when a straight portion 602 extending in a straight line is provided as in the fast lane 58 illustrated in FIG. 60, the centrifugal force toward the outside of the fast lane 58 is not applied to the basket 56 in the straight portion 602. Therefore, the second cart robot 52 may close the second opening 641 using the second sidewall 642 while traveling along the straight portion 602. This makes it possible to suitably suppress the dropping of the basket 56 along the straight portion 602.

### Sixteenth Embodiment

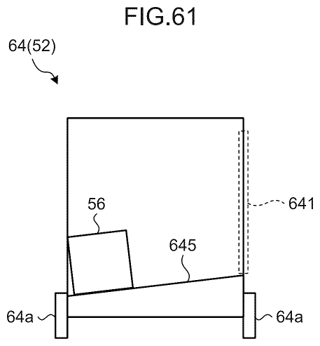

Next, a sixteenth embodiment will be described. Description of portions overlapping with the above-described embodiment will be omitted. FIG. 61 is a schematic diagram illustrating a configuration example of the second vehicle body 64 according to the sixteenth embodiment. As illustrated in FIG. 61, the second vehicle body 64 does not necessarily need to include the second sidewall 642. For example, in a case where the fast lane 58 has a circular shape or an elliptical shape in plan view, a centrifugal force toward the outside of the fast lane 58 is constantly applied to the basket 56 accommodated inside the second vehicle body 64 while the second cart robot 52 is circling. Therefore, even when the second sidewall 642 is not provided, that is, even when the second opening 641 is constantly open, it is possible to suppress the dropping of the basket 56 from the second opening 641.

As described above, the picking system (as an example, the picking system S) according to the embodiment includes: the first cart robot (as an example, the first cart robot 51) that has the first vehicle body (as an example, first vehicle body 63) capable of accommodating the package (as an example, the basket 56) and moves along the first lane (as an example, the local lane 60); and the second cart robot (as an example, the second cart robot 52) having the second vehicle body (as an example, second vehicle body 64) capable of accommodating the package and configured to move along the second lane (as an example, the fast lane 58) located outside the first lane, the second cart robot configured to receive the package from the first cart robot traveling in parallel and to accommodate the received package in the second vehicle body. The first vehicle body has a first opening (as an example, the first opening 631) at a position facing the second vehicle body traveling in parallel, and has the first sidewall (as an example, the first sidewall 632) capable of opening and closing the first opening. The second vehicle body has a second opening (as an example, the second opening 641) at a position facing the first vehicle body traveling in parallel, and has the second sidewall (as an example, the second sidewall 642) capable of opening and closing the second opening. The picking system according to the embodiment opens the first sidewall and the second sidewall, and transfers the package from the first vehicle body to the second vehicle body through the first opening and the second opening.

Consequently, with the picking system according to the embodiment, it is possible to efficiently pick a package and transport the package to a predetermined position by transferring the package through the openings of the first cart robot and the second cart robot facing each other.

The first sidewall may open and close the first opening by pivoting about a rotation shaft (as an example, the rotation shaft 633) provided at the lower end. The picking system according to the embodiment may transfer the package from the first vehicle body to the second vehicle body through the first opening, the first sidewall, and the second opening by opening the first sidewall and coupling the first vehicle body and the second vehicle body to each other via the first sidewall. With this configuration, the package can be efficiently transferred from the first cart robot to the second cart robot.

The first vehicle body may include a push-out portion (as an example, the push-out portion 637) that pushes out the package accommodated in the first vehicle body toward the first opening. The picking system according to the embodiment may transfer the package from the first vehicle body to the second vehicle body by opening the first sidewall to couple the first vehicle body and the second vehicle body to each other via the first sidewall, and then pushing out the package accommodated in the first vehicle body toward the first opening using the push-out portion. With this configuration, the package can be efficiently transferred from the first cart robot to the second cart robot.

The first vehicle body may include a first bottom portion on which a package is placed. The first bottom portion may include a roller. With this configuration, the package can be efficiently transferred from the first cart robot to the second cart robot.

The first sidewall may be inclined downward toward the second opening. With this configuration, the package can be efficiently transferred from the first cart robot to the second cart robot.

The second vehicle body may include a second bottom portion on which a package is placed. The second bottom portion may be inclined downward from the second opening. With this configuration, it is possible to suitably suppress the package from falling from the second opening.

The first vehicle body may include a first bottom portion on which a package is placed and a moving unit that moves the first bottom portion toward the second vehicle body. The picking system according to the embodiment may move the package from the first vehicle body to the second vehicle body by allowing the first bottom portion to enter the inside of the second vehicle body using the moving unit. With this configuration, the package can be efficiently transferred from the first cart robot to the second cart robot.

The first bottom portion may include a conveyor. The picking system according to the embodiment may allow the first bottom portion to enter the inside of the second vehicle body using the moving unit, and then transfer the package to the second vehicle body using the conveyor. With this configuration, the package can be efficiently transferred from the first cart robot to the second cart robot.

While the present invention has been described using the embodiments, the technical scope of the present invention is not limited to the scope described in the above embodiments. It is apparent to those skilled in the art that various modifications or improvements can be made to the above embodiments. It is apparent from the description of the claims that modes to which such changes or improvements have been added can also be included in the technical scope of the present invention.

It should be noted that the order of execution of each processing such as operations, procedures, steps, and stages in the devices, systems, programs, and methods illustrated in the claims, the specification, and the drawings can be implemented in any order unless “before”, “prior to”, or the like is explicitly stated, and unless the output of the previous processing is to be used in the subsequent processing. Descriptions using “First,”, “Next,”, and the like used for convenience in the operation flows in the claims, specification, and the drawings are not intended to indicate that it is essential to perform operations in the order described.

### REFERENCE SIGNS LIST

1 CONTROL CENTER
15 INFORMATION PROCESSING APPARATUS
50 FLOOR
52 CART ROBOT
58 FAST LANE
59 PICKUP SECTION
60 LOCAL LANE (SLOW LANE)
82 REPLACEMENT ROBOT
83 ROBOT CONTROL APPARATUS
S PICKING SYSTEM

1-5. (canceled)

6. A cart robot comprising:
a traveling vehicle body including a cart on which a package can be placed; and
a fixing frame being provided on a frame of the cart and configured to fix an arm, being an arm that transfers the package, to an inside of the cart.

7. The cart robot according to claim 6,
wherein the fixing frame fixes a plurality of the arms at intervals designed based on a shoulder width of a human.

8. The cart robot according to claim 6,
wherein the fixing frame fixes the arm at a height designed based on a height of a human shoulder.

9. The cart robot according to claim 6,
wherein the fixing frame is provided on one side when viewed in a traveling direction of the traveling vehicle body, and fixes the arm so as to transfer the package on a side opposite to the one side.

10. The cart robot according to claim 9,
wherein the fixing frame is constituted with a first support fixed to a corner portion of the frame and a second support fixed to a side of the corner portion from a center of the frame as viewed in the traveling direction of the traveling vehicle body, and the fixing frame fixes the arm to a distal end side of the first support and the second support.

11. The cart robot according to claim 9,
wherein the traveling vehicle body includes a compressor to cause the arm to suck the package, the compressor being mounted on a lower side of the fixing frame.

12. A picking system comprising a plurality of cart robots, the cart robots configured to pick up and convey a package and place the package on a shelf from which the package is to be picked up by a cart robot.

13. The picking system according to claim 12, wherein, in a case where another package is loaded, the cart robot places the package on another shelf.

14. The picking system according to claim 12,
wherein the cart robot includes: a first cart robot configured to move on a slow lane; and a second cart robot configured to move on a fast lane at a higher speed than the first cart robot,
the first cart robot places the package on the shelf from which the package is to be picked up by the first cart robot, and
the first cart robot passes the package picked up from the shelf to the second cart robot.

15. The picking system according to claim 12,
wherein the shelf is provided in plurality, and
the cart robot places the package on the shelf near another cart robot, among the plurality of shelves.

16. The picking system in accordance with claim 12,
wherein the shelf is provided in plurality, and
the cart robot changes quantity of the shelves on which the package is to be placed in accordance with an amount of the package to be picked up.

17. The picking system according to claim 12,
wherein the cart robot and the shelf are each provided in plurality,
each of the plurality of shelves corresponds to one cart robot or two or more cart robots, out of the plurality of cart robots, and
the cart robot places the package to be picked up by the cart robot on the shelf corresponding to the cart robot.

18. The picking system according to claim 12,
wherein the cart robot performs charging processing, being processing of charging a driving battery mounted on the cart robot at least one of situations: when picking up the package from the shelf, and when placing the package on the shelf.

19. A program causing a computer to execute:
a conveyance procedure, being a procedure of picking up and conveying a package using a cart robot; and
a placement procedure, being a procedure of placing, using the cart robot, the package on a shelf from which the package is to be picked up by the cart robot.

20-85. (canceled)
